(19) United States
(12) Patent Application Publication
(10) Pub. No.: US 2021/0337817 A1
(43) Pub. Date: Nov. 4, 2021

(54) COMPOUNDS AND FORMULATIONS FOR PROTECTIVE COATINGS

(71) Applicant: Apeel Technology, Inc., Goleta, CA (US)

(72) Inventors: Matthew Lee, Goleta, CA (US); Gabriel Rodriguez, Goleta, CA (US); David Sandoval, Goleta, CA (US); Bardia Soltanzadeh, Goleta, CA (US); Eli Boesch, Goleta, CA (US); Erich Brodbeck, Goleta, CA (US); James Rogers, Goleta, CA (US); Savannah Braden, Goleta, CA (US); Chance Holland, Goleta, CA (US); Louis Perez, Goleta, CA (US); Charles Frazier, Goleta, CA (US); Carlos Hernandez, Goleta, CA (US); Stephen Kaun, Goleta, CA (US); Jessica Sexton, Goleta, CA (US)

(21) Appl. No.: 17/272,133

(22) PCT Filed: Sep. 4, 2019
(86) PCT No.: PCT/US2019/049585

§ 371 Date: Feb. 26, 2021

Related U.S. Application Data
(63) Continuation-in-part of application No. 16/427,219, filed on May 30, 2019.
(60) Provisional application No. 62/728,702, filed on Sep. 7, 2018.
(60) Provisional application No. 62/727,501, filed on Sep. 5, 2018.

(51) Int. Cl. A23B 7/16; A23B 7/154; A23B 7/157; A23P 20/18; A23P 20/17; A01N 3/02; A01N 3/00

(52) U.S. Cl. CPC A23B 7/16; A23B 7/154; A23B 7/157; A23V 2002/00; A23P 20/17; A01N 3/02; A01N 3/00; A23P 20/18

(57) ABSTRACT

Compositions for forming protective coatings can include a first group of compounds, where each compound of the first group is a fatty acid, fatty acid ester, or fatty acid salt having a carbon chain length of at least 14 carbons. The compositions can optionally include a second group of compounds selected from fatty acids, fatty acid esters, fatty acid salts, and combinations thereof, wherein each compound of the second group has a carbon chain length from 7 to 13 carbons. At least some of the compounds of the first group can function as emulsifiers, allowing the composition to be dissolved, suspended, or dispersed in a solvent. At least some of the compounds of the second group can function as welling agents in order to improve the surface wetting of items to be coated when solutions, suspensions, or colloids that include the compositions are applied to the items.

### STATEMENT OF RELATED APPLICATIONS

This application claims the benefit of U.S. Provisional Application 62/727,501, filed Sep. 5, 2018, U.S. Provisional Application 62/728,702, filed Sep. 7, 2018, and US patent application Ser. No. 16/427,219, filed May 30, 2019, all of which are incorporated herein for all purposes.

### FIELD OF THE DISCLOSURE

Described herein are compounds and formulations for forming protective coatings and methods of making and using the same.

### BACKGROUND

Common agricultural products are susceptible to degradation and decomposition (i.e., spoilage) when exposed to the environment. Such agricultural products can include, for example, eggs, fruits, vegetables, produce, seeds, nuts, flowers, and/or whole plants (including their processed and semi-processed forms). Edible non-agricultural products (e.g., vitamins, candy, etc.) can also be vulnerable to degradation when exposed to the ambient environment. The degradation of agricultural and other edible products can occur via abiotic means as a result of evaporative moisture loss from an external surface of the products to the atmosphere, oxidation by oxygen that diffuses into the products from the environment, mechanical damage to the surface, and/or light-induced degradation (i.e., photodegradation). Biotic stressors such as bacteria, fungi, viruses, and/or pests can also infest and decompose the products.

The cells that form the aerial surface of most plants (such as higher plants) include an outer envelope or cuticle, which provides varying degrees of protection against water loss, oxidation, mechanical damage, photodegradation, and/or biotic stressors, depending upon the plant species and the plant organ (e.g., fruit, seeds, bark, flowers, leaves, stems, etc.). Cutin, which is a biopolyester derived from cellular lipids, forms the major structural component of the cuticle and serves to provide protection to the plant against environmental stressors (both abiotic and biotic). The thickness, density, as well as the composition of the cutin (i.e., the different types of monomers that form the cutin and their relative proportions) can vary by plant species, by plant organ within the same or different plant species, and by stage of plant maturity. The cutin-containing portion of the plant can also contain additional compounds (e.g., epicuticular waxes, phenolics, antioxidants, colored compounds, proteins, polysaccharides, etc.). This variation in the cutin composition as well as the thickness and density of the cutin layer between plant species, plant organs and/or a given plant at different stages of maturation can lead to varying degrees of resistance between plant species or plant organs to attack by environmental stressors (i.e., water loss, oxidation, mechanical injury, and light) and/or biotic stressors (e.g., fungi, bacteria, viruses, insects, etc.).

Conventional approaches to preventing degradation, maintaining quality, and increasing the life of agricultural products include special packaging and/or refrigeration. Refrigeration requires capital-intensive equipment, demands constant energy expenditure, can cause damage or quality loss to the product if not carefully controlled, must be actively managed, and its benefits are lost upon interruption of a temperature-controlled supply chain. Produce mass loss (e.g. water loss) during storage increases humidity, which necessitates careful maintenance of relative humidity levels (e.g. using condensers) to avoid negative impacts (e.g. condensation, microbial proliferation, etc.) during storage. Moreover, respiration of agricultural products is an exothermic process which releases heat into the surrounding atmosphere. During transit and storage in shipping containers, heat generated by the respiration of the agricultural product, as well as external environmental conditions and heat generated from mechanical processes (e.g., motors) necessitates active cooling of the storage container in order to maintain the appropriate temperature for storage, which is a major cost driver for shipping companies. By reducing the rate of degradation, reducing the heat generation in storage and transit, and increasing the shelf life of agricultural products, there is a direct value to the key stakeholders throughout the supply chain

There exists a need for new, more cost-effective approaches to prevent degradation, reduce the generation of heat and humidity, maintain quality, and increase the life of agricultural products. Such approaches may require less or no refrigeration, special packaging, etc.

### SUMMARY

Compositions and formulations for forming protective coatings and methods of making and using thereof are described herein. The compositions can include a first group of compounds, where each compound of the first group is selected from fatty acids, fatty acid esters, and fatty acid salts, and each compound of the first group has a carbon chain length of at least 14 carbons. The compositions can also include a second group of compounds selected from fatty acids, fatty acid esters, fatty acid salts, and combinations thereof, wherein each compound of the second group has a carbon chain length from 7 to 13 carbons. At least some of the compounds of the first group (e.g., fatty acid salts) can function as emulsifiers, allowing the composition to be dissolved, suspended, or dispersed in a solvent. At least some of the compounds of the second group can function as wetting agents or surfactants in order to improve the surface wetting of items to be coated when solutions, suspensions, or colloids that include the compositions are applied to the items. The fatty acid salts having a carbon chain length of less than 14 (e.g., from 7 to 13 carbons) can also (or alternatively) function as emulsifiers, allowing the composition to be dissolved, suspended, or dispersed in a solvent.

Accordingly, in a first aspect, a composition can include from about 50% to about 99.9% by mass of one or more first compounds selected from the group consisting of fatty acids, fatty acid esters, fatty acid salts, and combinations thereof, wherein each of the one or more first compounds has a carbon chain length of at least 14. The composition can further include from about 0.1% to about 35% by mass of one or more second compounds selected from the group consisting of fatty acids, fatty acid esters, fatty acid salts, and combinations thereof, wherein each of the one or more second compounds has a carbon chain length in a range of 7 to 13.

In a second aspect, a composition can include from about 50% to about 99.8% by mass of one or more first compounds selected from the group consisting of fatty acids, fatty acid esters, and combinations thereof, wherein each compound of the first group has a carbon chain length of at least 14. The composition can further include from about 0.1% to about 35% by mass of one or more wetting agents. The composition can further include from about 0.1% to about 25% by mass of one or more fatty acid salts, wherein each fatty acid salt has a carbon chain length of at least 14.

In a third aspect, a composition can include from about 50% to about 99.8% by mass of a first group of compounds, wherein each compound of the first group is a compound of Formula I having a carbon chain length of at least 14, and where Formula I is as defined throughout. The composition can further include from about 0.1% to about 35% by mass of a second group of compounds, wherein each compound of the second group is a compound of Formula I having a carbon chain in a range of 7 to 13. The composition can further include from about 0.1% to about 25% by mass of a third group of compounds, wherein each compound of the third group is a salt comprising a compound of Formula II. For the first and second groups of compounds, R can be selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen, hydroxyl, nitro, —CN, —NH2, —SH, —SR¹⁵, —OR¹⁴, —NR¹⁴R¹⁵, —C₁-C₆ alkyl, —C₂-C₆ alkenyl, or —C₂-C₆ alkynyl. For the third group of compounds, X can be a cationic moiety.

In a fourth aspect, a composition can include from about 50% to about 99% by mass of one or more fatty acid esters having carbon chain length of at least 14, and from about 1% to about 50% by mass of one or more fatty acid salts having a carbon chain length of at least 14.

In a fifth aspect, a composition can include (i) from 50% to 99% by mass of a first group of compounds, wherein each compound of the first group is a compound of Formula I, and (ii) from 1% to 50% by mass of a second group of compounds, wherein each compound of the second group is a salt of Formula II or Formula III, where Formulas I, II, and III are as defined throughout.

In a sixth aspect, a mixture (e.g., a solution, suspension, or colloid) can include a composition in a solvent, wherein the composition comprises (i) from 50% to 99% by mass of a first group of compounds, wherein each compound of the first group is a compound of Formula I, and (ii) from 1% to 50% by mass of a second group of compounds, wherein each compound of the second group is a salt of Formula II or Formula III, where Formulas I, II, and III are as defined throughout.

Any of the compositions or mixtures described herein can include one or more of the following features, either alone or in combination. The second compounds or wetting agents can have a carbon chain length of 8, 10, 11, or 12. Any of the compounds of the composition can be compounds of Formula I. The cationic moiety can be an organic or an inorganic ion. The cationic moiety can include sodium. Each of the one or more second compounds can be a wetting agent. The one or more first compounds can include monoacylglycerides and/or fatty acid salts. The fatty acid esters can include monacylglycerides. A mass ratio of the fatty acid esters (e.g., monoacylglycerides) to the fatty acid salts can be in a range of about 2 to 100 or about 2 to 99. Accordingly, a mass ratio of the first group of compounds to the second group of compounds can be in a range of 2 to 99 or 2 to 100. The composition can comprise less than 10% by mass of diglycerides. The composition can comprise less than 10% by mass of triglycerides. Each compound of the first and/or second group of compounds can have a carbon chain length of at least 14. In Formula I, R can -glyceryl. The second group of compounds can comprise SA-Na, PA-Na, MA-Na, SA-K, PA-K, or MA-K. The composition can comprise from 70% to 99% by mass of the first group of compounds and from 1% to 30% by mass of the second group of compounds. The solvent can be water, or can be at least 50% or at least 70% water by volume. A concentration of the composition in the mixture can be in a range of 0.5 to 200 mg/mL. The first group of compounds can comprise one or more compounds selected from the group consisting of:

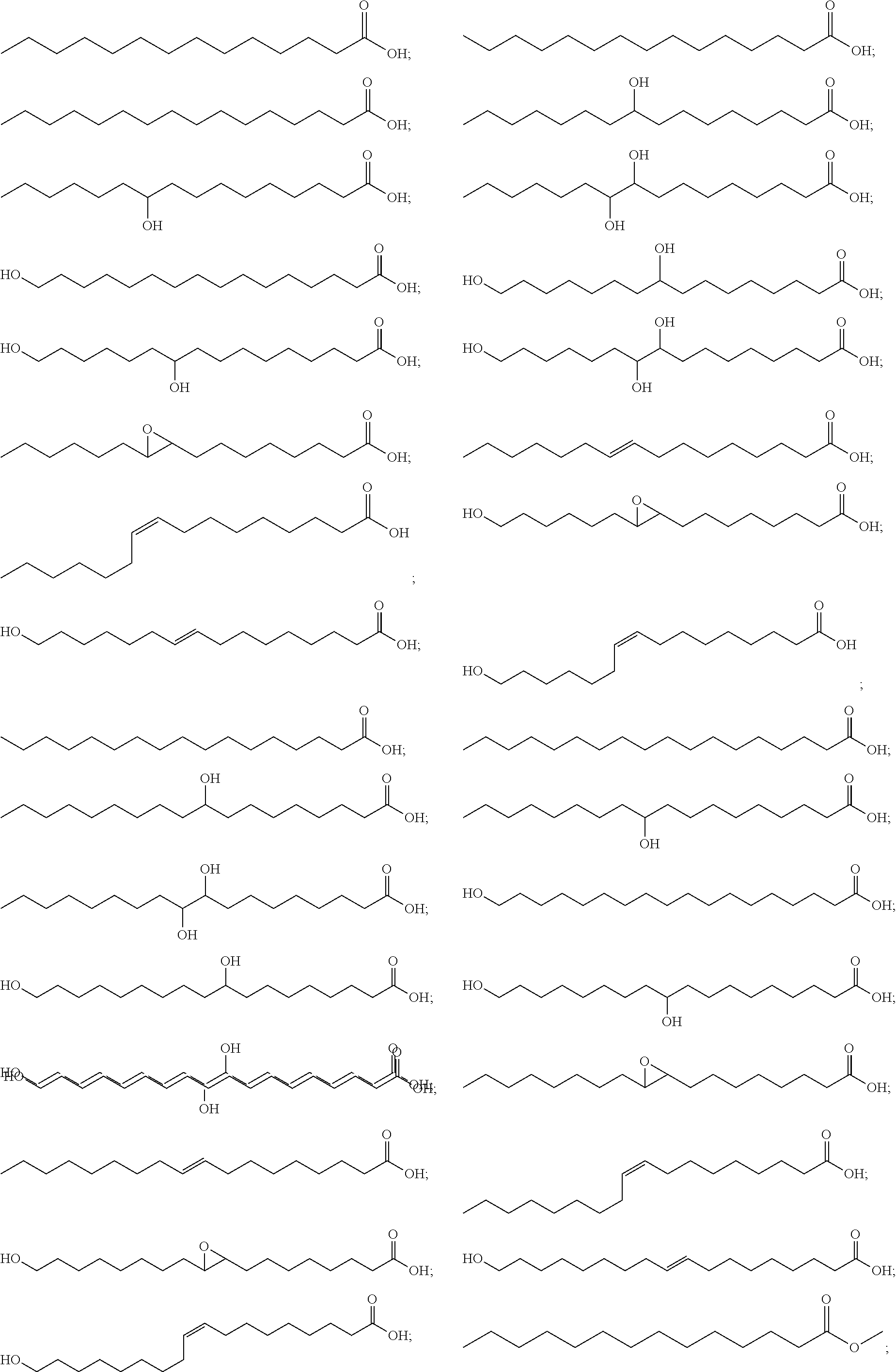

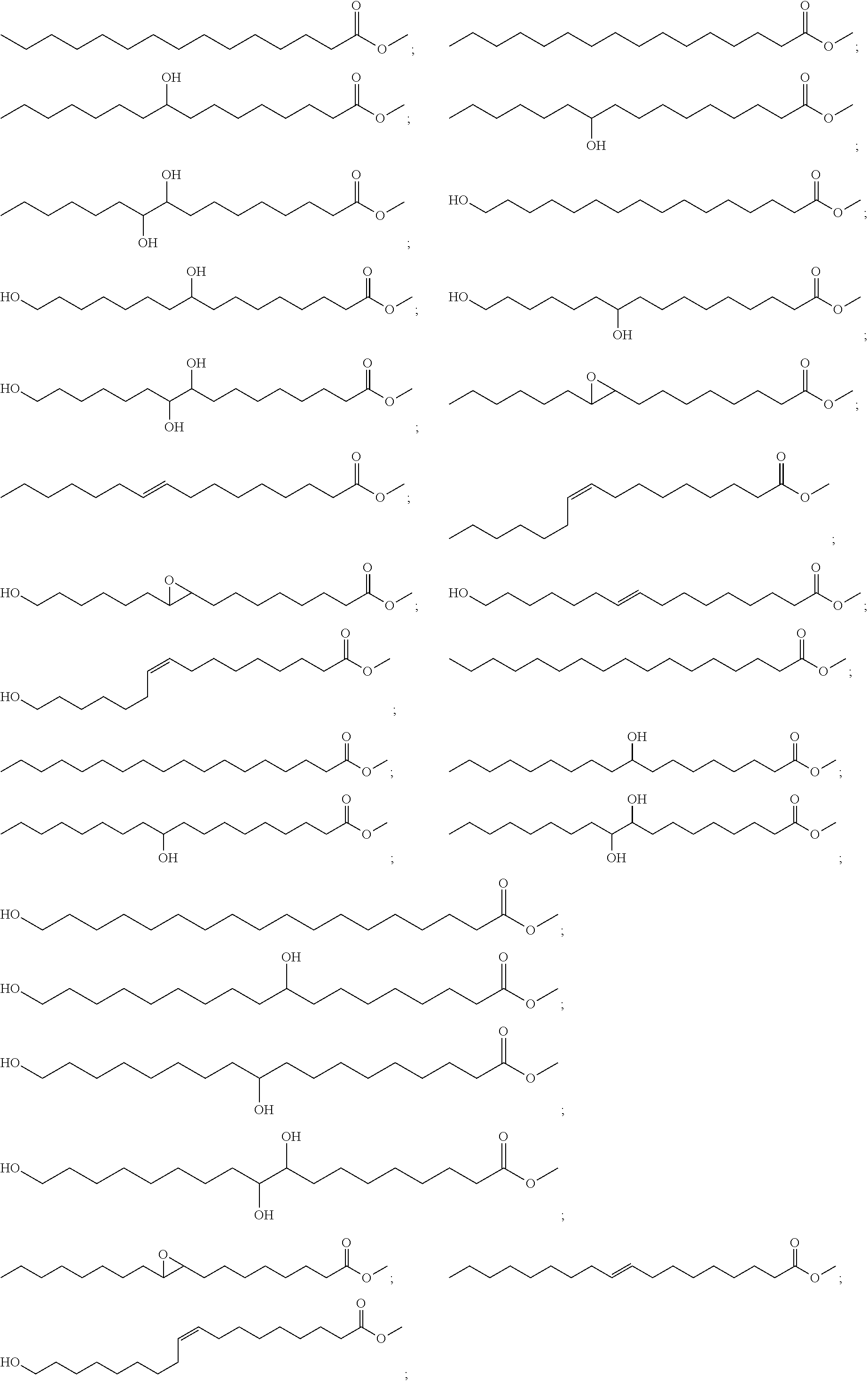

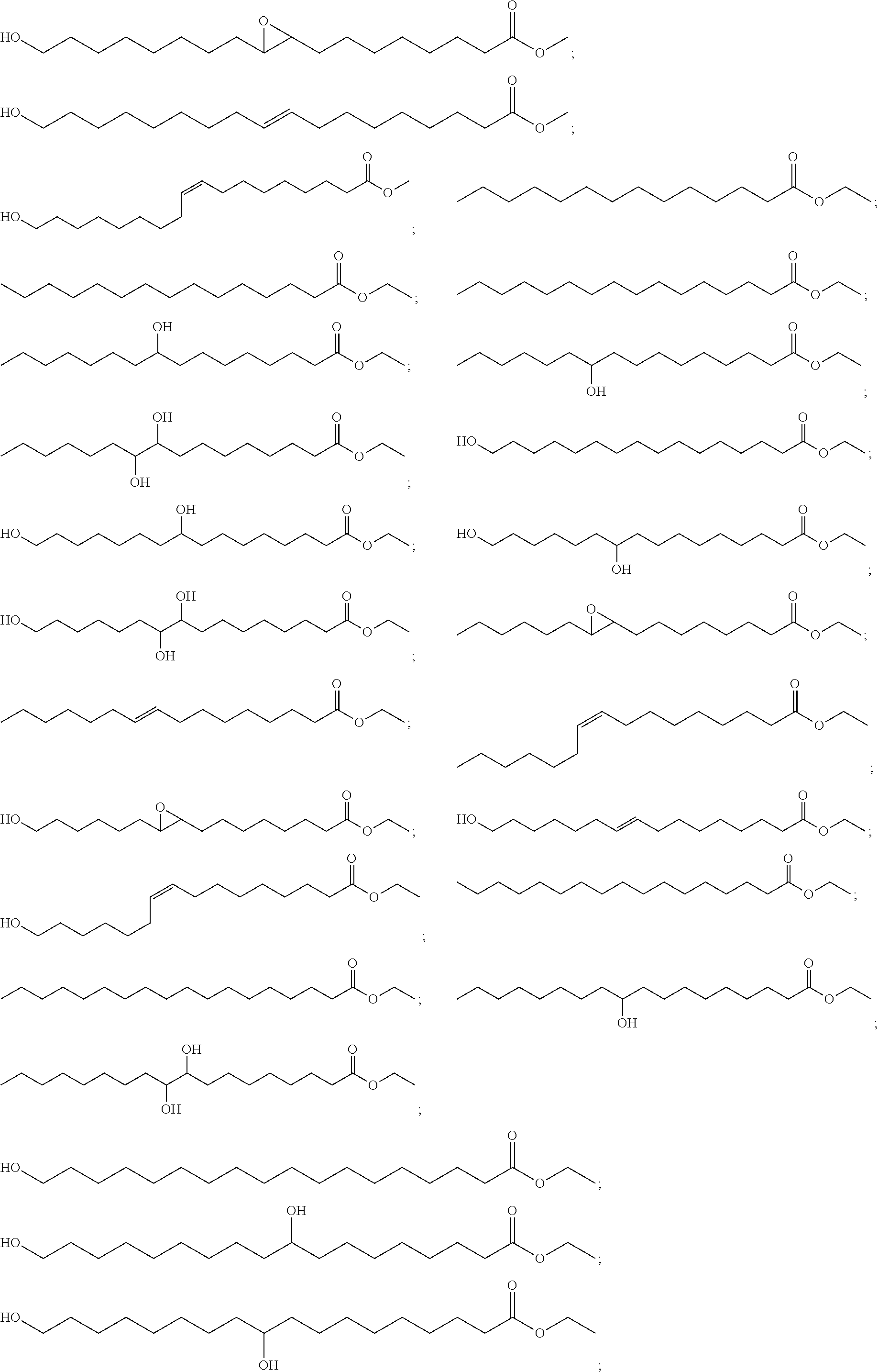

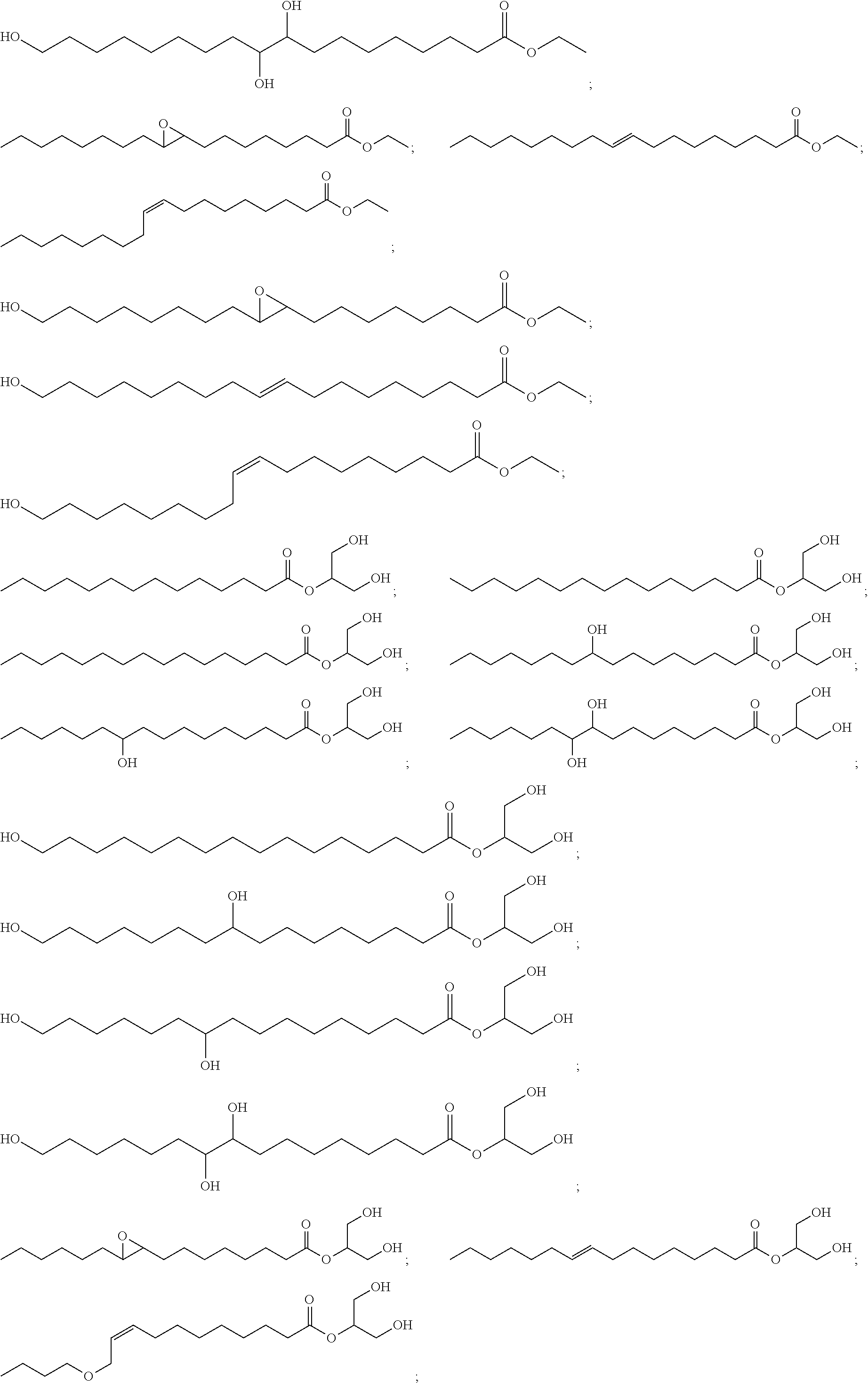

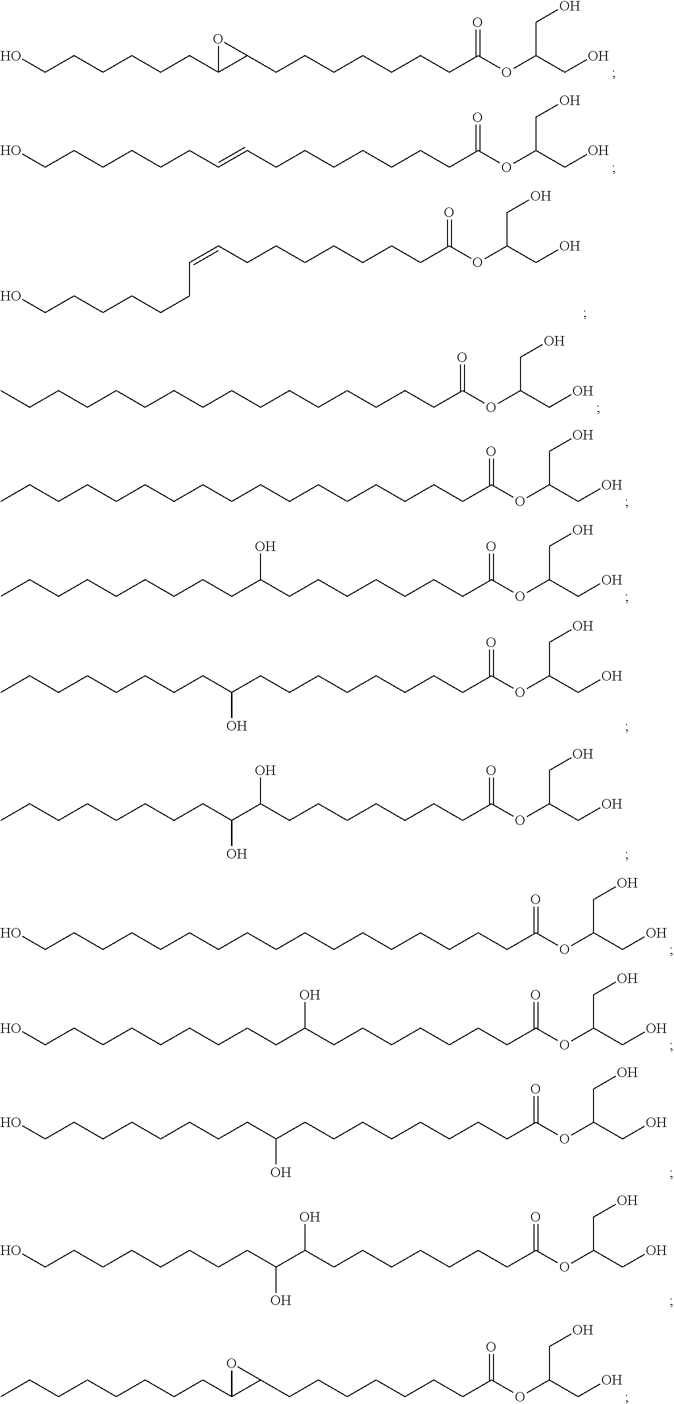

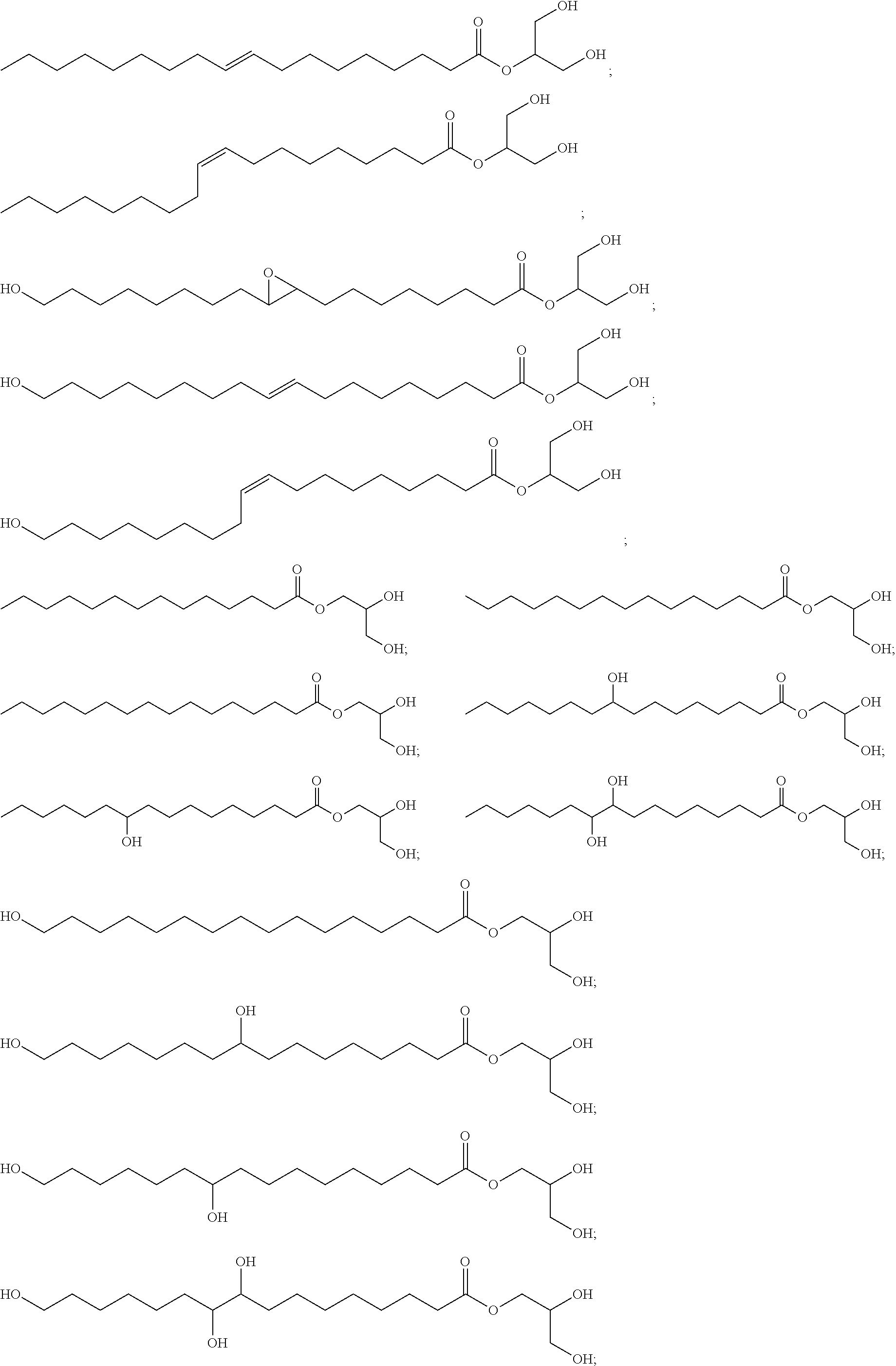

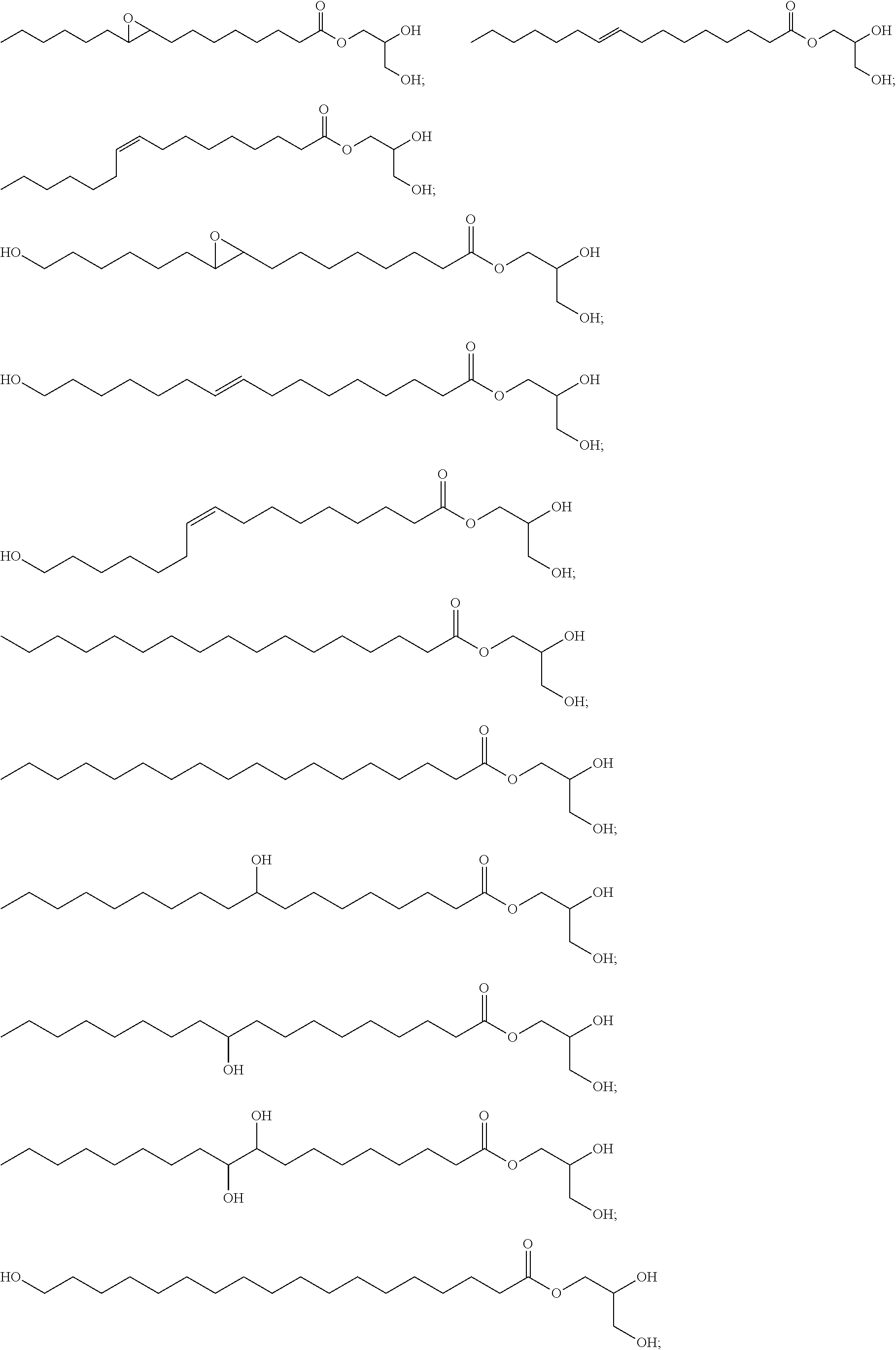

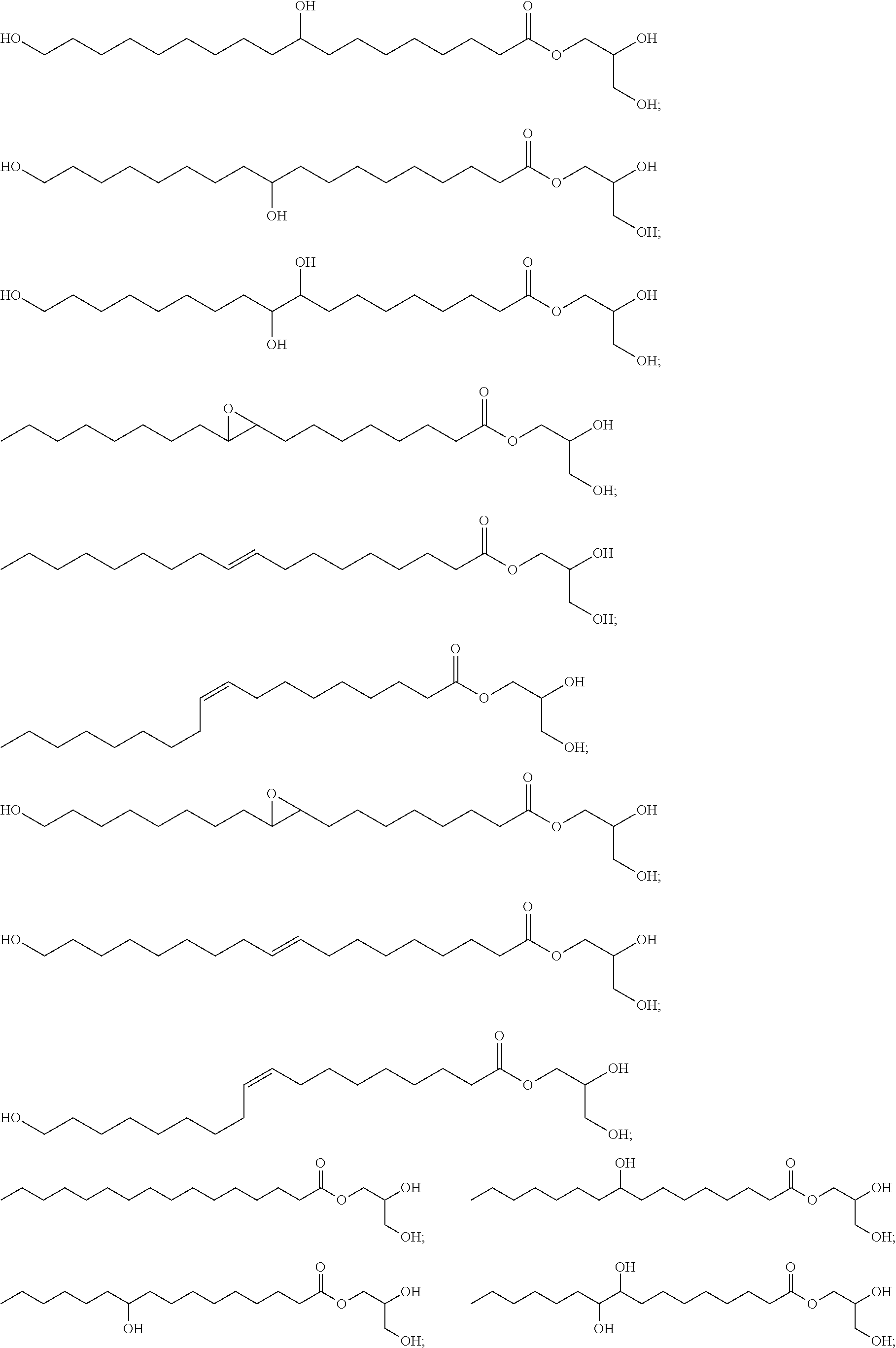

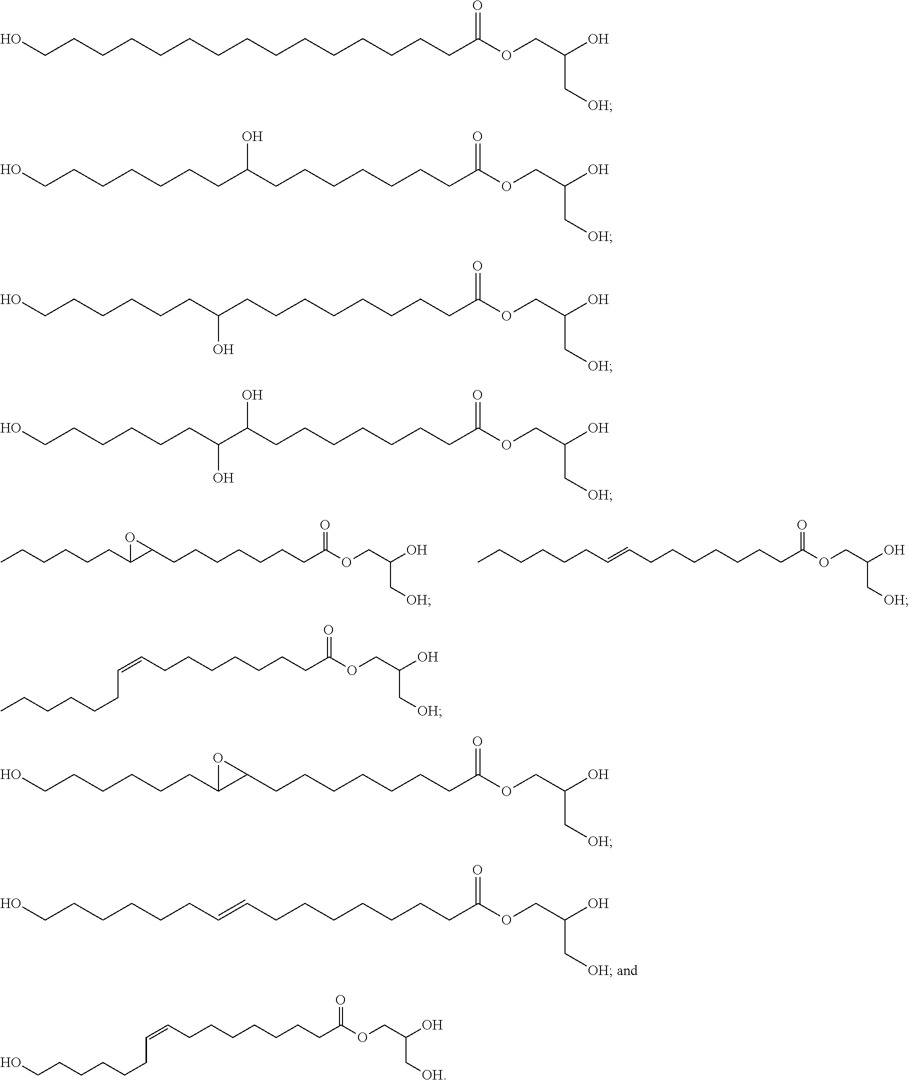

In another aspect, a mixture (e.g., a solution, suspension, or colloid) can include any of the compositions described herein in a solvent (e.g., dissolved, suspended, or dispersed in a solvent). Any of the mixtures described herein can include one or more of the following features. The solvent can be characterized as having a contact angle of at least about 70 degrees on carnauba wax. The solvent can be water or can be at least 70% water by volume. The solvent can include ethanol. The solvent can include water and ethanol. The mixture can include an antimicrobial agent, which can for example be citric acid. A concentration of the composition in the mixture can be in a range of 0.5 to 200 mg/mL. A concentration of the wetting agents in the mixture can be at least about 0.1 mg/mL.

In another aspect, a method of forming a mixture can include providing a solvent that is characterized as exhibiting a contact angle of at least about 70° (e.g., at least about 75°, at least about 80°, at least about 85°, or at least about 90°) when disposed on the surface of carnauba wax. The method can further include adding a composition to the solvent to form the mixture. The composition can include one or more fatty acids or salts or esters thereof, and/or can include compounds of Formula I, Formula II, and/or Formula III. The resulting mixture is characterized as exhibiting a contact angle less than about 85° (e.g., less than about 80°, less than about 75°, less than about 70°, or less than about 65°) when disposed on carnauba wax. The contact angle of the resulting mixture on carnauba wax can be less than the contact angle of the solvent (prior to the addition of the composition) on carnauba wax. Optionally, at least one of the fatty acids or salts or esters thereof of the composition can have a carbon chain length of 13 or less. Optionally, at least one of the fatty acids or salts or esters thereof of the composition can have a carbon chain length of 14 or greater. Optionally, the solvent can be water or can be at least 70% water by volume.

In another aspect, a method of forming a protective coating over a substrate (e.g., an agricultural product) can include applying a mixture (e.g., a solution, a suspension, or a colloid) to a surface of the substrate, the mixture comprising a composition in a solvent. The method can further include removing the solvent from the surface of the substrate, thereby causing the protective coating to be formed from the composition over the surface of the substrate. The composition can include compounds of Formula I, Formula II, and/or Formula III, where Formulas I, II, and III are as described throughout. For example, the composition can include (i) from 50% to 99% by mass of a first group of compounds, wherein each compound of the first group is a compound of Formula I, and (ii) from 1% to 50% by mass of a second group of compounds, wherein each compound of the second group is a salt of Formula II or Formula III.

### BRIEF DESCRIPTION OF THE FIGURES

FIG. 1 shows a plot of mass loss rates per day for finger limes coated with 1-glyceryl and 2-glyceryl esters of palmitic acid.

FIG. 2 shows a plot of mass loss factors for avocados coated with combinations of 1-glyceryl and 2-glyceryl esters of palmitic acid, stearic acid, and myristic acid.

FIG. 3 shows a plot of mass loss factors for avocados coated with combinations of fatty acids (MA, PA, and SA) and glyceryl esters of fatty acids (MA-1G, PA-1G, and SA-1G).

FIG. 4 shows a plot of mass loss factors for avocados coated with combinations of 1-glyceryl esters of palmitic acid, stearic acid, and myristic acid.

FIG. 5 is a high-resolution photograph of an avocado treated with a mixture of 1-glyceryl esters of undecanoic acid suspended in water.

FIG. 6 is a plot of percent mass loss of both treated and untreated blueberries over the course of 5 days.

FIG. 7 shows a plot of mass loss factors of lemons treated with various concentrations of SA-1G and SA-Na (mass ratio 4:1) suspended in water.

FIG. 8 shows a plot of mass loss factors of lemons treated with mixtures including various coating agents suspended in water.

FIG. 9 is a high-resolution photograph of an avocado treated with a mixture including a combination of medium and long chain fatty acid esters/salts suspended in water.

FIGS. 10 and 11 show graphs of contact angles of various mixtures on the surfaces of non-waxed lemons.

FIG. 12 shows a graph of contact angles of various solvents and mixtures on the surfaces of non-waxed lemons, candelilla wax, and carnauba wax.

FIG. 13 shows a plot of mass loss factors of avocados treated with mixtures including various combinations of medium and long chain fatty acid esters/salts suspended in water.

FIG. 14 shows a plot of mass loss factors of cherries treated with mixtures including various combinations of medium and long chain fatty acid esters/salts suspended in water.

FIG. 15 shows a plot of average daily mass loss rates of finger limes treated with mixtures including various combinations of medium and long chain fatty acid esters/salts suspended in water.

FIG. 16 shows a graph of contact angles of various solvents and mixtures on the surface of paraffin wax.

FIG. 17 shows the contact angle of a droplet on a solid surface.

FIG. 18 shows a plot of average daily mass loss rates of avocados treated with mixtures including various combinations of fatty acid esters and fatty acid salts suspended in water.

FIG. 19 shows a plot of average daily mass loss rates of avocados treated with mixtures including various combinations of fatty acid esters and emulsifiers suspended in water.

FIG. 20 shows a plot of mass loss factors for avocados treated with mixtures including various combinations of fatty acid esters and emulsifiers suspended in water at different concentrations.

FIG. 21 shows a plot of respiration factors for avocados treated with mixtures including various combinations of fatty acid esters and emulsifiers suspended in water at different concentrations.

FIG. 22 shows a representative image of a droplet of a mixture including a combination of fatty acid esters and fatty acid salts on a surface.

FIG. 23 shows a representative image of a droplet of a mixture including a combination of fatty acid esters and sodium laurel sulfate on a surface.

FIG. 24 shows the sources of heat generation or conduction in a shipping container.

FIG. 25 shows the average temperature of stacks of boxes of avocados, untreated and coated with a mixture of fatty acid esters and fatty acid salts, in different orientations after removal from 10° C. storage.

### DEFINITIONS

As used herein, the term “plant matter” refers to any portion of a plant, including, for example, fruits (in the botanical sense, including fruit peels and juice sacs), vegetables, leaves, stems, barks, seeds, flowers, peels, or roots. Plant matter includes pre-harvest plants or portions thereof as well as post-harvest plants or portions thereof, including, e.g., harvested fruits and vegetables, harvested roots and berries, and picked flowers.

As used herein, a “coating agent” refers to a composition including a compound or group of compounds from which a protective coating can be formed.

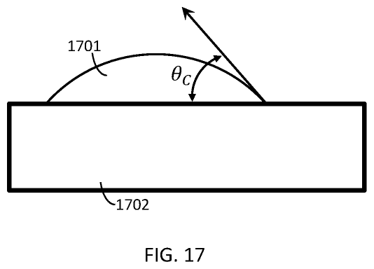

As used herein, the term “contact angle” of a liquid on a solid surface refers to an angle of the outer surface of a droplet of the liquid measured where the liquid-vapor interface meets the liquid-solid interface. For example, as shown in FIG. 17, the angle θ_{C} defines the contact angle of the droplet 1701 on the surface of solid 1702. The contact angle quantifies the wettability of the solid surface by the liquid.

As used herein, the terms “wetting agent” or “surfactant” each refer to a compound that, when added to a solvent, suspension, colloid, or solution, reduces the difference in surface energy between the solvent/suspension/colloid/solution and a solid surface on which the solvent/suspension/colloid/solution is disposed.

As used herein, the “carbon chain length” of a fatty acid or salt or ester thereof refers to the number of carbon atoms in the chain including the carbonyl carbon.

As used herein, a “long chain fatty acid”, a “long chain fatty acid ester”, or a “long chain fatty acid salt” refers to a fatty acid or ester or salt thereof, respectively, for which the carbon chain length is greater than 13 (i.e., is at least 14).

As used herein, a “medium chain fatty acid”, a “medium chain fatty acid ester”, or a “medium chain fatty acid salt” refers to a fatty acid or ester or salt thereof, respectively, for which the carbon chain length is in a range of 7 to 13 (inclusive of 7 and 13).

As used herein, a “cationic counter ion” is any organic or inorganic positively charged ion associated with a negatively charged ion. Examples of a cationic counter ion include, for example, sodium, potassium, calcium, and magnesium.

As used herein, a “cationic moiety” is any organic or inorganic positively charged ion.

The following abbreviations are used throughout. Hexadecanoic acid (i.e., palmitic acid) is abbreviated to “PA”. Octadecanoic acid (i.e., stearic acid) is abbreviated to “SA”. Tetradecanoic acid (i.e., myristic acid) is abbreviated to “MA”. (9Z)-Octadecenoic acid (i.e., oleic acid) is abbreviated to “OA”. Dodecanoic acid (e.g., lauric acid) is abbreviated to “LA”. Undecanoic acid (e.g., undecylic acid) is abbreviated to “UA”. Decanoic acid (e.g., capric acid) is abbreviated to “CA”. 1,3-dihydroxypropan-2-yl palmitate (i.e., 2-glyceryl palmitate) is abbreviated to “PA-2G”. 1,3-dihydroxypropan-2-yl octadecanoate (i.e., 2-glyceryl stearate) is abbreviated to “SA-2G”. 1,3-dihydroxypropan-2-yl tetradecanoic acid (i.e., 2-glyceryl myristate) is abbreviated to “MA-2G”. 1,3-dihydroxypropan-2-yl (9Z)-octadecenoate (i.e., 2-glyceryl oleate) is abbreviated to “OA-2G”. 2,3-dihydroxypropan-1-yl palmitate (i.e., 1-glyceryl palmitate) is abbreviated to “PA-1G”. 2,3-dihydroxypropan-1-yl octadecanoate (i.e., 1-glyceryl stearate) is abbreviated to “SA-1G”. 2,3-dihydroxypropan-1-yl tetradecanoate (i.e., 1-glyceryl myristate) is abbreviated to “MA-1G”. 2,3-dihydroxypropan-1-yl (9Z)-octadecenoate (i.e., 1-glyceryl oleate) is abbreviated to “OA-1G”. 2,3-dihydroxypropan-1-yl dodecanoate (i.e., 1-glyceryl laurate) is abbreviated to “LA-1G”. 2,3-dihydroxypropan-1-yl undecanoate (i.e., 1-glyceryl undecanoate) is abbreviated to “UA-1G”. 2,3-dihydroxypropan-1-yl decanoate (i.e., 1-glyceryl caprate) is abbreviated to “CA-1G”. Sodium salt of stearic acid is abbreviated to “SA-Na”. Sodium salt of myristic acid is abbreviated to “MA-Na”. Sodium salt of palmitic acid is abbreviated to “PA-Na”. Potassium salt of stearic acid is abbreviated to “SA-K”. Potassium salt of myristic acid is abbreviated to “MA-K”. Potassium salt of palmitic acid is abbreviated to “PA-K”. Calcium salt of stearic acid is abbreviated to “(SA)₂-Ca”. Calcium salt of myristic acid is abbreviated to “(MA)₂-Ca”. Calcium salt of palmitic acid is abbreviated to “(PA)₂-Ca”. Magnesium salt of stearic acid is abbreviated to “(SA)₂-Mg”. Magnesium salt of myristic acid is abbreviated to “(MA)₂-Mg”. Magnesium salt of palmitic acid is abbreviated to “(PA)₂-Mg”.

“Substituted” or “substituent”, as used herein, means an atom or group of atoms is replaced with another atom or group of atoms. Exemplary substituents include, but are not limited to, halogen, hydroxyl, nitro, cyano, alkyl, alkenyl, alkynyl, cycloalkyl, cycloalkenyl, formyl, acyl, ether, ester, keto, aryl, heteroaryl, etc.

As used herein, the “mass loss rate” refers to the rate at which the product loses mass (e.g. by releasing water and other volatile compounds). The mass loss rate is typically expressed as a percentage of the original mass per unit time (e.g. percent per day).

As used herein, the term “mass loss factor” is defined as the ratio of the average mass loss rate of uncoated produce (measured for a control group) to the average mass loss rate of the corresponding coated produce at a given time. Hence a larger mass loss factor corresponds to a greater reduction in average mass loss rate for the coated produce.

As used herein, the “respiration rate” refers to the rate at which the product releases CO₂, and more specifically is the volume of CO₂ (at standard temperature and pressure) released per unit time per unit mass of the product. The respiration rate is typically expressed as ml CO₂/kg hour. The respiration rate of the product can be measured by placing the product in a closed container of known volume that is equipped with a CO₂ sensor, recording the CO₂ concentration within the container as a function of time, and then calculating the rate of CO₂ release required to obtain the measured concentration values.

As used herein, the term “respiration factor” is defined as the ratio of the cumulative respiration of uncoated produce (measured for a control group) to the cumulative respiration of the corresponding coated produce. Hence a larger respiration factor corresponds to a greater reduction in cumulative respiration for the coated produce.

### DETAILED DESCRIPTION

Described herein are solutions, suspensions, or colloids containing a composition (e.g., a coating agent) in a solvent that can be used to form protective coatings over substrates such as plant matter, agricultural products, or food products. The protective coatings can, for example, prevent water loss from the substrates, oxidation of the substrates, and/or can shield the substrates from threats such as bacteria, fungi, viruses, and the like. The coatings can also protect the substrates from physical damage (e.g., bruising) and photodamage. Accordingly, the coating agents, solutions/suspensions/colloids, and the coatings formed thereof can be used to help store agricultural or other food products for extended periods of time without spoiling. In some instances, the coatings and the coating agents from which they are formed can allow for food to be kept fresh in the absence of refrigeration. The coating agents and coatings described herein can also be edible (i.e., the coating agents and coatings can be non-toxic for human consumption). In some particular implementations, the solutions/suspensions/colloids include a wetting agent or surfactant which cause the solution/suspension/colloid to better spread over the entire surface of the substrate during application, thereby improving surface coverage as well as overall performance of the resulting coating. In some particular implementations, the solutions/suspensions/colloids include an emulsifier which improves the solubility of the coating agent in the solvent and/or allows the coating agent to be suspended or dispersed in the solvent. The wetting agent and/or emulsifier can each be a component of the coating agent, or can be separately added to the solution/suspension/colloid.

Plant matter (e.g., agricultural products) and other degradable items can be protected against degradation from biotic or abiotic stressors by forming a protective coating over the outer surface of the product. The coating can be formed by adding the constituents of the coating (herein collectively a “coating agent”) to a solvent (e.g., water and/or ethanol) to form a mixture (e.g., a solution, suspension, or colloid), applying the mixture to the outer surface of the product to be coated, e.g., by dipping the product in the mixture or by spraying the mixture over the surface of the product, and then removing the solvent from the surface of the product, e.g., by allowing the solvent to evaporate, thereby causing the coating to be formed from the coating agent over the surface of the product. The coating agent can be formulated such that the resulting coating provides a barrier to water and/or oxygen transfer, thereby preventing water loss from and/or oxidation of the coated product. The coating agent can additionally or alternatively be formulated such that the resulting coating provides a barrier to CO₂, ethylene and/or other gas transfer.

Coating agents including long chain fatty acids (e.g., palmitic acid, stearic acid, myristic acid, and/or other fatty acids having a carbon chain length greater than 13) and/or esters or salts thereof can both be safe for human consumption and can be used as coating agents to form coatings that are effective at reducing mass loss and oxidation in a variety of produce. For example, coatings formed from coating agents that include various combinations of palmitic acid, myristic acid, stearic acid, 1-glyceryl esters of palmitic acid (i.e., 2,3-dihydroxypropan-1-yl palmitate, herein “PA-1G”), 2-glyceryl esters of palmitic acid (i.e., 1,3-dihydroxypropan-2-yl palmitate, herein “PA-2G”), 1-glyceryl esters of myristic acid (i.e., 2,3-dihydroxypropan-1-yl tetradecanoate, herein “MA-1G”), 1-glyceryl esters of stearic acid (i.e., 2,3-dihydroxypropan-1-yl octadecenoate, herein “SA-1G”), and/or other long chain fatty acids or salts or esters thereof have been shown to be effective at reducing mass loss rates in many types of produce, for example finger limes, avocados, blueberries, and lemons. Specific examples of a variety of coatings and their effects in reducing mass loss rates in various types of produce are provided in Examples 1-4 below.

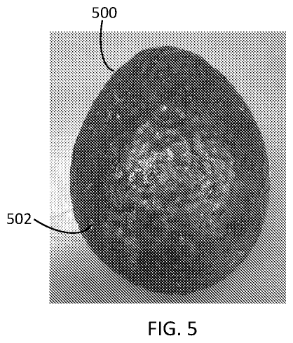

Medium chain fatty acids (e.g., having a carbon chain length in a range of 7 to 13) and/or salts or esters thereof can also be used as coating agents to form coatings over produce or other plant matter or agricultural products using the methods described above. However, these compounds have typically been found to cause damage to the produce or plant matter, and also typically result in minimal to no reduction in mass loss rates. For example, treating avocados with a solution of 1-glyceryl esters of undecanoic acid (i.e., 2,3-dihydroxypropan-1-yl undecanoate, herein “UA-1G”) suspended in water at a concentration as low as 5 mg/mL (UA-1G has a carbon chain length of 11) was shown to cause the avocados' skins to change from being virtually entirely green to having a high density of black discolored regions as a result of skin damage caused by the UA-1G. As seen in FIG. 5, which is a high-resolution photograph of one of the avocados 500 after treatment with the suspension described above, the skin of the previously green avocado exhibited numerous black discolored regions 502 after treatment.

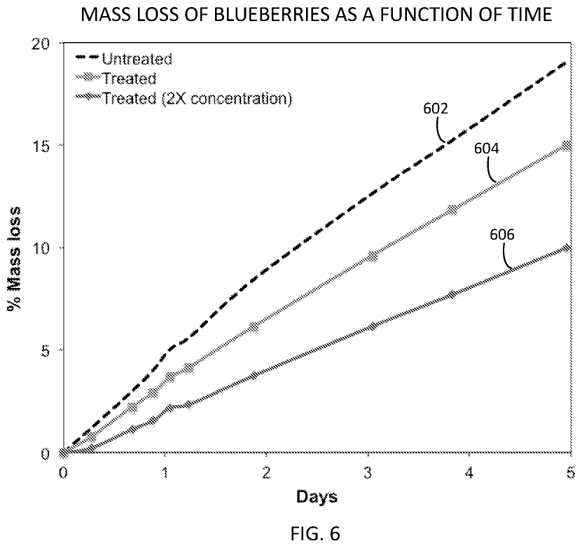

It is generally expected that for coatings that are formulated to prevent water loss from or oxidation of coated substrates such as produce, thicker coatings will be less permeable to water and oxygen as compared to thinner coatings formed from the same coating agent, and should therefore result in lower mass loss rates as compared to thinner coatings. Thicker coatings can be formed by increasing the concentration of the coating agent in the solution/suspension/colloid and applying a similar volume of solution/suspension/colloid to each piece of (similarly sized) produce. The effect of increasing the coating thickness on harvested produce is demonstrated in FIG. 6, which shows plots of the percent mass loss over the course of 5 days in untreated blueberries (602), blueberries treated with a first solution including 10 mg/mL of coating agent compounds dissolved in ethanol (604), and blueberries treated with a second solution including 20 mg/mL of coating agent compounds dissolved in ethanol (606). The coating agents in both the first and second solutions were about 75% PA-2G and about 25% PA-1G by mass. As shown, the mass loss rates of the blueberries decreased significantly with increasing coating thickness.

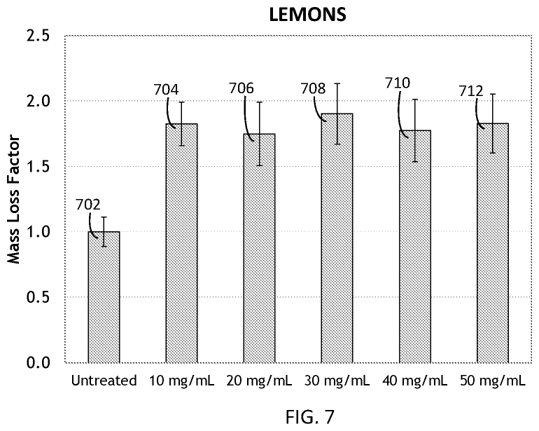

For certain solutions/suspensions/colloids including long chain fatty acids and/or salts or esters thereof dissolved or suspended or dispersed in a solvent, protective coatings formed over certain types of produce by the methods described above were found to reduce the mass loss rate of the produce but did not result in lower mass loss rates as the thickness of the coating was increased, as in the blueberries described above. Instead, the mass loss rate in these cases was found to be lower than in uncoated produce but was approximately the same for thinner and thicker coatings. For example, FIG. 7 shows a plot of mass loss factor of lemons treated with various concentrations of a coating agent (e.g., SA-1G and SA-Na combined at a mass ratio of 4:1) suspended or dispersed in water. Bar 702 corresponds to a group of untreated lemons. Bar 704 corresponds to a group of lemons for which the concentration of coating agent in the solvent was 10 mg/mL. Bar 706 corresponds to a group of lemons for which the concentration of coating agent in the solvent was 20 mg/mL. Bar 708 corresponds to a group of lemons for which the concentration of coating agent in the solvent was 30 mg/mL. Bar 710 corresponds to a group of lemons for which the concentration of coating agent in the solvent was 40 mg/mL. Bar 712 corresponds to a group of lemons for which the concentration of coating agent in the solvent was 50 mg/mL. As shown in FIG. 7, while the mass loss factor for all the coated lemons was greater than 1 (indicating that the coating was causing a reduction in the mass loss rate), the mass loss rate was approximately the same for all coating agent concentrations tested in a range of 10 mg/mL to 50 mg/mL and hence did not vary with concentration.

Surprisingly, for many cases in which the mass loss rate did not vary with coating thickness (as with the lemons in FIG. 7), it was found that if a small concentration of medium chain fatty acids and/or salts or esters thereof was added to the mixture (i.e., the solution, suspension, or colloid) prior to application to produce (e.g., by including them in the coating agent at a lower concentration than that of the long chain fatty acids and/or salts or esters thereof, or by separately adding them to the mixture), then mass loss rates did increase with coating thickness. Furthermore, in many of these cases, the resulting mass loss rates for coatings that included a small concentration of medium chain fatty acids and/or salts or esters thereof were substantially lower as compared to coatings formed from coating agents that lacked the medium chain fatty acids and/or salts or esters thereof but were otherwise identical, and surface damage to the produce in these cases was either absent or minimal. These results were particularly surprising in view of the fact that medium chain fatty acids and/or salts or esters thereof were generally found to cause damage to produce or other plant matter when applied individually at similar concentrations, as shown in FIG. 5.

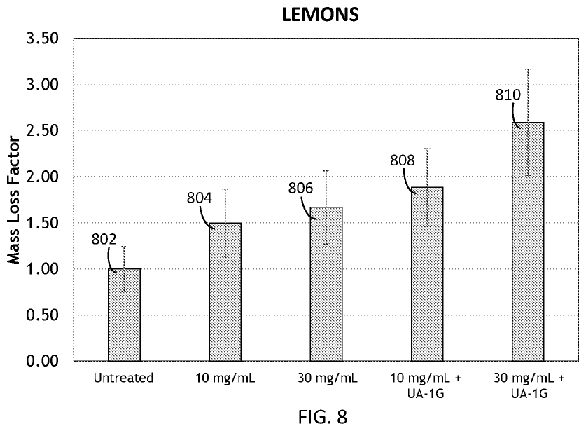

The beneficial effects of adding small concentrations of medium chain fatty acids or salts or esters thereof to coating solutions/suspensions/colloids that include long chain fatty acids or salts/esters thereof are shown in FIG. 8. FIG. 8 is a graph showing mass loss factors of untreated lemons (802), lemons treated with suspensions in which the coating agent included only long chain fatty acid esters and fatty acid salts (804 and 806), and lemons treated with suspensions in which the coating agent included a small concentration of medium chain fatty acids or salts or esters thereof in combination with a larger concentration of long chain fatty acid esters and fatty acid salts (808 and 810). Specifically, bar 804 corresponds to lemons treated with 10 mg/mL of the long chain fatty acid esters/salts suspended in water. Bar 806 corresponds to lemons treated with 30 mg/mL of the long chain fatty acid esters/salts solvent in water. Bar 808 corresponds to lemons treated with 10 mg/mL of long chain fatty acid esters/salts plus 5 mg/mL of medium chain fatty acid esters solvent in water. Bar 810 corresponds to lemons treated with 30 mg/mL of long chain fatty acid esters/salts plus 5 mg/mL of medium chain fatty acid esters solvent in water.

While treating the lemons with the coating agents that only included long chain fatty acid salts and esters (804 and 806) did reduce the average mass loss rate of the lemons, the mass loss factor did not substantially increase when the concentration of the coating agent compounds in the mixture was increased from 10 mg/mL (804) to 30 mg/mL (806). However, the mass loss factor did increase substantially when a small concentration of medium chain fatty acid esters (5 mg/mL of UA-1G) was added to each of the mixtures. Specifically, adding 5 mg/mL of medium chain esters to the mixture with 10 mg/mL of long chain fatty acid esters/salts caused the mass loss factor of the lemons due to the resulting coatings to increase from about 1.5 (bar 804) to about 1.9 (bar 808), corresponding to an increase in mass loss factor of over 25%. Adding 5 mg/mL of medium chain esters to the mixture with 30 mg/mL of long chain fatty acid esters/salts caused the mass loss factor of the lemons due to the resulting coatings to increase from about 1.7 (bar 806) to about 2.6 (bar 810), corresponding to an increase in mass loss factor of over 50%. The mass loss factor of the lemons corresponding to bar 810 was in fact substantially larger than that of groups of lemons coated with any of the concentrations of long chain fatty acid esters/salts in solution for which medium chain fatty acids or salts/esters thereof were not also added.

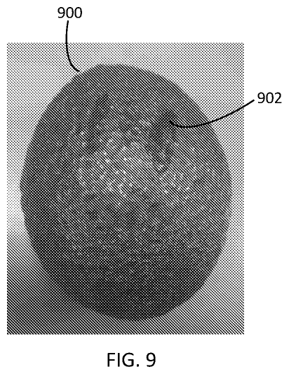

FIG. 9 is a high-resolution photograph of an avocado 900 treated with the same mixture used to treat the lemons of bar 810 in FIG. 8 (5 mg/mL of UA-1G plus 30 mg/mL of long chain fatty acid esters/salts suspended in water). Prior to treatment, the avocado skin was virtually entirely green (not shown). As seen in FIG. 9, after treatment the avocado skin was mostly still green, with only a small density of black discolored regions 902, indicating that the treatment caused very little skin damage to the avocado. In contrast, the avocado shown in FIG. 5, which was treated with a solution that included the same concentration of UA-1G in water (5 mg/mL) but lacked the long chain fatty acid esters/salts, displayed extensive skin damage.

Without wishing to be bound by theory, it is believed that many of the mixtures (i.e., solutions, suspensions, or colloids) that lacked the medium chain fatty acids or salts/esters thereof were not sufficiently wetting the entire surface of the produce to which they were applied due to a difference in surface energy of the mixture as compared to that of the surface of the produce. Consequently, the coatings formed from these mixtures did not completely cover the surface of the produce. As such, mass loss was dominated by water loss through the openings in the coating, and was relatively unaffected by increasing the coating thickness. Thus, in cases where this effect was believed to occur (e.g., in lemons coated from a water-based solution such as in FIG. 7), mass loss rates were relatively unaffected by increasing the thickness of the coating.

It is further believed that the medium chain fatty acids that were added to the mixtures acted as surfactants/wetting agents, reducing the contact angle of the mixture on the surface of the produce. The addition of the wetting agents was believed to improve coverage of the mixture over the surface of the produce, thereby allowing a substantially contiguous coating to be formed over the entire surface. Consequently, the mass loss rates of coated produce were found to decrease with increasing coating thickness, and overall mass loss rates were found to be substantially reduced as compared to produce coated with similar mixtures that lacked the wetting agents. Furthermore, the long chain fatty acids and/or salts or esters thereof appeared to suppress surface damage to the produce observed in cases where the wetting agent was dissolved, dispersed, or suspended in the mixture and applied on its own without also including the long chain fatty acids and/or salts or esters thereof. Additional evidence of these effects is provided below.

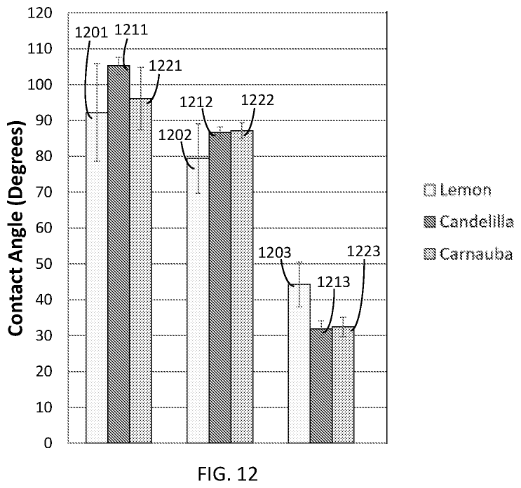

Through extensive experimentation, it was found that the contact angle of droplets of some solvents and coating solutions/suspensions on the surfaces of at least some types of produce was quite large, indicating a large difference in surface energy of the droplets as compared to the surface of the produce. This effect was particularly evident in cases where the coating solution/suspension was at least 70% water by volume, since the surfaces of many plants or other agricultural products often tend to be hydrophobic due to the presence of epicuticular waxes. This phenomenon was characterized as follows. Droplets of solvent or coating solution/suspension/colloid (i.e., solvent with coating agent dissolved, suspended or dispersed therein) were deposited either directly on produce surfaces or directly on carnauba, candellila, or paraffin wax (carnauba, candellila, and paraffin wax all tend to have similar native hydrophobicity to that of the surfaces of lemons as well as many other types of produce, see FIG. 12 for example), and contact angles were determined with image analysis software. Results of various studies are summarized as follows.

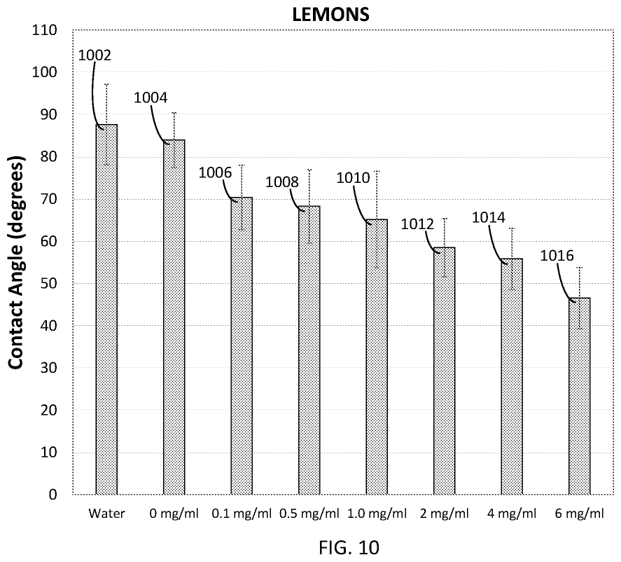

Increasing the concentration of the wetting agent (e.g., the medium chain fatty acids and/or salts or esters thereof) in water-based or high water content coating mixtures generally decreased the contact angle of the solution/suspension/colloid on the produce or wax surface. For example, as shown in FIG. 10, water (bar 1002) exhibited a contact angle of about 88° on the surface of non-waxed lemons, and coating mixtures containing only long chain fatty acid esters/salts (SA-1G and MA-Na combined at a mass ratio of 95:5) suspended in water at a concentration of 30 mg/mL (bar 1004) exhibited a contact angle of about 84°. However, as small concentrations of medium chain fatty acid esters (e.g., CA-1G) were added, the contact angle gradually decreased from about 70° for 0.1 mg/mL of CA-1G (bar 1006) to about 47° for 6 mg/mL of CA-1G (bar 1016).

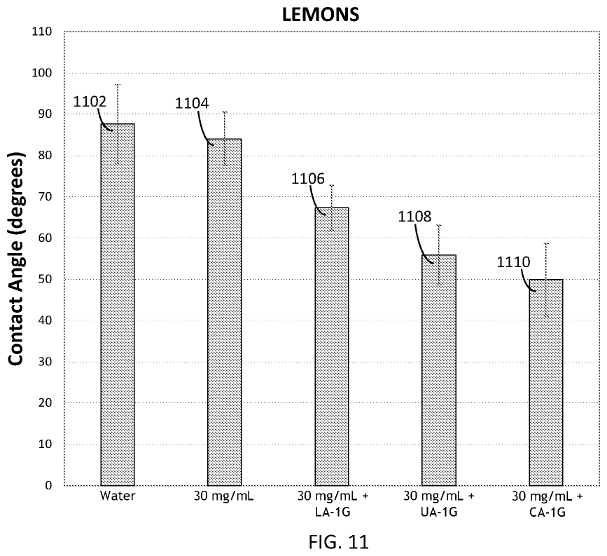

It was further found that for many mixtures, the addition of medium chain fatty acids and/or salts or esters thereof having a smaller chain length caused a larger reduction in contact angle of droplets on produce than addition of similar concentrations of medium chain fatty acids and/or salts or esters thereof having a longer chain length. For example, FIG. 11 shows results of a study in which different medium chain fatty acid esters (C10, C11, and C12) were added to water-based coating mixtures, and contact angles of droplets of the various mixtures on non-waxed lemons were measured. Bar 1102 corresponds to droplets of water. Bar 1104 corresponds to SA-1G and MA-Na combined at a mass ratio of 95:5 and suspended in water at a concentration of 30 mg/mL. Bars 1106, 1108, and 1110 correspond to the same mixture as bar 1104 but with the addition of 4 mg/mL of LA-1G (for bar 1106), 4 mg/mL of UA-1G (for bar 1108), or 4 mg/mL of CA-1G (for bar 1110).

As seen in FIG. 11, drops of water (1102) on lemons as well as drops of the mixture that included only long chain fatty acid esters/salts (1104) on lemons exhibited larger contact angles than mixtures for which a small concentration of medium chain fatty acid esters (1106, 1108, and 1110) were added. Furthermore, for a given concentration of medium chain fatty acid esters, the contact angle decreased with decreasing carbon chain length. Specifically, the mixtures that lacked the medium chain fatty acid esters (1102 and 1104) exhibited contact angles of about 84° to 88°. Adding 4 mg/mL of LA-1G (carbon chain length of 12) decreased the contact angle to about 67°, adding 4 mg/mL of UA-1G (carbon chain length of 11) decreased the contact angle to about 56°, and adding 4 mg/mL of CA-1G (carbon chain length of 10) decreased the contact angle to about 50°.

As previously described, carnauba, candellila, and paraffin wax were all found to have similar native hydrophobicity to that of the surfaces of lemons (as well as other produce). Hence the wetting properties (e.g., contact angle) of mixtures characterized on carnauba, candellila, or paraffin wax surfaces are typically predictive of the wetting properties of the mixtures on produce. For example, FIG. 12 shows contact angles of water as well as two other mixtures on the surfaces of lemons (bars 1201-1203), candellila wax (bars 1211-1213), and carnauba wax (bars 1221-1223). The first group of bars (1201, 1211, and 1221) each correspond to water, and the contact angle on all 3 surfaces was in a range of about 92° to 105°. The second group of bars (1202, 1212, and 1222) correspond to a suspension for which the solvent was water and the coating agent included 30 mg/mL of SA-1G and SA-Na (long chain fatty acid salts/esters) combined at a mass ratio of 94:6, as well as 0.25 mg/mL of citric acid and 0.325 mg/mL of sodium bicarbonate. As shown, the contact angle on all 3 surfaces was in a range of about 80° to 88°, which was slightly lower than for pure water but was still generally quite large. The third group of bars (1203, 1213, and 1223) correspond to a suspension which was the same as that of the second group of bars but also included 3 mg/mL of CA-1G (medium chain fatty acid ester). As shown, the contact angles on all 3 surfaces remained quite similar to one another and were greatly reduced as compared to the solutions which lacked the medium chain fatty acid esters, each being in a range of about 31° to 44°.

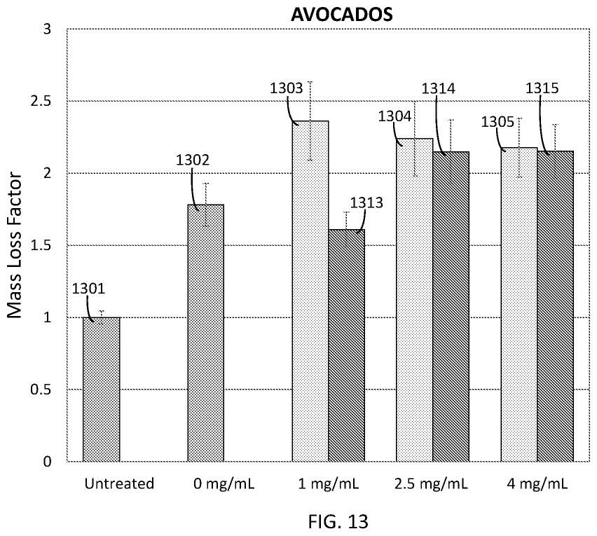

The effects of adding small concentrations of LA-1G and CA-1G to coating mixtures used to form coatings on avocados is shown in the graph of FIG. 13. As seen, avocados coated from a mixture that included SA-1G and MA-Na (long chain fatty acid esters/salts) combined at a mass ratio of 94:6 and suspended in water at a concentration of 30 mg/mL (bar 1302) exhibited a mass loss factor of about 1.78. Bars 1303-1305 show the effects of adding CA-1G to the mixture at concentrations of 1 mg/mL, 2.5 mg/mL, and 4 mg/mL, respectively, and bars 1313-1315 show the effects of adding LA-1G to the mixture at concentrations of 1 mg/mL, 2.5 mg/mL, and 4 mg/mL, respectively.

The addition of the CA-1G (carbon chain length of 10) to the coating mixture increased the mass loss factor to about 2.35 for a CA-1G concentration of 1 mg/mL (bar 1303), to about 2.24 for a CA-1G concentration of 2.5 mg/mL (bar 1304), and to about 2.18 for a CA-1G concentration of 4 mg/mL (bar 1305). So while the mass loss factor was substantially larger for all concentrations of CA-1G in a range of 1 to 4 mg/mL as compared to mixtures lacking the medium chain fatty acid esters (bar 1302), the mass loss factor appeared to decrease slightly as the concentration of CA-1G was increased. Without wishing to be bound by theory, it is believed that the addition of CA-1G at all concentrations of at least 1 mg/mL was effective at improving the wetting of the solution on the surfaces of the avocados, but that increasing the concentration of the CA-1G began to cause some moderate damage to the avocados, thereby mitigating the beneficial surface wetting effects and causing a slight decrease in the mass loss factor.

Still referring to FIG. 13, the addition of the LA-1G (carbon chain length of 12) to the coating mixture caused a decrease in the mass loss factor to about 1.61 for an LA-1G concentration of 1 mg/mL (bar 1313), but caused the mass loss factor to increase to about 2.15 for LA-1G concentrations of both 2.5 mg/mL (bar 1314) and 4 mg/mL (bar 1315). Without wishing to be bound by theory, it is believed that at a concentration of 1 mg/mL of LA-1G, the surface wetting of the solution was not sufficiently improved to overcome surface damage to the avocados caused by the LA-1G, and so the mass loss factor decreased relative to treatment by the coating mixture that lacked the medium chain fatty acid esters. However, for larger concentrations of LA-1G, the surface wetting was sufficiently improved such that the mass loss factor substantially increased relative to treatment by the coating solution that lacked the medium chain fatty acid esters. This result is consistent with that of FIG. 11, which found that shorter chain fatty esters (e.g., CA-1G) caused a larger reduction in contact angle as compared to longer chain fatty esters (e.g., LA-1G) when added to water-based coating mixtures at the same concentration.

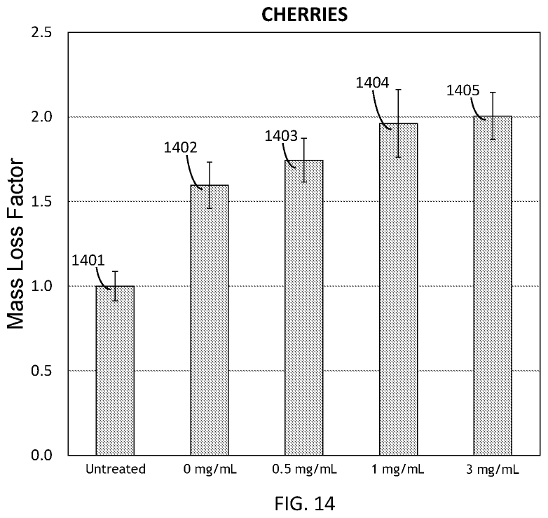

The effects of adding small concentrations of CA-1G to coating mixtures used to form coatings on cherries is shown in FIG. 14. As seen, cherries coated from a mixture that included SA-1G and MA-Na (long chain fatty acid esters/salts) combined at a mass ratio of 94:6 and suspended in water at a concentration of 40 mg/mL (bar 1402) exhibited a mass loss factor of about 1.60. Bars 1403-1405 show the effects of adding CA-1G to the mixture at concentrations of 0.5 mg/mL, 1 mg/mL, and 3 mg/mL, respectively. The addition of the CA-1G (carbon chain length of 10) to the coating mixture increased the mass loss factor to about 1.75 for a CA-1G concentration of 0.5 mg/mL (bar 1403), to about 1.96 for a CA-1G concentration of 1 mg/mL (bar 1404), and to about 2.00 for a CA-1G concentration of 4 mg/mL (bar 1405). As shown, the addition of small concentrations of CA-1G to the mixture increased the mass loss factor of the coated cherries. This increase was believed to result from the improved surface wetting resulting from the addition of the CA-1G to the coating mixture.

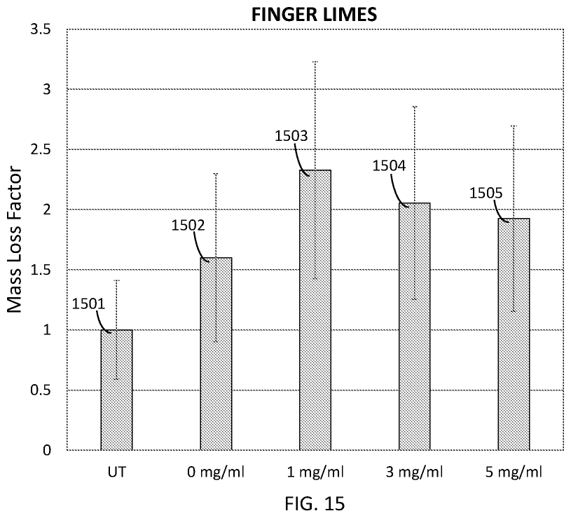

The effects of adding small concentrations of UA-1G to coating mixtures used to form coatings on finger limes is shown FIG. 15. As seen, finger limes coated from a mixture that included SA-1G and SA-Na (long chain fatty acid esters/salts) combined at a mass ratio of 94:6 and suspended in water at a concentration of 30 mg/mL (bar 1502) exhibited a mass loss factor of about 1.61. Bars 1503-1505 show the effects of adding UA-1G to the mixture at concentrations of 1 mg/mL, 3 mg/mL, and 5 mg/mL, respectively. The addition of the UA-1G (carbon chain length of 11) to the mixture increased the mass loss factor to about 2.33 for a UA-1G concentration of 1 mg/mL (bar 1503), to about 2.06 for a UA-1G concentration of 3 mg/mL (bar 1504), and to about 1.93 for a UA-1G concentration of 5 mg/mL (bar 1505). Although the addition of UA-1G did increase the mass loss factor of the finger limes at all concentrations in a range of 1 to 5 mg/mL, the peak mass loss factor occurred at 1 mg/mL, and the mass loss factor decreased as the concentration of UA-1G increased. Without wishing to be bound by theory, it is believed that increasing the concentration of UA-1G began to damage the surface of the finger limes, and that any improvements in surface wetting caused by the increased UA-1G concentration were not sufficient to mitigate this effect, thus resulting in gradually decreasing mass loss factors with increasing UA-1G concentrations.

As described throughout, wetting agents can be included in coating solutions/suspensions/colloids in order to improve the surface wetting of substrates to which the solutions/suspensions/colloids are applied, thereby resulting in improved surface coverage of the coatings that are formed thereover. The wetting agents can be included within or as part of the coating agent that is dissolved or suspended in the solvent to form the coating solution/suspension/colloid. That is, a sub-group of the compounds of the coating agent can cause a change in surface energy of the solvent to which the coating agent is added, thereby acting as a wetting agent. Alternatively, the wetting agent can be a separate compound (or group of compounds) from the coating agent, and can be added to the solvent either before, after, or at the same time as the coating agent.

Alternatively, the wetting agent can be a separate compound (or group of compounds) from the coating agent and can be applied to the surface prior to applying the coating agent. For example, the wetting agent can first be added to a separate solvent to form a wetting agent solution/suspension/colloid. The wetting agent solution/suspension/colloid can then be applied to the surface, after which the coating solution/suspension/colloid is applied to the surface to form the coating. Priming of the surface in this manner can improve the surface wetting of the coating solution/suspension/colloid with the surface.

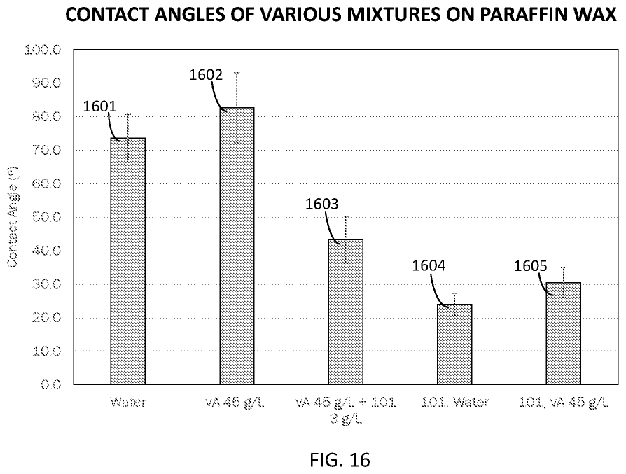

An example of the surface priming effect described above is shown in FIG. 16, which is a graph of contact angles of various solvents or mixtures on the surface of paraffin wax. As shown, water applied directly to the paraffin wax surface (bar 1601) exhibited an average contact angle of 74°. When a coating agent mixture of SA-1G and SA-Na combined at a mass ratio of 95:5 was dispersed in water at a concentration of 45 mg/mL and applied directly to the paraffin wax surface (bar 1602), the average contact angle was even larger (83°). However, when a wetting agent (e.g., a medium chain fatty acid or salt/ester thereof) was added to the coating agent mixture, the contact angle of the coating agent mixture was substantially reduced. Additionally, when a wetting agent (e.g., a medium chain fatty acid or salt/ester thereof) was applied to the paraffin wax surface prior to applying either the water or the coating agent mixture, the contact angle was also substantially reduce. For example, when 3 mg/mL of CA-1G was added to the mixture corresponding to bar 1602, the resulting contact angle (bar 1603) was 43°. When the paraffin wax surface was primed by applying a wetting agent mixture of CA-1G at a concentration of 3 mg/mL in water and then allowing the surface to dry prior to applying water (bar 1604) or the SA-1G/SA-Na coating agent mixture described above (bar 1605), the resulting contact angles were 24° and 30°, respectively.

The solvent to which the coating agent and wetting agent (when separate from the coating agent) is added to form the solution/suspension/colloid can, for example, be water, methanol, ethanol, isopropanol, butanol, acetone, ethyl acetate, chloroform, acetonitrile, tetrahydrofuran, diethyl ether, methyl tert-butyl ether, an alcohol, any other suitable solvent, or a combination thereof. The resulting solutions, suspensions, or colloids can be suitable for forming coatings on agricultural products. For example, the solutions, suspensions, or colloids can be applied to the surface of the agricultural product, after which the solvent can be removed (e.g., by evaporation or convective drying), leaving a protective coating formed from the coating agent on the surface of the agricultural product.

While a number of the solvents above (particularly water and ethanol) can be safely and effectively used in solutions/suspensions/colloids that are applied to edible products such as produce or other agricultural products, in many cases it can be advantageous to use either water or otherwise a solvent which is at least about 40% (and in many cases higher) water by volume. This is because water is typically cheaper than other suitable solvents and can also be safer to work with than solvents that have a higher volatility and/or a lower flash point (e.g., acetone or alcohols such as isopropanol or ethanol). Accordingly, for any of the solutions/suspensions/colloids described herein, the solvent or solution/suspension/colloid can be at least about 40%, at least about 45%, at least about 50%, at least about 55%, at least about 60%, at least about 65%, at least about 70%, at least about 75%, at least about 80%, at least about 85%, at least about 90%, at least about 95%, or at least about 99% water by mass or by volume. In some implementations, the solvent includes a combination of water and ethanol, and can optionally be at least about 40%, at least about 45%, at least about 50%, at least about 55%, at least about 60%, at least about 65%, at least about 70%, at least about 75%, at least about 80%, at least about 85%, at least about 90%, at least about 95%, or at least about 99% water by volume. In some implementations, the solvent or solution/suspension/colloid can be about 40% to 100% water by mass or volume, about 40% to 99% water by mass or volume, about 40% to 95% water by mass or volume, about 40% to 90% water by mass or volume, about 40% to 85% water by mass or volume, about 40% to 80% water by mass or volume, about 50% to 100% water by mass or volume, about 50% to 99% water by mass or volume, about 50% to 95% water by mass or volume, about 50% to 90% water by mass or volume, about 50% to 85% water by mass or volume, about 50% to 80% water by mass or volume, about 60% to 100% water by mass or volume, about 60% to 99% water by mass or volume, about 60% to 95% water by mass or volume, about 60% to 90% water by mass or volume, about 60% to 85% water by mass or volume, about 60% to 80% water by mass or volume, about 70% to 100% water by mass or volume, about 70% to 99% water by mass or volume, about 70% to 95% water by mass or volume, about 70% to 90% water by mass or volume, about 70% to 85% water by mass or volume, about 80% to 100% water by mass or volume, about 80% to 99% water by mass or volume, about 80% to 97% water by mass or volume, about 80% to 95% water by mass or volume, about 80% to 93% water by mass or volume, about 80% to 90% water by mass or volume, about 85% to 100% water by mass or volume, about 85% to 99% water by mass or volume, about 85% to 97% water by mass or volume, about 85% to 95% water by mass or volume, about 90% to 100% water by mass or volume, about 90% to 99% water by mass or volume, about 90% to 98% water by mass or volume, or about 90% to 97% water by mass or volume.

In view of the above, for some applications the solvent can be a low wetting solvent (i.e., a solvent exhibiting a large contact angle with respect to the surface to which it is applied). For example, in the absence of any added wetting agents or other surfactants, the contact angle between the solvent and either (a) carnauba wax, (b) candelilla wax, (c) paraffin wax, or (d) the surface of a non-waxed lemon can be at least about 70°, for example at least about 75°, 80°, 85°, or 90°. Addition of any of the wetting agents described herein to the solvent, either alone or in combination with other compounds or coating agents, can cause the contact angle between the resulting solution/suspension/colloid and either (a) carnauba wax, (b) candelilla wax, (c) paraffin wax, or (d) the surface of a non-waxed lemon to be less than about 85°, for example less than about 80°, 75° 70°, 65°, 60°, 55° 50°, 45° 40°, 35° 30°, 25°, 20°, 15°, 10°, 5° or 0°.

The coating agent that is added to or dissolved, suspended, or dispersed in the solvent to form the coating solution/suspension/colloid can be any compound or combination of compounds capable of forming a protective coating over the substrate to which the solution/suspension/colloid is applied. The coating agent can be formulated such that the resulting coating protects the substrate from biotic and/or abiotic stressors. For example, the coating can prevent or suppress the transfer of oxygen and/or water, thereby preventing the substrate from oxidizing and/or from losing water via transpiration/osmosis/evaporation. In cases where the substrate is perishable and/or edible, for example when the substrate is a plant, an agricultural product, or a piece of produce, the coating agent is preferably composed of non-toxic compounds that are safe for consumption. For example, the coating agent can be formed from or include fatty acids and/or salts or esters thereof. The fatty acid esters can, for example, be ethyl esters, methyl esters, or glyceryl esters (e.g., 1-glyceryl or 2-glyceryl esters).

Coating agents formed from or containing a high percentage of long chain fatty acids and/or salts or esters thereof (e.g., having a carbon chain length of at least 14) have been found to be effective at forming protective coatings over a variety of substrates that can prevent water loss from and/or oxidation of the substrate. The addition of one or more medium chain fatty acids and/or salts or esters thereof (or other wetting agents) can further improve the performance of the coatings. Accordingly, the coating agents herein can include one or more compounds of Formula I, wherein Formula I is:

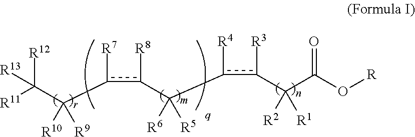

wherein:

R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen (e.g., C₁, Br, or I), hydroxyl, nitro, —CN, —NH₂, —SH, —SR¹⁵, —OR¹⁴, —NR¹⁴R¹⁵, C₁-C₆ alkyl, C₂-C₆ alkenyl, or C₂-C₆ alkynyl;

R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;

R³, R⁴, R⁷, and R⁸ are each independently, at each occurrence, —H, —OR¹⁴, —NR¹⁴R, —SR¹⁴, halogen, —C₁-C₆ alkyl, —C₂-C₆ alkenyl, —C₂-C₆ alkynyl, —C₃-C₇ cycloalkyl, aryl, or heteroaryl wherein each alkyl, alkynyl, cycloalkyl, aryl, or heteroaryl is optionally substituted with one or more —OR¹⁴, —NR¹⁴R¹⁵, —SR¹⁴, or halogen; or

R³ and R⁴ can combine with the carbon atoms to which they are attached to form a C₃-C₆ cycloalkyl, a C₄-C₆ cycloalkenyl, or 3- to 6-membered ring heterocycle; and/or

R⁷ and R⁸ can combine with the carbon atoms to which they are attached to form a C₃-C₆ cycloalkyl, a C₄-C₆ cycloalkenyl, or 3- to 6-membered ring heterocycle;

R¹⁴ and R¹⁵ are each independently, at each occurrence, —H, aryl, heteroaryl, —C₁-C₆ alkyl, —C₂-C₆ alkenyl, or —C₂-C₆ alkynyl;

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

In some embodiments, R is selected from —H, —CH₃, or —CH₂CH₃. In some embodiments, R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more C₁-C₆ alkyl or hydroxyl.

As further described herein, the coating agents can additionally or alternatively include fatty acid salts such as sodium salts (e.g., SA-Na, PA-Na, or MA-Na), potassium salts (e.g., SA-K, PA-K, MA-K), calcium salts (e.g., (SA)₂-Ca, (PA)₂-Ca, or (MA)₂-Ca) or magnesium salts (e.g., (SA)₂-Mg, (PA)₂-Mg, or (MA)₂-Mg). Accordingly, the coating agents herein can include one or more compounds of Formula II or Formula III, wherein Formula II and Formula III are:

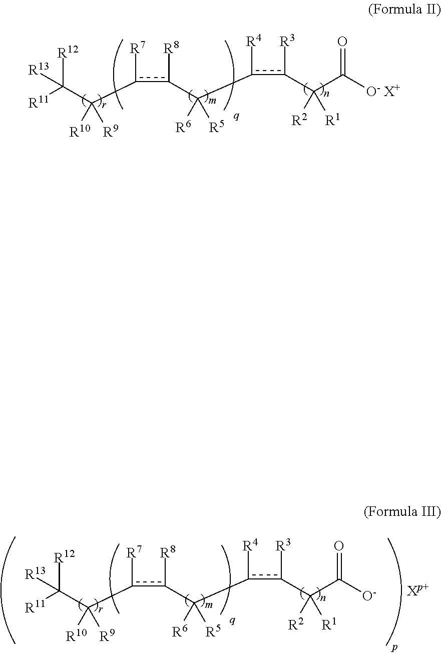

wherein for each formula:

X is a cationic moiety;

X^{p+} is a cationic counter ion having a charge state p, and p is 1, 2, or 3;

R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;

R³, R⁴, R⁷, and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl wherein each alkyl, alkynyl, cycloalkyl, aryl, or heteroaryl is optionally substituted with one or more —OR¹⁴, —NR¹⁴R¹⁵, —SR¹⁴, or halogen; or

R³ and R⁴ can combine with the carbon atoms to which they are attached to form a C₃-C₆ cycloalkyl, a C₄-C₆ cycloalkenyl, or 3- to 6-membered ring heterocycle; and/or

R⁷ and R⁸ can combine with the carbon atoms to which they are attached to form a C₃-C₆ cycloalkyl, a C₄-C₆ cycloalkenyl, or 3- to 6-membered ring heterocycle;

R¹⁴ and R¹⁵ are each independently, at each occurrence, —H, aryl, heteroaryl, —C₁-C₆ alkyl, —C₂-C₆ alkenyl, or —C₂-C₆ alkynyl;

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

Any of the coating agents described herein can include one or more of the following medium chain fatty acid compounds (e.g., compounds of Formula I):

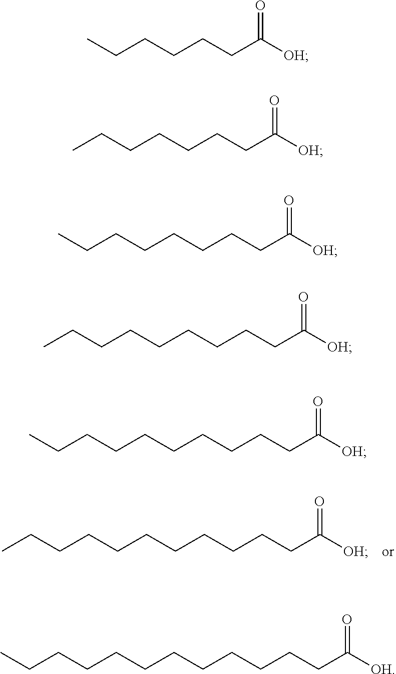

Any of the coating agents described herein can include one or more of the following long chain fatty acid compounds (e.g., compounds of Formula I):

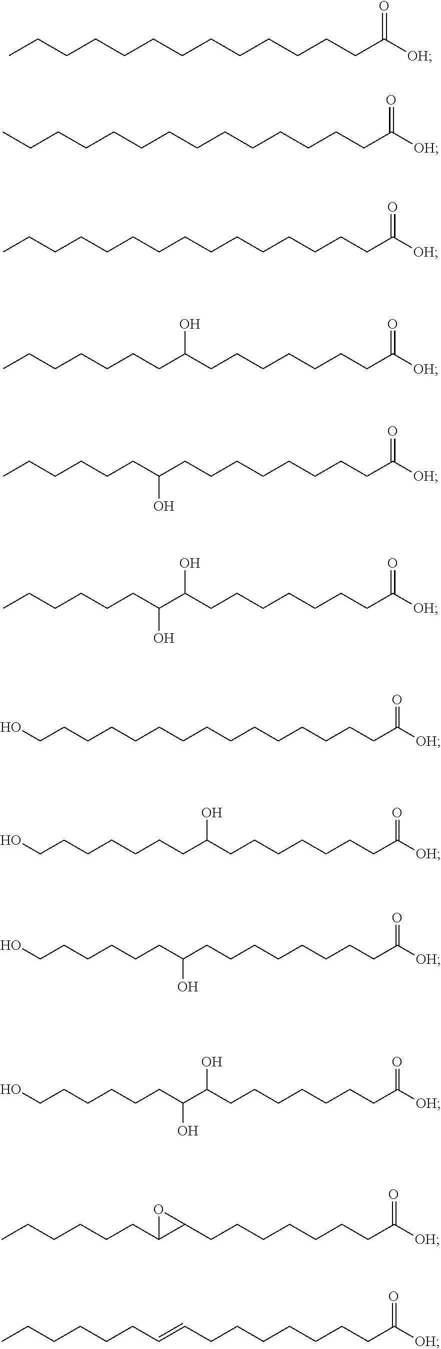

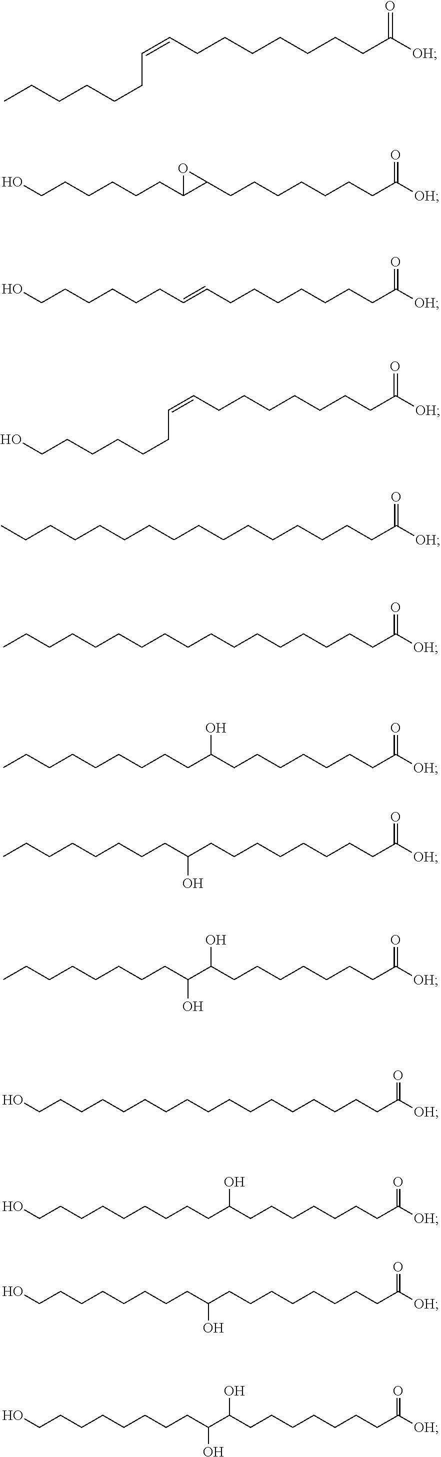

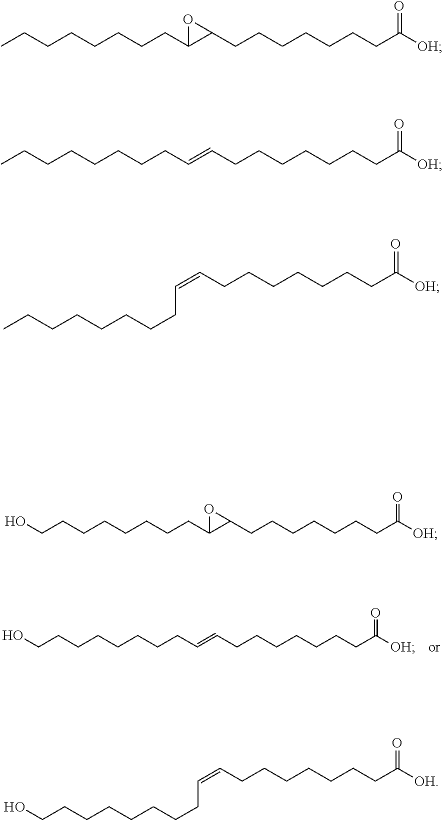 [SMILES: CCCCCCCCC1OC1CCCCCCCC(=O)O ; CCCCCCCC/C=C/CCCCCCCC(=O)O ; CCCCCCCC/C=C\CCCCCCCC(=O)O ; O=C(O)CCCCCCCC1OC1CCCCCCCCO ; O=C(O)CCCCCCC/C=C/CCCCCCCCO ; O=C(O)CCCCCCC/C=C\CCCCCCCCO]

The coating agents herein can include one or more of the following medium chain fatty acid methyl ester compounds (e.g., compounds of Formula I):

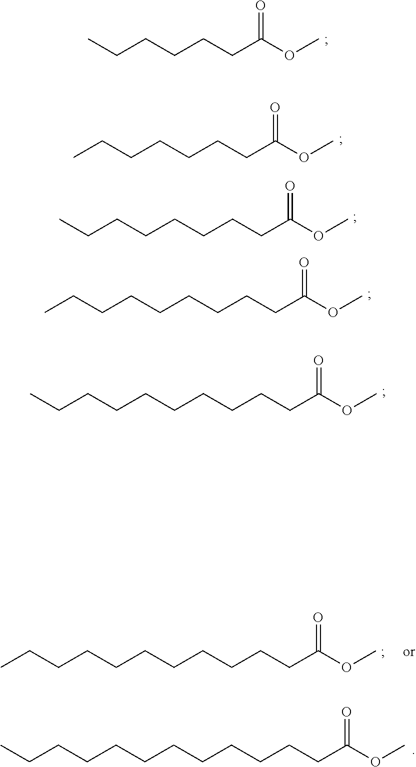

The coating agents herein can include one or more of the following long chain fatty acid methyl ester compounds (e.g., compounds of Formula I):

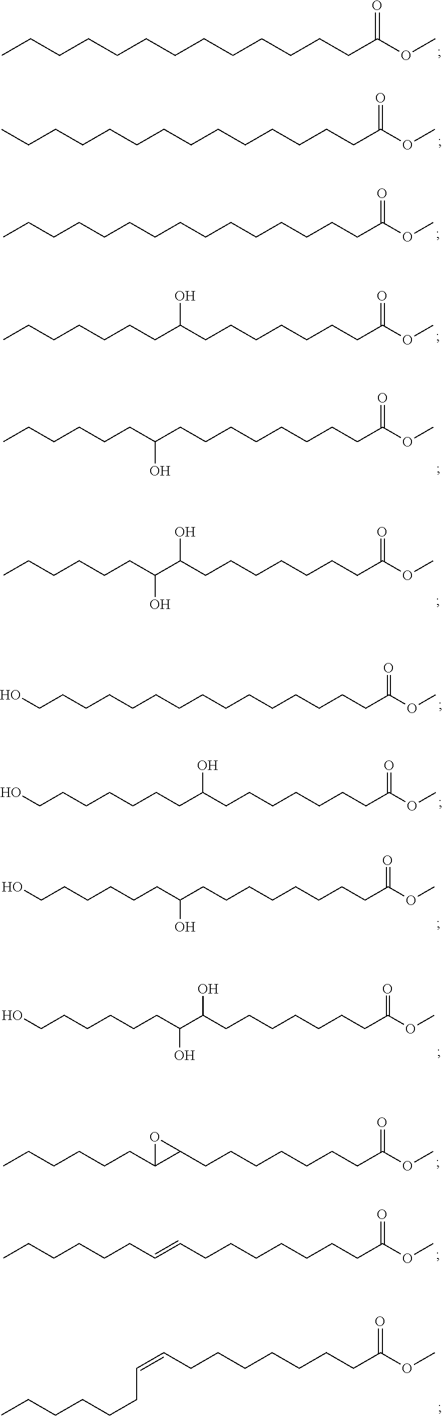

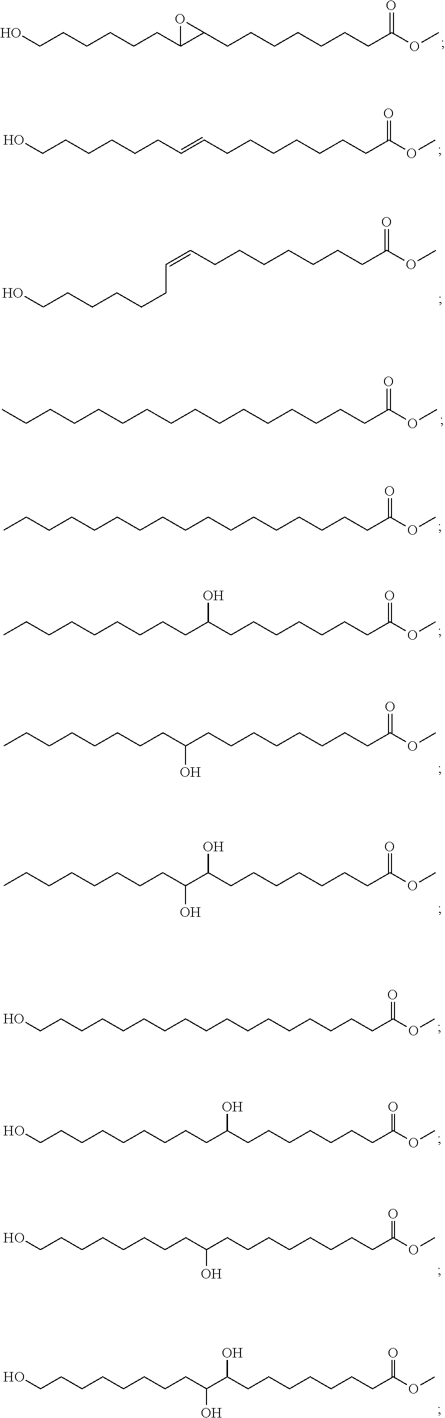

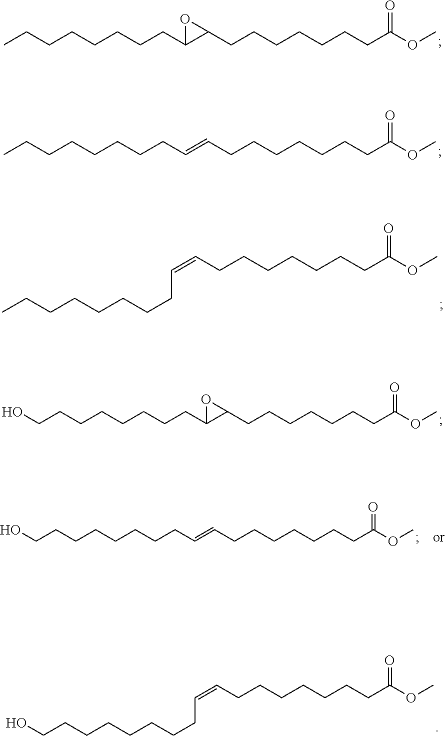

The coating agents herein can include one or more of the following medium chain fatty acid ethyl ester compounds (e.g., compounds of Formula I):

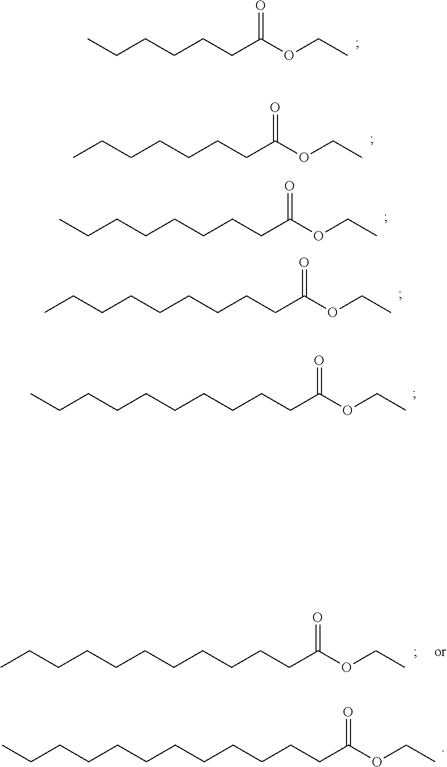

The coating agents herein can include one or more of the following long chain fatty acid ethyl ester compounds (e.g., compounds of Formula I):

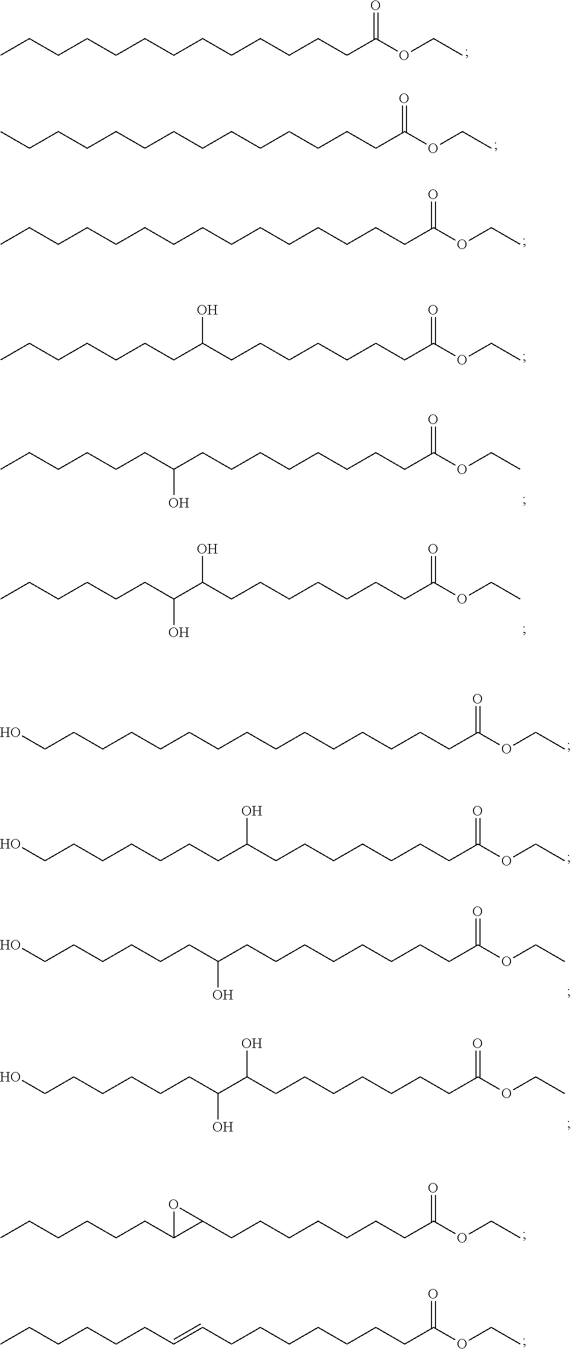

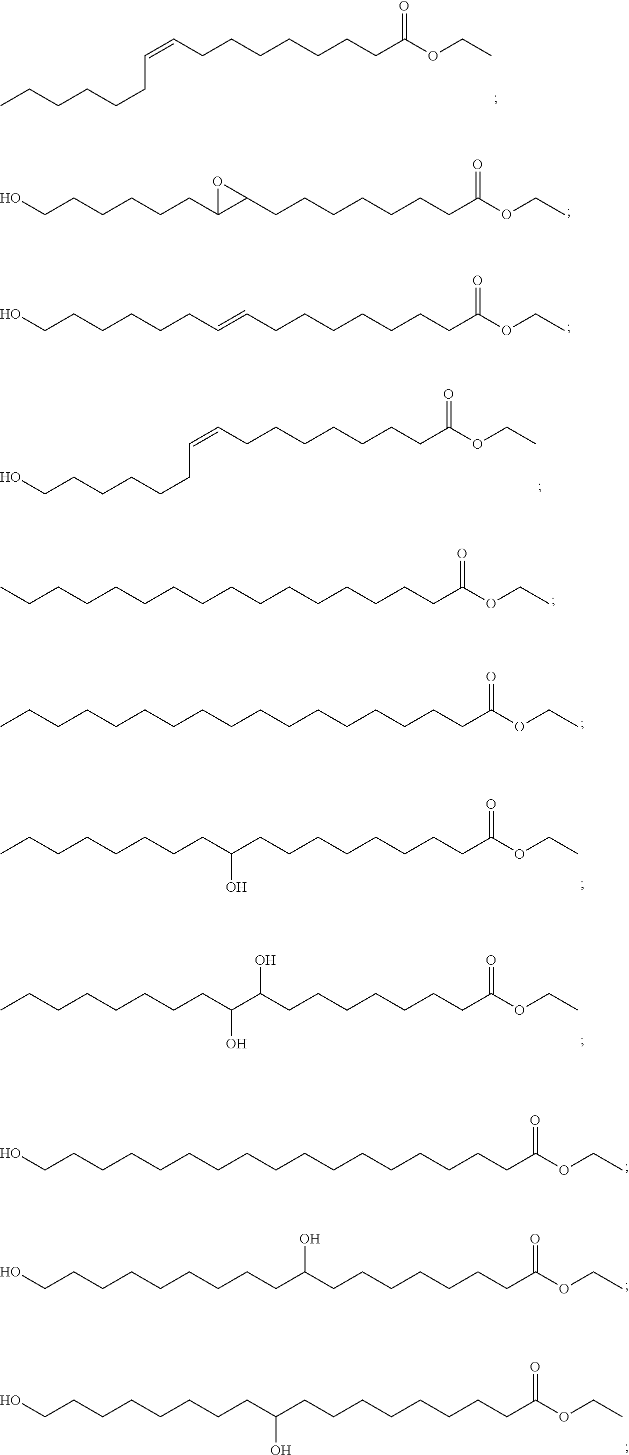

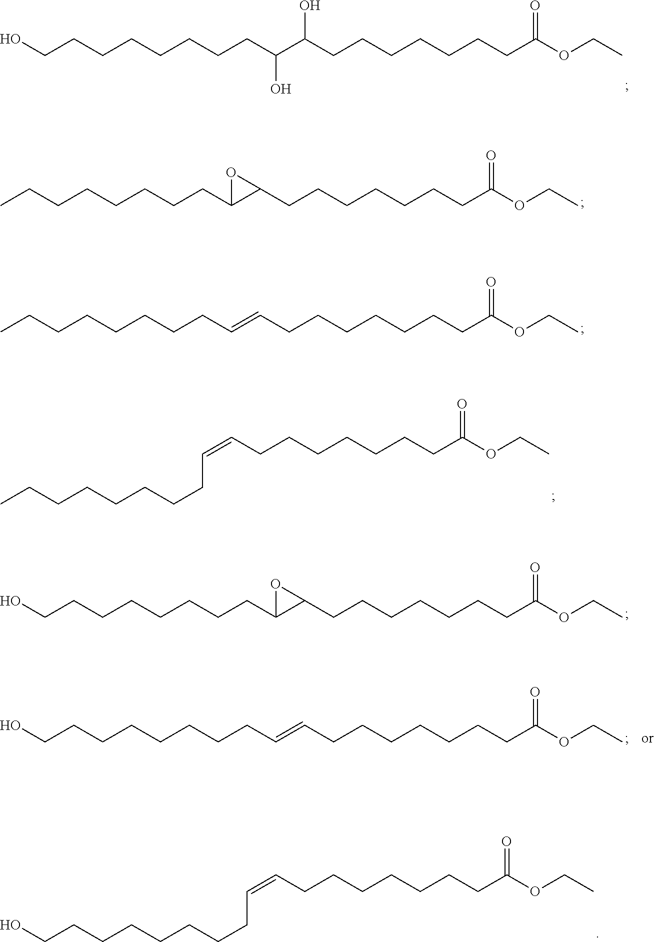

The coating agents herein can include one or more of the following medium chain fatty acid 2-glyceryl ester compounds (e.g., compounds of Formula I).

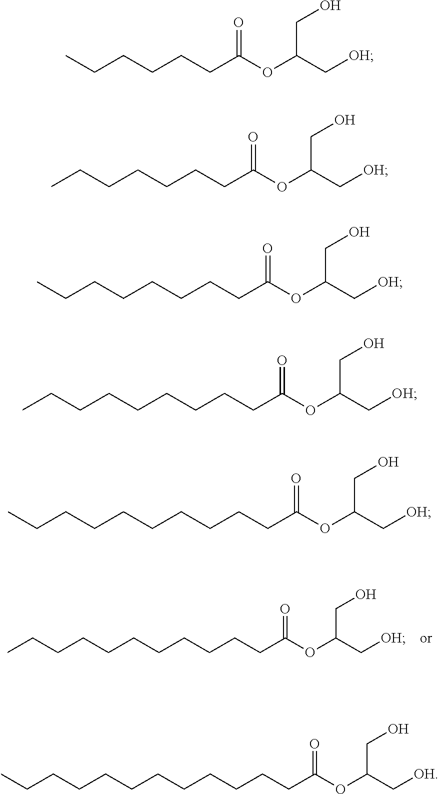

The coating agents herein can include one or more of the following long chain fatty acid 2-glyceryl ester compounds (e.g., compounds of Formula I).

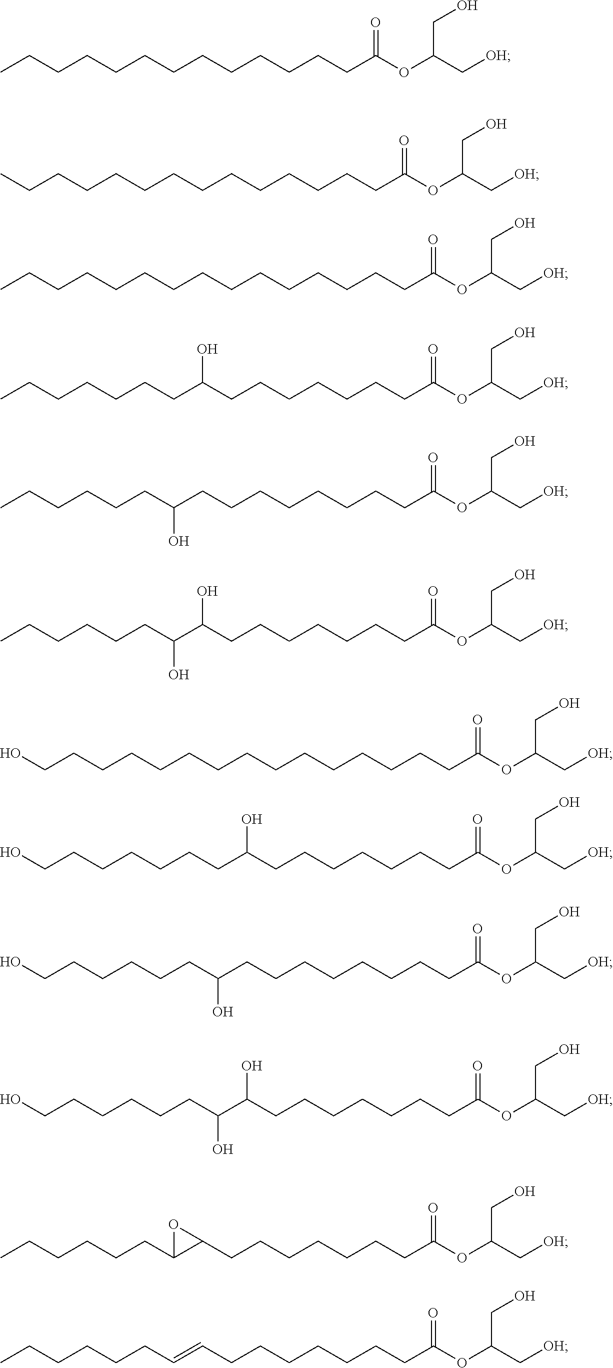

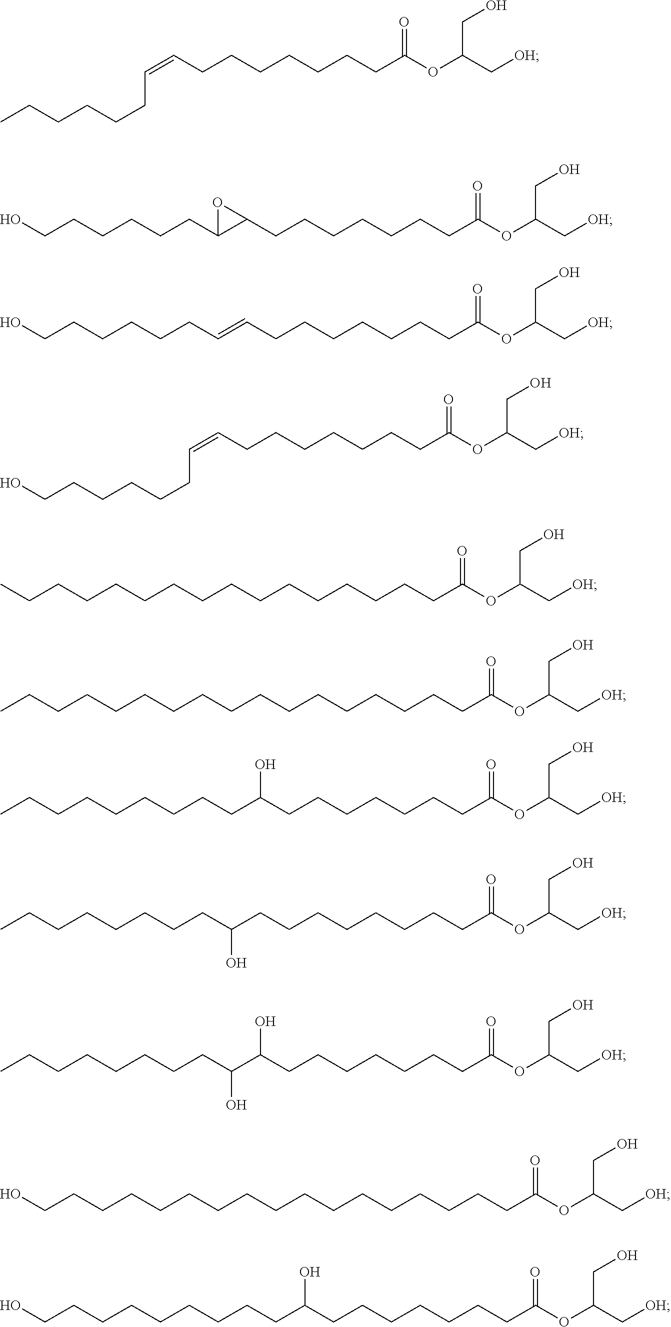

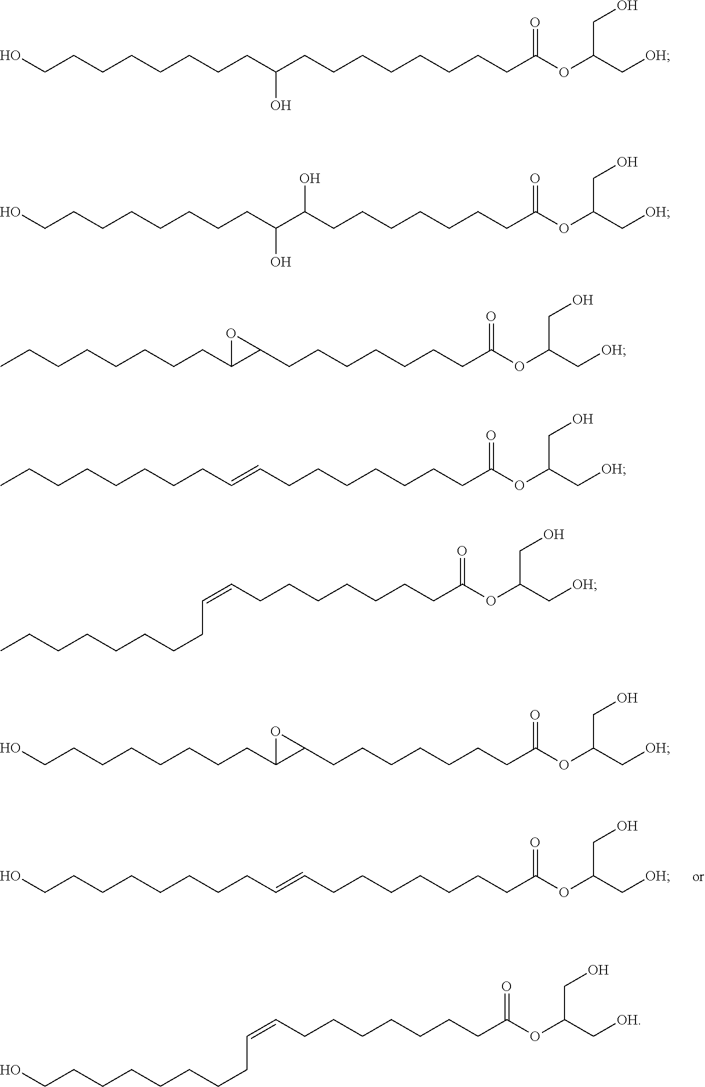

The coating agents herein can include one or more of the following medium chain fatty acid 1-glyceryl ester compounds (e.g., compounds of Formula I):

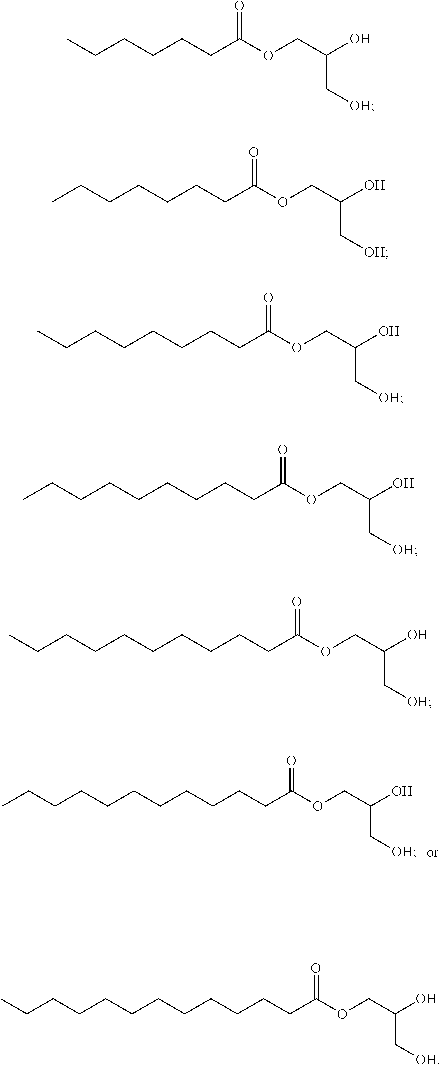

The coating agents herein can include one or more of the following long chain fatty acid 1-glyceryl ester compounds (e.g., compounds of Formula I):

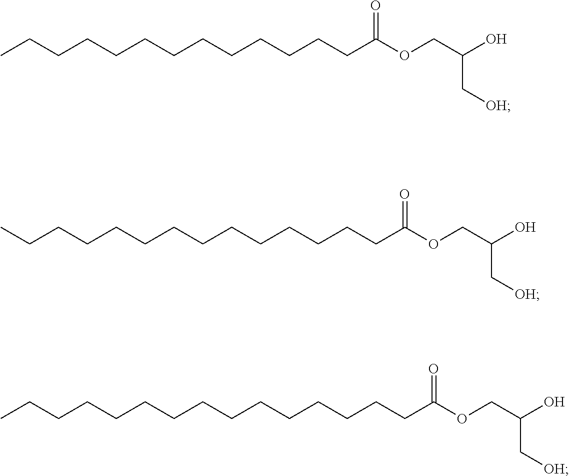 [SMILES: CCCCCCCCCCCCCC(=O)OCC(O)CO ; CCCCCCCCCCCCCCC(=O)OCC(O)CO ; CCCCCCCCCCCCCCCC(=O)OCC(O)CO]

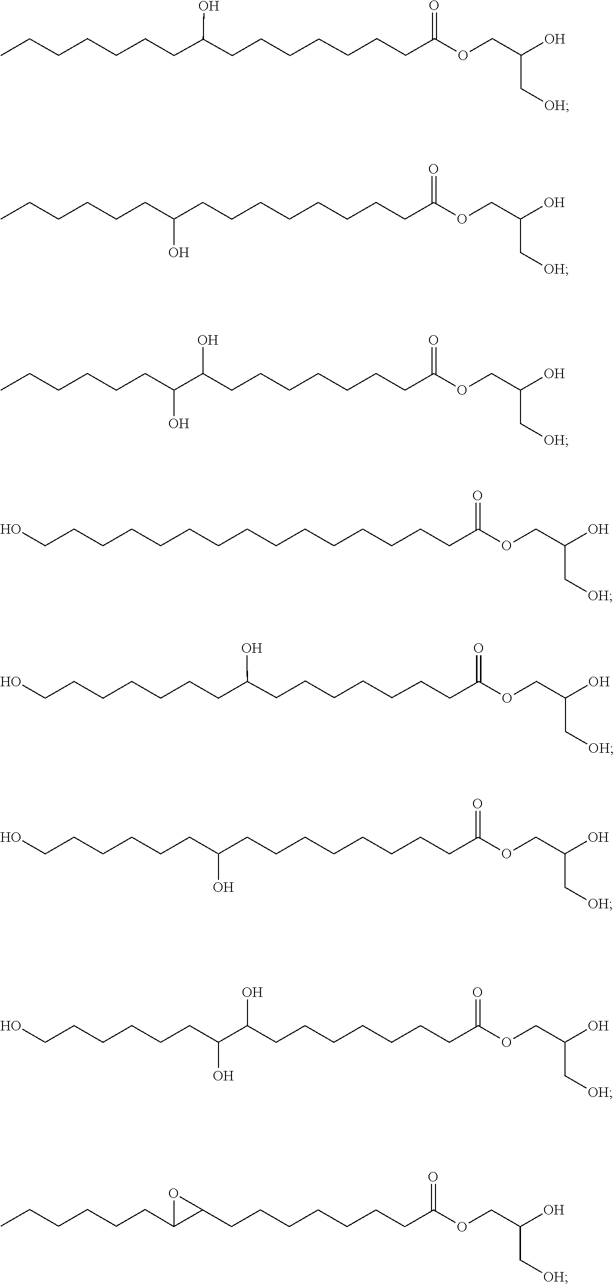

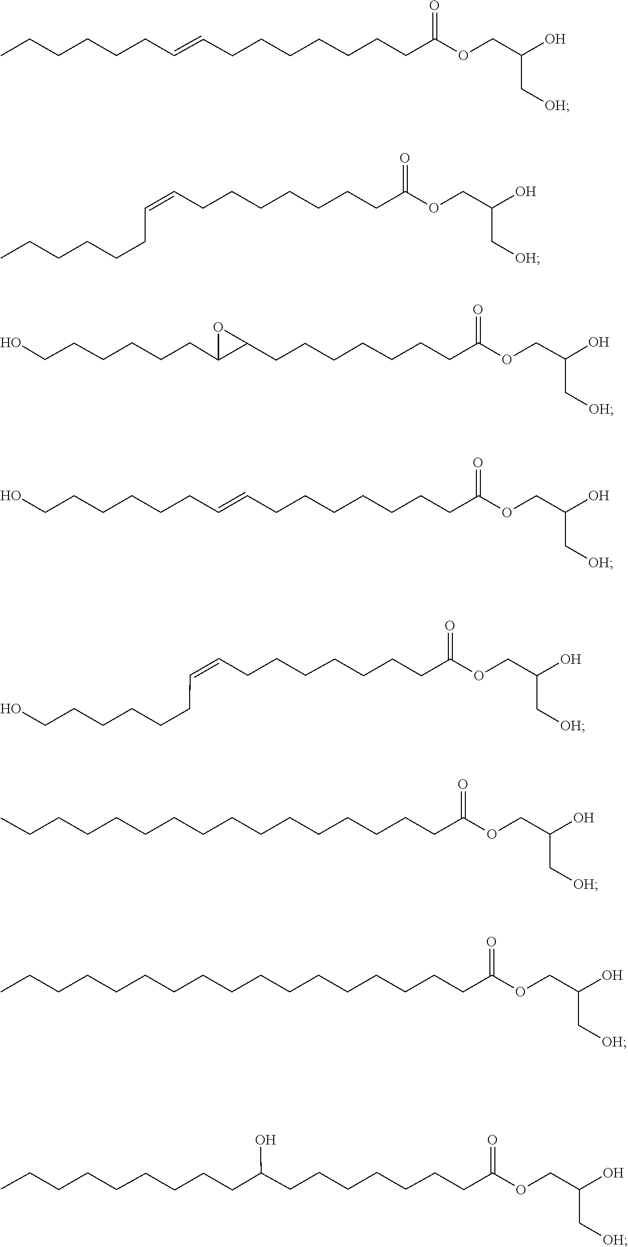

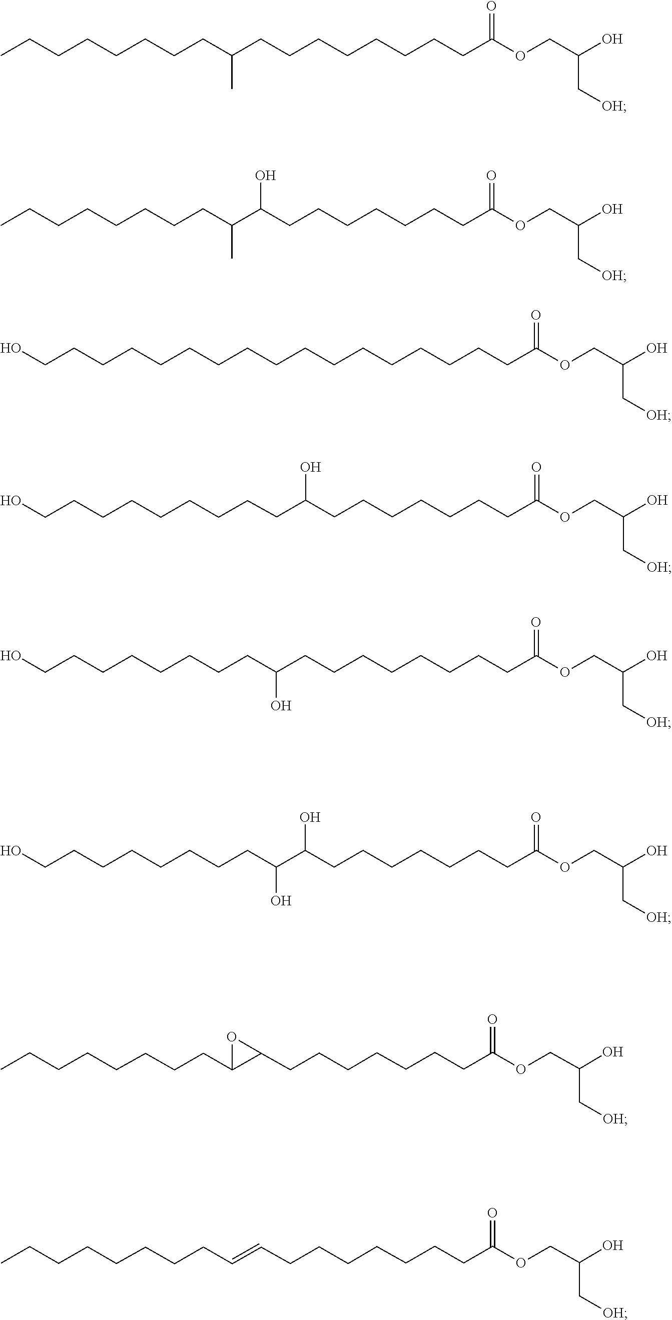

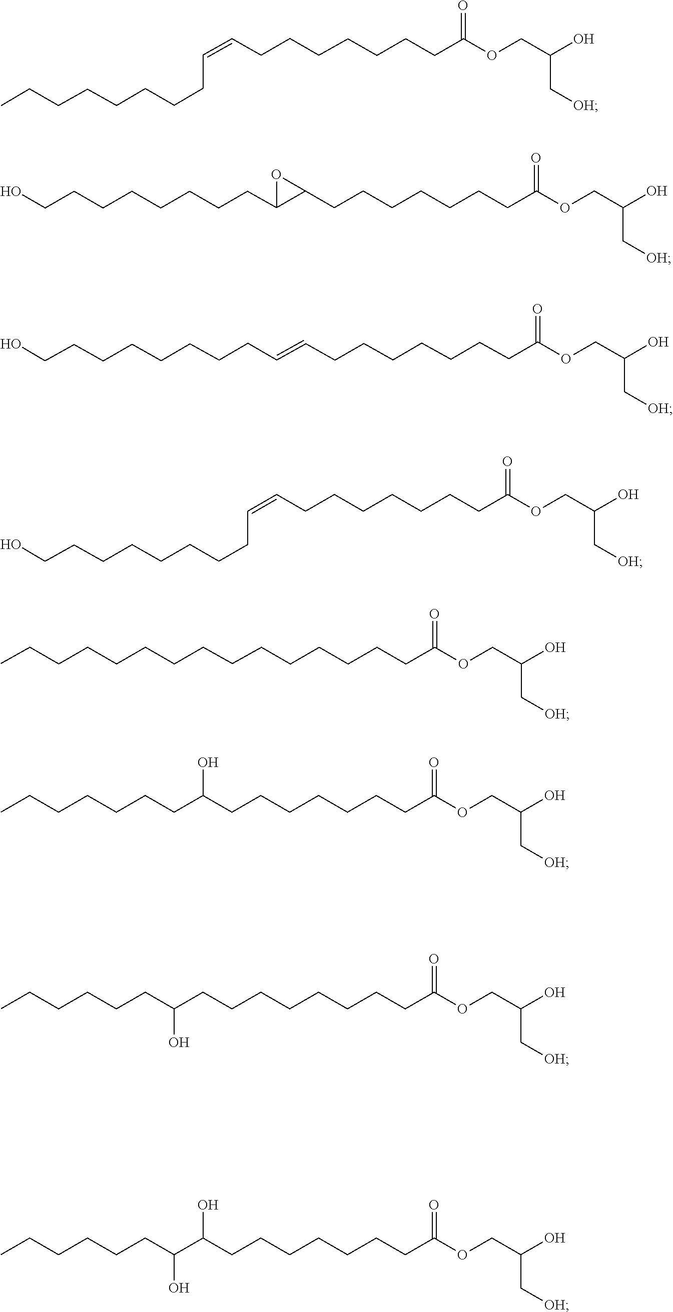

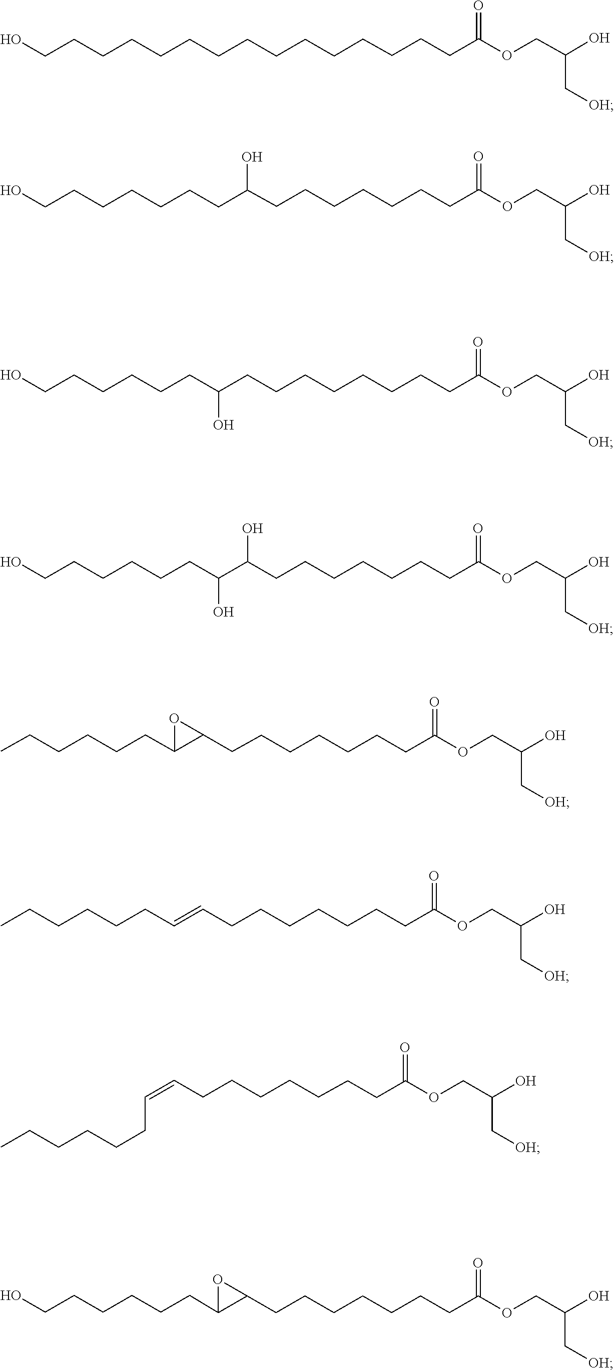

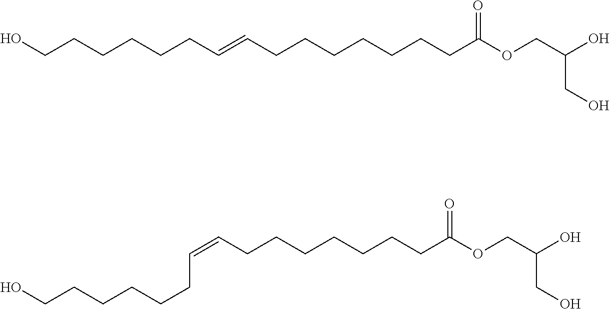 [SMILES: O=C(CCCCCCC/C=C/CCCCCCO)OCC(O)CO ; O=C(CCCCCCC/C=C\CCCCCCO)OCC(O)CO]

The coating agents herein can include one or more of the following fatty acid salts (e.g., compounds of Formula II or Formula III), where X is a cationic counter ion and n represents the charge state (i.e., the number of proton-equivalent charges) of the cationic counter ion.

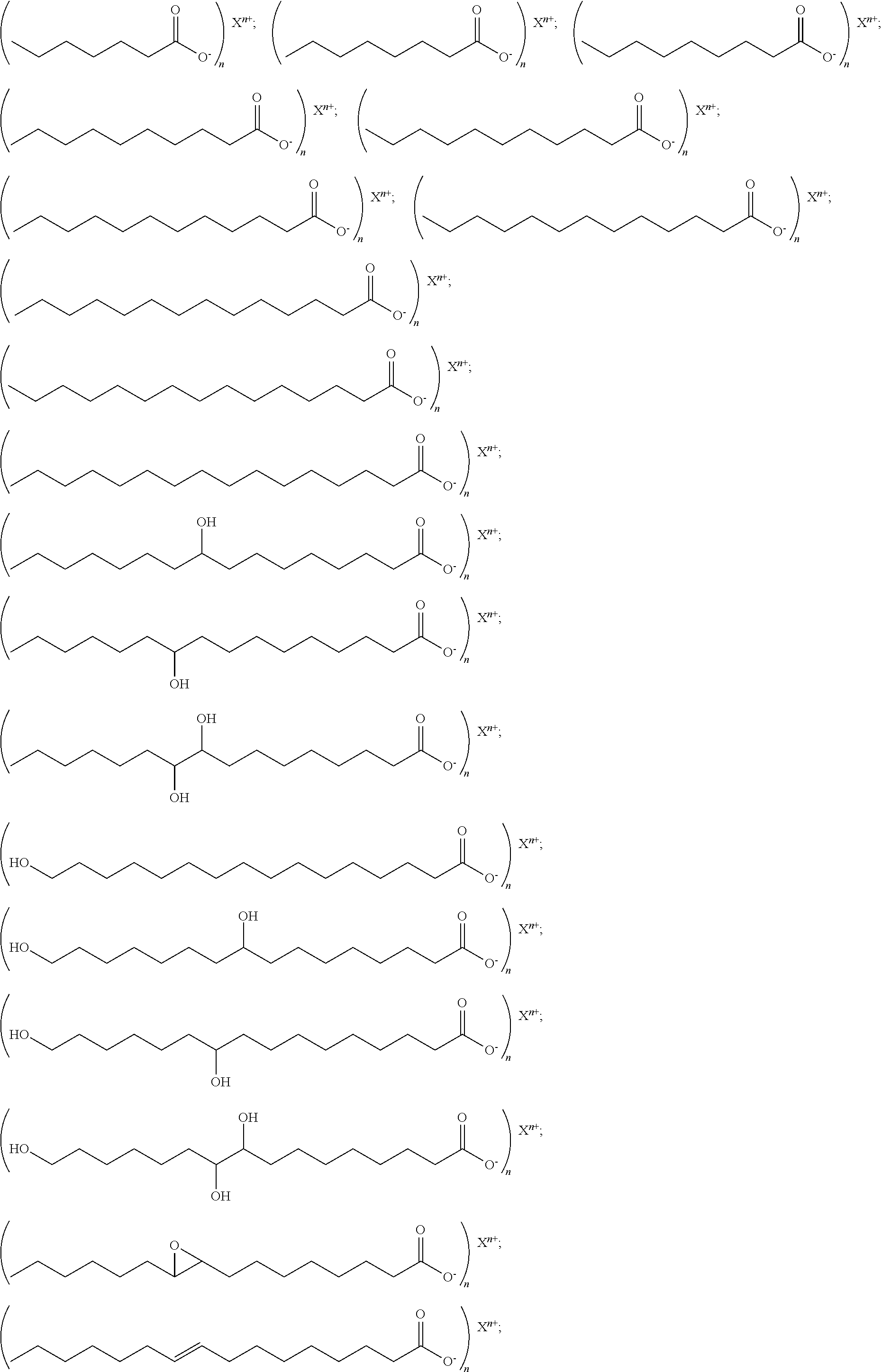

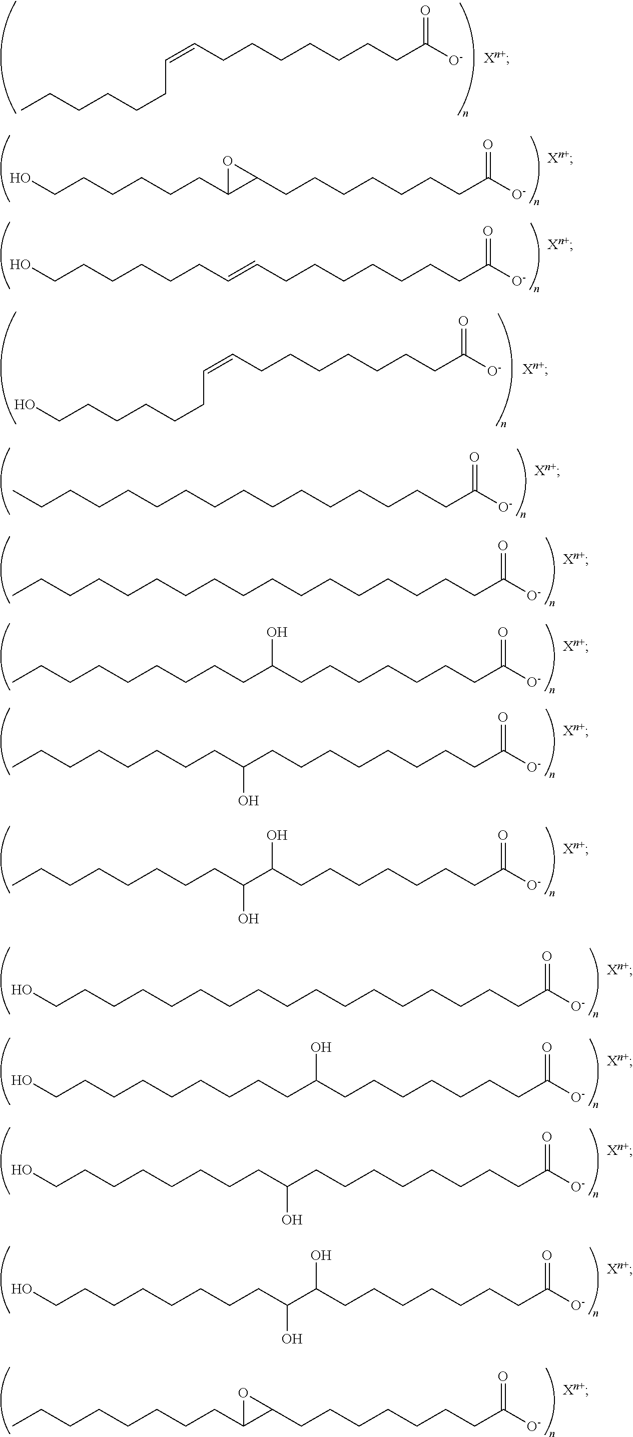

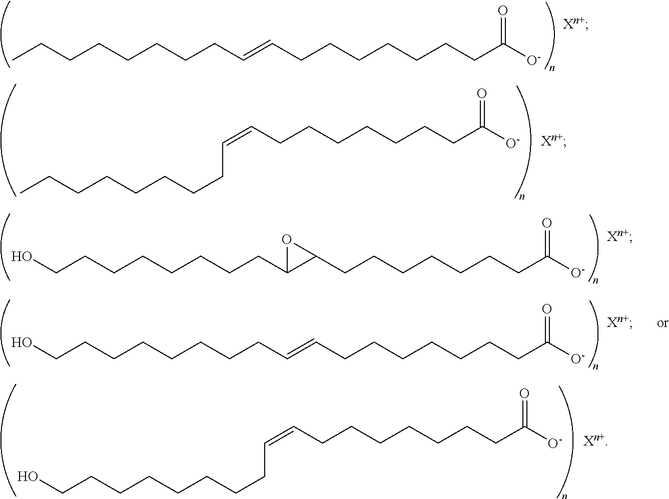

In some embodiments, n is 1, 2, or 3. In some embodiments, X is sodium, potassium, calcium, or magnesium.

As previously described, coating agents formed predominantly of various combinations of compounds of Formula I (e.g., coating agents that are at least 50% compounds of Formula I by mass or by molar composition) each having a carbon chain length of at least 14 have been shown to form protective coatings on produce and other agricultural products that are effective at reducing moisture loss and oxidation. As also previously described, the coatings can be formed over the outer surface of the agricultural product by dissolving, suspending, or dispersing the coating agent in a solvent to form a mixture, applying the mixture to the surface of the agricultural product (e.g., by spray coating the product, by dipping the product in the mixture, or by brushing the mixture onto the surface of the product), and then removing the solvent (e.g., by allowing the solvent to evaporate). The solvent can include any polar, non-polar, protic, or aprotic solvents, including any combinations thereof. Examples of solvents that can be used include water, methanol, ethanol, isopropanol, butanol, acetone, ethyl acetate, chloroform, acetonitrile, tetrahydrofuran, diethyl ether, methyl tert-butyl ether, any other suitable solvent or combinations thereof. In cases where the coating is going to be applied to plants or other edible products, it may be preferable to use a solvent that is safe for consumption, for example water, ethanol, or combinations thereof. Depending on the solvent that is used, the solubility limit of the coating agent in the solvent may be lower than desired for particular applications. For example, when compounds of Formula I are used as the coating agent and the solvent is water (or is predominantly water), the solubility limit of the coating agent may be relatively low. In these cases it may still be possible to add the desired concentration of coating agent to the solvent and form a suspension or colloid.

In order to improve the solubility of the coating agent in the solvent, or to allow the coating agent to be suspended or dispersed in the solvent, the coating agent can further include an emulsifier. When the coatings are to be formed over plants or other edible products, it may be preferable that the emulsifier be safe for consumption. Furthermore, it is also preferable that the emulsifier either not be incorporated into the coating or, if the emulsifier is incorporated into the coating, that it does not degrade the performance of the coating.

Through extensive experimentation, it has been shown that organic salts (e.g., compounds of Formula II or Formula III) added to the coating agent can increase the solubility of the coating agent or allow the coating agent to be suspended or dispersed in solvents having a substantial water content (e.g., solvents that are at least 50% water by volume), provided that the concentration of the salts is not too low (relative to the concentration of compounds of Formula I). Furthermore, the added salts do not substantially degrade the performance of subsequently formed coatings provided that the concentration of the salts (relative to the concentration of the compounds of Formula I) is not too high.

For example, coating agents including a first group of compounds of Formula I mixed with a second group of compounds of Formula II and/or III can be added to water to form a suspension by heating the water to about 70° C., adding the coating agent, and then cooling the resulting mixture to about room temperature (or a lower temperature). The cooled mixture can then be applied to substrates such as produce to form a protective coating, as described throughout. However, it has been found that when the compounds of Formula I make up at least 50% of the mass of the coating agent and the compounds of Formula II and/or III make up less than about 3% of the coating agent, the coating agent either cannot be suspended in the water at the elevated temperature, or the coating agent can be suspended in the water at the higher temperature but then crashes out as the temperature is reduced, thus preventing coatings from being able to be formed from the mixture.

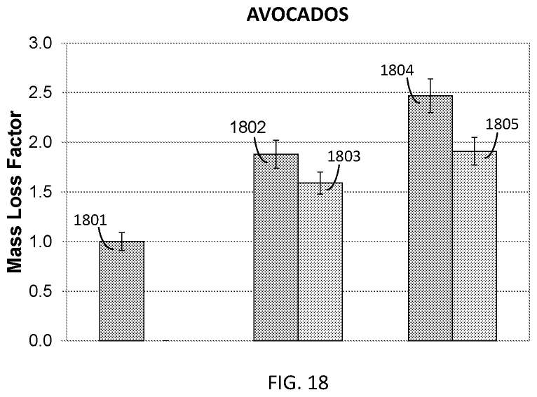

Additionally, if the concentration of compounds of Formula II and/or III is too high, the performance of the resulting coatings can be degraded. For example, as shown in FIG. 18 and Example 13 below, coatings formed on avocados from a 94:6 mixture of compounds of Formula I (PA-1G and SA-1G) to compounds of Formula II or III (SA-Na) resulted in a mass loss factor of 1.88. However, when the study was repeated with a 70:30 mixture of the same compounds, the mass loss factor of the coated avocados was reduced to 1.59. As further shown in FIG. 18, a similar degradation in the mass loss factor with a high concentration of salts in the coating agent was observed when the compound of Formula II or III in the coating agent was MA-Na.

In view of the above, compositions (e.g., coating agents) can include a first group of compounds that includes one or more compounds of Formula I (e.g., fatty acids or esters thereof) and a second group of compounds that includes one or more salts of Formula II or Formula III (e.g., fatty acid salts). The compound(s) of Formula I and/or the salt(s) of Formula II or III can optionally have a carbon chain length of at least 14. A mass ratio of the first group of compounds (e.g., compounds of Formula I such as fatty acids or esters, including monoacylglycerides) to the second group of compounds (salts of Formula II or III, e.g., fatty acid salts) can, for example, be in a range of about 2 to 200, for example about 2 to 100, 2 to 99, 2 to 90, 2 to 80, 2 to 70, 2 to 60, 2 to 50, 2 to 40, 2 to 30, 2 to 25, 2 to 20, 2 to 15, 2 to 10, 2.5 to 200, 2.5 to 100, 2.5 to 90, 2.5 to 80, 2.5 to 70, 2.5 to 60, 2.5 to 50, 2.5 to 40, 2.5 to 30, 2.5 to 25, 2.5 to 20, 2.5 to 15, 2.5 to 10, 3 to 200, 3 to 100, 3 to 90, 3 to 80, 3 to 70, 3 to 60, 3 to 50, 3 to 40, 3 to 30, 3 to 25, 3 to 20, 3 to 15, 3 to 10, 4 to 200, 4 to 100, 4 to 90, 4 to 80, 4 to 70, 4 to 60, 4 to 50, 4 to 40, 4 to 30, 4 to 25, 4 to 20, 4 to 15, 4 to 10, 5 to 200, 5 to 100, 5 to 90, 5 to 80, 5 to 70, 5 to 60, 5 to 50, 5 to 40, 5 to 30, 5 to 25, 5 to 20, 5 to 15, 5 to 10, 10 to 100, 10 to 99, 10 to 90, 10 to 80, 10 to 70, 10 to 60, 10 to 50, 10 to 40, 10 to 30, 10 to 25, 10 to 20, 10 to 15, 15 to 100, 15 to 99, 15 to 90, 15 to 80, 15 to 70, 15 to 60, 15 to 50, 15 to 40, 15 to 30, 15 to 25, or 15 to 20.

As described above, the coating agent can be added to or dissolved, suspended, or dispersed in a solvent to form a colloid, suspension, or solution. The various components of the coating agent (e.g., the compounds of Formula I and the salts) can be combined prior to being added to the solvent and then added to the solvent together. Alternatively, the components of the coating agent can be kept separate from one another and then be added to the solvent consecutively (or at separate times).

The concentration of the first group of compounds (compounds of Formula I) in the solvent/solution/suspension/colloid can, for example, be in a range of about 1 mg/mL to about 200 mg/mL, such as about 1 to 150 mg/mL, 1 to 100 mg/mL, 1 to 90 mg/mL, 1 to 80 mg/mL, 1 to 75 mg/mL, 1 to 70 mg/mL, 1 to 65 mg/mL, 1 to 60 mg/mL, 1 to 55 mg/mL, 1 to 50 mg/mL, 1 to 45 mg/mL, 1 to 40 mg/mL, 2 to 200 mg/mL, 2 to 150 mg/mL, 2 to 100 mg/mL, 2 to 90 mg/mL, 2 to 80 mg/mL, 2 to 75 mg/mL, 2 to 70 mg/mL, 2 to 65 mg/mL, 2 to 60 mg/mL, 2 to 55 mg/mL, 2 to 50 mg/mL, 2 to 45 mg/mL, 2 to 40 mg/mL, 5 to 200 mg/mL, 5 to 150 mg/mL, 5 to 100 mg/mL, 5 to 90 mg/mL, 5 to 80 mg/mL, 5 to 75 mg/mL, 5 to 70 mg/mL, 5 to 65 mg/mL, 5 to 60 mg/mL, 5 to 55 mg/mL, 5 to 50 mg/mL, 5 to 45 mg/mL, 5 to 40 mg/mL, 10 to 200 mg/mL, 10 to 150 mg/mL, 10 to 100 mg/mL, 10 to 90 mg/mL, 10 to 80 mg/mL, 10 to 75 mg/mL, 10 to 70 mg/mL, 10 to 65 mg/mL, 10 to 60 mg/mL, 10 to 55 mg/mL, 10 to 50 mg/mL, 10 to 45 mg/mL, or 10 to 40 mg/mL.

The concentration of the second group of compounds (salts of Formula II or Formula III, e.g., fatty acid salts) in the solvent/solution/suspension/colloid can, for example, be in a range of about 0.01 mg/mL to about 80 mg/mL, such as about 0.01 to 75 mg/mL, 0.01 to 70 mg/mL, 0.01 to 65 mg/mL, 0.01 to 60 mg/mL, 0.01 to 55 mg/mL, 0.01 to 50 mg/mL, 0.01 to 45 mg/mL, 0.01 to 40 mg/mL, 0.01 to 35 mg/mL, 0.01 to 30 mg/mL, 0.01 to 25 mg/mL, 0.01 to 20 mg/mL, 0.01 to 15 mg/mL, 0.01 to 10 mg/mL, 0.1 to 80 mg/mL, 0.1 to 75 mg/mL, 0.1 to 70 mg/mL, 0.1 to 65 mg/mL, 0.1 to 60 mg/mL, 0.1 to 55 mg/mL, 0.1 to 50 mg/mL, 0.1 to 45 mg/mL, 0.1 to 40 mg/mL, 0.1 to 35 mg/mL, 0.1 to 30 mg/mL, 0.1 to 25 mg/mL, 0.1 to 20 mg/mL, 0.1 to 15 mg/mL, 0.1 to 10 mg/mL, 1 to 80 mg/mL, 1 to 75 mg/mL, 1 to 70 mg/mL, 1 to 65 mg/mL, 1 to 60 mg/mL, 1 to 55 mg/mL, 1 to 50 mg/mL, 1 to 45 mg/mL, 1 to 40 mg/mL, 1 to 35 mg/mL, 1 to 30 mg/mL, 1 to 25 mg/mL, 1 to 20 mg/mL, 1 to 15 mg/mL, 1 to 10 mg/mL, 2 to 80 mg/mL, 2 to 75 mg/mL, 2 to 70 mg/mL, 2 to 65 mg/mL, 2 to 60 mg/mL, 2 to 55 mg/mL, 2 to 50 mg/mL, 2 to 45 mg/mL, 2 to 40 mg/mL, 2 to 35 mg/mL, 2 to 30 mg/mL, 2 to 25 mg/mL, 2 to 20 mg/mL, 2 to 15 mg/mL, or 2 to 10 mg/mL.

The concentration of the composition (e.g., the coating agent) in the solvent/solution/suspension/colloid can, for example, be in a range of about 1 mg/mL to about 200 mg/mL, such as about 1 to 150 mg/mL, 1 to 100 mg/mL, 1 to 90 mg/mL, 1 to 80 mg/mL, 1 to 75 mg/mL, 1 to 70 mg/mL, 1 to 65 mg/mL, 1 to 60 mg/mL, 1 to 55 mg/mL, 1 to 50 mg/mL, 1 to 45 mg/mL, 1 to 40 mg/mL, 2 to 200 mg/mL, 2 to 150 mg/mL, 2 to 100 mg/mL, 2 to 90 mg/mL, 2 to 80 mg/mL, 2 to 75 mg/mL, 2 to 70 mg/mL, 2 to 65 mg/mL, 2 to 60 mg/mL, 2 to 55 mg/mL, 2 to 50 mg/mL, 2 to 45 mg/mL, 2 to 40 mg/mL, 5 to 200 mg/mL, 5 to 150 mg/mL, 5 to 100 mg/mL, 5 to 90 mg/mL, 5 to 80 mg/mL, 5 to 75 mg/mL, 5 to 70 mg/mL, 5 to 65 mg/mL, 5 to 60 mg/mL, 5 to 55 mg/mL, 5 to 50 mg/mL, 5 to 45 mg/mL, 5 to 40 mg/mL, 10 to 200 mg/mL, 10 to 150 mg/mL, 10 to 100 mg/mL, 10 to 90 mg/mL, 10 to 80 mg/mL, 10 to 75 mg/mL, 10 to 70 mg/mL, 10 to 65 mg/mL, 10 to 60 mg/mL, 10 to 55 mg/mL, 10 to 50 mg/mL, 10 to 45 mg/mL, or 10 to 40 mg/mL.

As also described above and demonstrated in the examples below, the coating solutions/suspensions/colloids can further include a wetting agent that serves to reduce the contact angle between the solution/suspension/colloid and the surface of the substrate being coated. The wetting agent can be included as a component of the coating agent and therefore added to the solvent at the same time as other components of the coating agent. Alternatively, the wetting agent can be separate from the coating agent and can be added to the solvent either before, after, or at the same time as the coating agent. Alternatively, the wetting agent can be separate from the coating agent, and can be applied to a surface before the coating agent in order to prime the surface.

The wetting agent can be a fatty acid or salt or ester thereof. The wetting agent can be a compound or group of compounds of Formula I, II, or III, where Formulas I, II, and III are given above. In particular, the wetting agent compounds can each have a carbon chain length of 13 or less. For example, the carbon chain length can be, 7, 8, 9, 10, 11, 12, 13, in a range of 7 to 13, or in a range of 8 to 12. The wetting agent can also or alternatively be one or more of a phospholipid, a lysophospholipid, a glycoglycerolipid, a glycolipid, an ascorbyl ester of a fatty acid, an ester of lactic acid, an ester of tartaric acid, an ester of malic acid, an ester of fumaric acid, an ester of succinic acid, an ester of citric acid, an ester of pantothenic acid, or a fatty alcohol derivative (e.g. an alkyl sulfate). In some embodiments, the wetting agents included in the mixtures herein are edible and/or safe for consumption.

Prior to adding the wetting agent to the solvent (and either before or after adding the coating agent for cases where the wetting agent and coating agent are separate), the contact angle between the solvent/solution/suspension/colloid and carnauba, candelilla, or paraffin wax can be at least about 70°, for example at least about 75°, at least about 80°, at least about 85°, or at least about 90°. After adding the wetting agent to the solvent (and either before or after adding the coating agent for cases where the wetting agent and coating agent are separate), the contact angle between the resulting solution/suspension/colloid and carnauba, candelilla, or paraffin wax can be less than 85°, for example less than about 80°, less than about 75°, less than about 70°, less than about 65°, less than about 60°, less than about 55°, less than about 50°, less than about 45°, less than about 40°, less than about 35°, less than about 30°, less than about 25°, less than about 20°, less than about 15°, less than about 10°, less than about 5°, or about 0°.

Because the wetting agents can in many cases damage the substrate being coated, the concentration of the wetting agent compounds can be less than that of the other components of the coating agent. However, if the concentration of the wetting agents added to the solvent is too low, the surface energy of the resulting solution/suspension/colloid may not be substantially different from that of the solvent, in which case improved surface wetting of the substrate may not be achieved.

In some embodiments, compounds used as wetting agents can also (or alternatively) be used as emulsifiers. For example, in some embodiments, a medium chain fatty acid (e.g., having a carbon chain length of 7, 8, 9, 10, 11, 12, or 13) or salt or ester thereof is used as an emulsifier (and optionally also functions as a wetting agent) in the composition, thereby enabling the composition to be dissolved or suspended in the solvent. In some embodiments, a phospholipid, a lysophospholipid, a glycoglycerolipid, a glycolipid, an ascorbyl ester of a fatty acid, an ester of lactic acid, an ester of tartaric acid, an ester of malic acid, an ester of fumaric acid, an ester of succinic acid, an ester of citric acid, an ester of pantothenic acid, or a fatty alcohol derivative (e.g. an alkyl sulfate), is included in the composition and functions as an emulsifier (and optionally also functions as a wetting agent). In some embodiments, the emulsifier is cationic. In some embodiments, the emulsifier is anionic. In some embodiments, the emulsifier is zwitterionic. In some embodiments, the emulsifier is uncharged.

In view of the above, any of the compositions (e.g., coating agents) described herein can include a first group of compounds of Formulas I, II, and/or III (e.g., fatty acids and/or salts or esters thereof) and a second group of compounds of Formulas I, II, and/or III (e.g., fatty acids and/or salts or esters thereof), where each compound of the first group of compounds has a carbon chain length of at least 14, and each compound of the second group of compounds has a carbon chain length of 13 or less, for example in a range of 7 to 13. The first and second groups of compounds can each, for example, include ethyl esters, methyl esters, glyceryl esters (e.g., monoacylglycerides such as 1-monoacylglycerides or 2-monoacylglycerides), sodium salts of fatty acids, potassium salts of fatty acids, calcium salts of fatty acids, magnesium salts of fatty acids, or combinations thereof. In some embodiments, any of the compositions described herein can include a first group of compounds of Formula I, (e.g., fatty acids and/or esters thereof) and a second group of compounds, where the second group of compounds function as an emulsifier (e.g. is a fatty acid salt, a phospholipid, a lysophospholipid, a glycoglycerolipid, a glycolipid, an ascorbyl ester of a fatty acid, an ester of lactic acid, an ester of tartaric acid, an ester of malic acid, an ester of fumaric acid, an ester of succinic acid, an ester of citric acid, an ester of pantothenic acid, or a fatty alcohol derivative (e.g. an alkyl sulfate).

A mass ratio of the fatty acids and/or esters in the first group of compounds to the emulsifiers in the second group of compounds can be in any of the ranges given previously (e.g., a range such that the solubility of the coating agent in the solvent is sufficient to allow the desired coating agent concentration to be dissolved, suspended, or dispersed in the solvent). A mass ratio of the first group of compounds (carbon chain length of at least 14) to the second group of compounds (carbon chain length of 13 or less, or emulsifier) can be in a range of about 2 to 200, for example about 2 to 100, 2 to 90, 2 to 80, 2 to 70, 2 to 60, 2 to 50, 2 to 40, 2 to 30, 2 to 25, 2 to 20, 2 to 15, 2 to 10, 2.5 to 200, 2.5 to 100, 2.5 to 90, 2.5 to 80, 2.5 to 70, 2.5 to 60, 2.5 to 50, 2.5 to 40, 2.5 to 30, 2.5 to 25, 2.5 to 20, 2.5 to 15, 2.5 to 10, 3 to 200, 3 to 100, 3 to 90, 3 to 80, 3 to 70, 3 to 60, 3 to 50, 3 to 40, 3 to 30, 3 to 25, 3 to 20, 3 to 15, 3 to 10, 4 to 200, 4 to 100, 4 to 90, 4 to 80, 4 to 70, 4 to 60, 4 to 50, 4 to 40, 4 to 30, 4 to 25, 4 to 20, 4 to 15, 4 to 10, 5 to 200, 5 to 100, 5 to 90, 5 to 80, 5 to 70, 5 to 60, 5 to 50, 5 to 40, 5 to 30, 5 to 25, 5 to 20, 5 to 15, or 5 to 10.

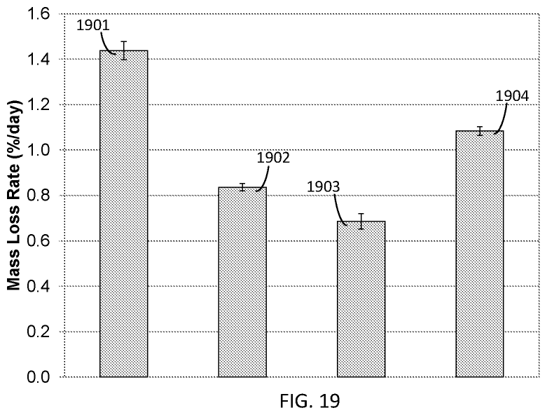

As shown in FIG. 19, mixtures comprising fatty acid esters (e.g. monoacylglycerides) and various emulsifiers can be used as coatings on agricultural products (e.g. fresh produce) to reduce the mass loss rate. For example, as shown in FIG. 19 and Example 14 below, coatings formed on avocados from a 94:6 mixture of compounds of Formula I (PA-1G and SA-1G) to compounds of Formula II or III (SA-Na) resulted in a mass loss rate of 0.84% per day (bar 1902). Coatings formed on avocados from a 94:6 mixture of compounds of Formula I (PA-1G and SA-1G) to a fatty alcohol derivative (e.g. sodium lauryl sulfate) resulted in a mass loss rate of 0.69% per day (bar 1903). Coatings formed on avocados from a 70:30 mixture of compounds of Formula I (PA-1G and SA-1G) to a phospholipid (e.g. lecithin) resulted in a mass loss rate of 1.08% per day (bar 1904). All of the exemplified mixtures reduced the mass loss rate of the avocados as compared to the untreated control, which had a mass loss rate of 1.44% per day (bar 1901).

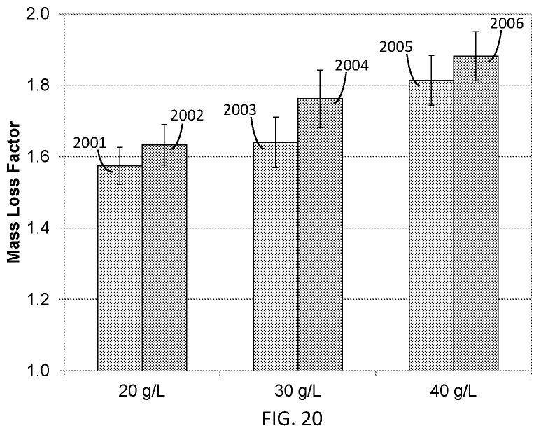

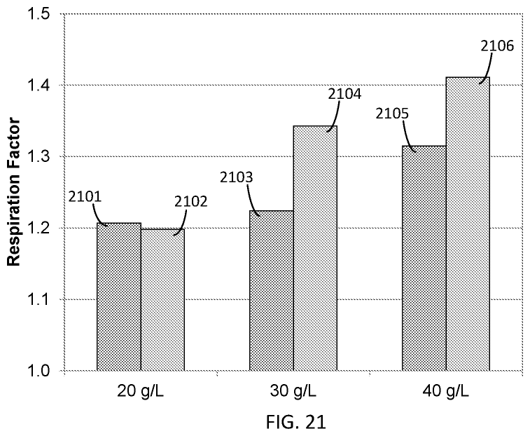

As shown in FIGS. 20 and 21, the concentration of the fatty acid esters (e.g. monoacylglycerides) and emulsifier can impact the mass loss and respiration factors of avocados. For example, as shown in FIG. 20, increasing the concentration of the 94:6 mixture of compounds of Formula I (PA-1G and SA-1G) to compounds of Formula II or III (SA-Na) from 20 g/L (bar 2001) to 30 g/L (bar 2003) increased the mass loss factor from 1.57 to 1.64. Increasing the concentration from 30 g/L (bar 2003) to 40 g/L (bar 2005) increased to mass loss factor from 1.64 to 1.81. Correspondingly, as seen in FIG. 21 the respiration factor also increased from 1.21 at 20 g/L (bar 2101) to 1.22 at 30 g/L (bar 2103) to 1.31 at 40 g/L (bar 2105). A concentration dependence was also observed with a the 94:6 mixture of compounds of Formula I (PA-1G and SA-1G) to a fatty alcohol derivative (e.g. sodium lauryl sulfate). As seen in FIG. 20, the mass loss factor increased from 1.63 at 20 g/L (bar 2002) to 1.76 at 30 g/L (bar 2004) to 1.88 at 40 g/L (bar 2006). Correspondingly, as seen in FIG. 21 the respiration factor also increased from 1.20 at 20 g/L (bar 2102) to 1.34 at 30 g/L (bar 2104) to 1.41 at 40 g/L (bar 2106).

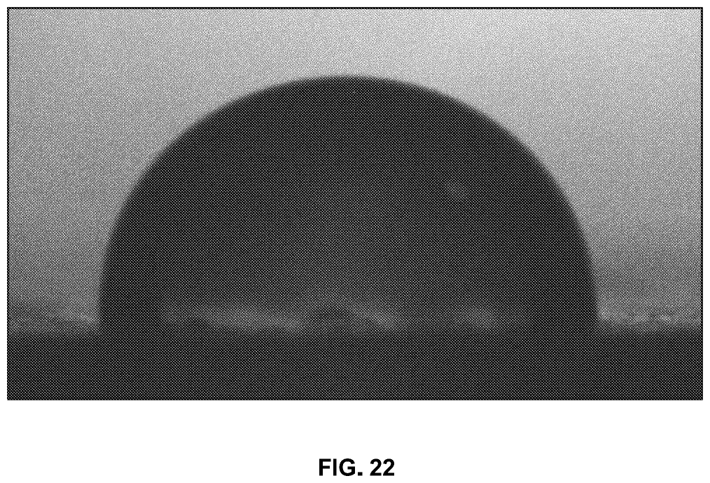

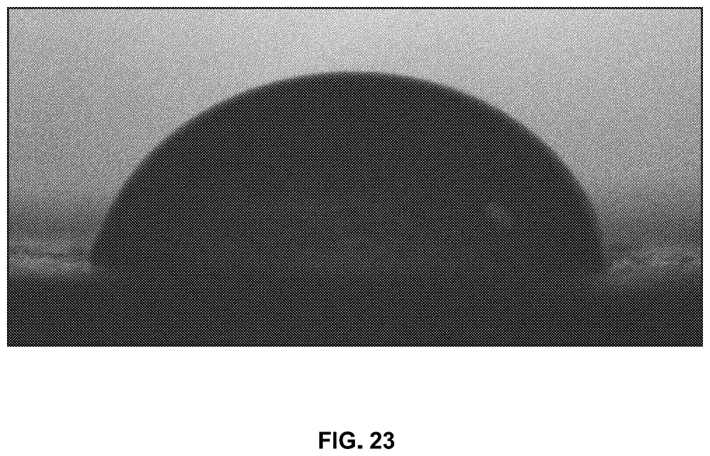

As seen in FIG. 22, the contact angle a 94:6 mixture of compounds of Formula I (PA-1G and SA-1G) to compounds of Formula II or III (SA-Na) at 45 g/L was 95±5°. As seen in FIG. 23, the contact angle a 94:6 mixture of compounds of Formula I (PA-1G and SA-1G) to a fatty alcohol derivative (e.g. sodium lauryl sulfate) at 45 g/L was 84±4°. Without wishing to be bound to theory, the increase in mass loss factor when utilizing a fatty alcohol derivative (e.g. an alkyl sulfate) as an emulsifier can be attributed to the improved wetting, as compared to a compound of Formula II or III (SA-Na).

As described above, the coating agent can be added to or dissolved, suspended, or dispersed in a solvent to form a suspension, colloid, or solution. The various components of the coating agent (e.g., the compounds of Formula I, the salts of Formula II and/or III, and/or the wetting agents) can be combined prior to being added to the solvent and then added to the solvent together. Alternatively, at least some of the components of the coating agent can be kept separate from other components and can be added to the solvent consecutively (or at separate times).

The concentration of the first group of compounds (compounds of Formula I, II and/or III having a carbon chain length of at least 14) in the solvent/solution/suspension/colloid can, for example, be in a range of about 1 mg/mL to about 200 mg/mL, such as about 1 to 150 mg/mL, 1 to 100 mg/mL, 1 to 90 mg/mL, 1 to 80 mg/mL, 1 to 75 mg/mL, 1 to 70 mg/mL, 1 to 65 mg/mL, 1 to 60 mg/mL, 1 to 55 mg/mL, 1 to 50 mg/mL, 1 to 45 mg/mL, 1 to 40 mg/mL, 2 to 200 mg/mL, 2 to 150 mg/mL, 2 to 100 mg/mL, 2 to 90 mg/mL, 2 to 80 mg/mL, 2 to 75 mg/mL, 2 to 70 mg/mL, 2 to 65 mg/mL, 2 to 60 mg/mL, 2 to 55 mg/mL, 2 to 50 mg/mL, 2 to 45 mg/mL, 2 to 40 mg/mL, 5 to 200 mg/mL, 5 to 150 mg/mL, 5 to 100 mg/mL, 5 to 90 mg/mL, 5 to 80 mg/mL, 5 to 75 mg/mL, 5 to 70 mg/mL, 5 to 65 mg/mL, 5 to 60 mg/mL, 5 to 55 mg/mL, 5 to 50 mg/mL, 5 to 45 mg/mL, 5 to 40 mg/mL, 10 to 200 mg/mL, 10 to 150 mg/mL, 10 to 100 mg/mL, 10 to 90 mg/mL, 10 to 80 mg/mL, 10 to 75 mg/mL, 10 to 70 mg/mL, 10 to 65 mg/mL, 10 to 60 mg/mL, 10 to 55 mg/mL, 10 to 50 mg/mL, 10 to 45 mg/mL, or 10 to 40 mg/mL.

The concentration of wetting agents or second group of compounds of Formula I, II, and/or III (e.g., compounds of Formula I and/or salts of Formula II and/or III having a carbon chain length of 13 or less) in the solvent/solution/suspension/colloid can, for example, be about 0.01 mg/mL to about 20 mg/mL, such as about 0.01 mg/mL to 15 mg/mL, 0.01 mg/mL to 12 mg/mL, 0.01 mg/mL to 10 mg/mL, 0.01 mg/mL to 9 mg/mL, 0.01 mg/mL to 8 mg/mL, 0.01 mg/mL to 7 mg/mL, 0.01 mg/mL to 6 mg/mL, 0.01 mg/mL to 5 mg/mL, 0.1 mg/mL to 20 mg/mL, 0.1 mg/mL to 15 mg/mL, 0.1 mg/mL to 12 mg/mL, 0.1 mg/mL to 10 mg/mL, 0.1 mg/mL to 9 mg/mL, 0.1 mg/mL to 8 mg/mL, 0.1 mg/mL to 7 mg/mL, 0.1 mg/mL to 6 mg/mL, 0.1 mg/mL to 5 mg/mL, 0.5 mg/mL to 20 mg/mL, 0.5 mg/mL to 15 mg/mL, 0.5 mg/mL to 12 mg/mL, 0.5 mg/mL to 10 mg/mL, 0.5 mg/mL to 9 mg/mL, 0.5 mg/mL to 8 mg/mL, 0.5 mg/mL to 7 mg/mL, 0.5 mg/mL to 6 mg/mL, or 0.5 mg/mL to 5 mg/mL.

The composition that is added to the solvent (e.g., the coating agent) can be composed from about 50% to about 99.9% (e.g., about 60%-99.9%, 65%-990.9%, 70%-990.9%, 75%-99.9%, 80%-99.9%, 85%-99.9%, 90%-99.9%, 50%-99%, 60%-99%, 65%-99%, 70%-99%, 75%-99%, 80%-99%, 85%-99%, 90%-99%, 50%-98%, 60%-98%, 65%-98%, 70%-98%, 75%-98%, 80%-98%, 85%-98%, 90%-98%, 50%-96%, 60%-96%, 65%-96%, 70%-96%, 75%-96%, 80%-96%, 85%-96%, 90%-96%, 50%-94%, 60%-94%, 65%-94%, 70%-94%, 75%-94%, 80%-94%, 85%-94%, or 90%-94%) by mass of a first group of compounds of fatty acids, fatty acid esters, fatty acid salts, or combinations thereof (e.g., compounds of Formula I and/or salts of Formula II or Formula III), where optionally each compound of the first group optionally has a carbon chain length of at least 14. In some embodiments, the compounds of the first group are fatty acid esters, e.g., monoacylglycerides.

The composition that is added to the solvent (e.g., the coating agent) can be composed from about 0.1% to about 50% (e.g., about 0.1%-45%, 0.1%-40%, 0.1%-35%, 0.1%-30%, 0.1%-25%, 0.1%-20%, 0.1%-15%, 0.1%-10%, 0.1%-8%, 0.1%-6%, 0.1%-5%, 0.1%-4%, 0.4%-50%, 0.4%-45%, 0.4%-40%, 0.4%-35%, 0.4%-30%, 0.4%-25%, 0.4%-20%, 0.4%-15%, 0.4%-10%, 0.4%-8%, 0.4%-6%, 0.4%-5%, 0.4%-4%, 0.7%-50%, 0.7%-45%, 0.7%-40%, 0.7%-35%, 0.7%-30%, 0.7%-25%, 0.7%-20%, 0.7%-15%, 0.7%-10%, 0.7%-8%, 0.7%-6%, 0.7%-5%, 0.7%-4%, 1%-50%, 1%-45%, 1%-40%, 1%-35%, 1%-30%, 1%-25%, 1%-20%, 1%-15%, 1%-10%, 1%-8%, 1%-6%, 1%-5%, or 1%-4%) by mass of a second group of compounds of fatty acids, fatty acid esters, fatty acid salts, or combinations thereof (e.g., compounds of Formula I and/or salts of Formula II and/or III), where each compound of the second group optionally has a carbon chain length of 13 or less (e.g., a carbon chain length in a range of 7 to 13). The compounds of the second group can function as wetting agents, as previously described.

The composition that is added to the solvent (e.g., the coating agent) can be composed from about 0.1% to about 50% (e.g., about 0.1%-45%, 0.1%-40%, 0.1%-35%, 0.1%-30%, 0.1%-25%, 0.1%-20%, 0.1%-15%, 0.1%-10^{%}, 0.1%-8%, 0.1%-6%, 0.1%-5%, 0.1%-4%, 0.4%-50%, 0.4%-45%, 0.4%-40%, 0.4%-35%, 0.4%-30%, 0.4%-25%, 0.4%-20%, 0.4%-15%, 0.4%-10%, 0.4%-8%, 0.4%-6%, 0.4%-5%, 0.4%-4%, 0.7%-50%, 0.7%-45%, 0.7%-40%, 0.7%-35%, 0.7%-30%, 0.7%-25%, 0.7%-20%, 0.7%-15%, 0.7%-10%, 0.7%-8%, 0.7%-6%, 0.7%-5%, 0.7%-4%, 1%-50%, 1%-45%, 1%-40%, 1%-35%, 1%-30%, 1%-25%, 1%-20%, 1%-15%, 1%-10%, 1%-8%, 1%-6%, 1%-5%, or 1%-4%) by mass of a third group of compounds comprised of salts of compounds of Formula II or Formula III, or fatty acid salts. Each compound of the third group can optionally have a carbon chain length greater than 13. The compounds of the third group can function as emulsifiers and, for example, increase the solubility of the coating agent, as previously described.

Any of the coating solutions/suspensions/colloids described herein can further include an antimicrobial agent, for example ethanol or citric acid. In some implementations, the antimicrobial agent is part of or a component of the solvent. Any of the coating solutions described herein can further include other components or additives such as sodium bicarbonate.

In some implementations, coatings formed from coating agents described herein over agricultural products can be configured to change the surface energy of the agricultural product. Various properties of coatings described herein can be adjusted by tuning the crosslink density of the coating, its thickness, or its chemical composition. This can, for example, be used to control the ripening of postharvest fruit or produce. For example, coatings formed from coating agents that primarily include bifunctional or polyfunctional monomer units can, for example, have higher crosslink densities than those that include monofunctional monomer units. Thus, coatings formed from bifunctional or polyfunctional monomer units can in some cases result in slower rates of ripening as compared to coatings formed from monofunctional monomer units.

In some implementations, one or more wetting agents such as those described above are used to improve the wetting of the surfaces to which the coating solutions/suspensions/colloids are applied, but the wetting agent are not included in the coating solutions/suspensions/colloids. Instead, the wetting agents are added to a second solvent (which can be the same as or different than the solvent to which the coating agent is added) to form a second mixture, and the second mixture is applied to the surface to be coated prior to applying the coating solution/suspension/colloid to the surface. In this case, the second mixture can prime the surface to be coated such that the contact angle of the coating solution/suspension/colloid with the surface is less than it would have otherwise been, thereby improving surface wetting.

Any of the coating agents described herein can further include additional materials that are also transported to the surface with the coating, or are deposited separately and are subsequently encapsulated by the coating (e.g., the coating is formed at least partially around the additional material), or are deposited separately and are subsequently supported by the coating (e.g., the additional material is anchored to the external surface of the coating). Examples of such additional materials can include cells, biological signaling molecules, vitamins, minerals, pigments, aromas, enzymes, catalysts, antifungals, antimicrobials, and/or time-released drugs. The additional materials can be non-reactive with surface of the coated product and/or coating, or alternatively can be reactive with the surface and/or coating.

In some implementations, the coating can include an additive configured, for example, to modify the viscosity, vapor pressure, surface tension, or solubility of the coating. The additive can, for example, be configured to increase the chemical stability of the coating. For example, the additive can be an antioxidant configured to inhibit oxidation of the coating. In some implementations, the additive can reduce or increase the melting temperature or the glass-transition temperature of the coating. In some implementations, the additive is configured to reduce the diffusivity of water vapor, oxygen, CO₂, or ethylene through the coating or enable the coating to absorb more ultra violet (UV) light, for example to protect the agricultural product (or any of the other products described herein). In some implementations, the additive can be configured to provide an intentional odor, for example a fragrance (e.g., smell of flowers, fruits, plants, freshness, scents, etc.). In some implementations, the additive can be configured to provide color and can include, for example, a dye or a US Food and Drug Administration (FDA) approved color additive.

Any of the coating agents or coatings formed thereof that are described herein can be flavorless or have high flavor thresholds, e.g. above 500 ppm, and can be odorless or have a high odor threshold. In some embodiments, the materials included in any of the coatings described herein can be substantially transparent. For example, the coating agent, the solvent, and/or any other additives included in the coating can be selected so that they have substantially the same or similar indices of refraction. By matching their indices of refraction, they may be optically matched to reduce light scattering and improve light transmission. For example, by utilizing materials that have similar indices of refraction and have a clear, transparent property, a coating having substantially transparent characteristics can be formed.

The compositions (e.g., coating agents) described herein can be of high purity. For example, the compositions can be substantially free (e.g., be less than 10% by mass, less than 9% by mass, less than 8% by mass, less than 7% by mass, less than 6% by mass, or less than 5%, 4%, 3%, 2%, or 1% by mass) of diglycerides, triglycerides, acetylated monoglycerides, proteins, polysaccharides, phenols, lignans, aromatic acids, terpenoids, flavonoids, carotenoids, alkaloids, alcohols, alkanes, and/or aldehydes. In some embodiments, the compositions comprise less than 10% (e.g., less than 9%, 8%, 7%, 6%, 5%, 4%, 3%, 2%, or 1%) by mass of diglycerides. In some embodiments, the compositions comprise less than 10% (e.g., less than 9%, 8%, 7%, 6%, 5%, 4%, 3%, 2%, or 1%) by mass of triglycerides. In some embodiments, the compositions comprise less than 10% (e.g., less than 9%, 8%, 7%, 6%, 5%, 4%, 3%, 2%, or 1%) by mass of acetylated monoglycerides.

Any of the coatings described herein can be disposed on the external surface of an agricultural product or other substrate using any suitable means. For example, the substrate can be dip-coated in a bath of the coating formulation (e.g., an aqueous or mixed aqueous-organic or organic solution). The deposited coating can form a thin layer on the surface of an agricultural product, which can protect the agricultural product from biotic stressors, water loss, and/or oxidation. In some implementations, the deposited coating can have a thickness of less than 10 microns, less than 9 microns, less than 8 microns, less than 7 microns, less than 6 microns, less than 5 microns, less than 4 microns, less than 3 microns, less than 2 microns, or less than about 1500 nm, and/or the coating can be transparent to the naked eye. For example, the deposited coating can have a thickness of about 10 nm, about 20 nm, about 30 nm, about 40 nm, about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, 1,000 nm, about 1,100 nm, about 1,200 nm, about 1,300 nm, about 1,400 nm, about 1,500 nm, about 1,600 nm, about 1,700 nm, about 1,800 nm, about 1,900 nm, about 2,000 nm, about 2,100 nm, about 2,200 nm, about 2,300 nm, about 2,400 nm, about 2,500 nm, about 2,600 nm, about 2,700 nm, about 2,800 nm, about 2,900 nm, or about 3,000 nm, inclusive of all ranges therebetween.

In some implementations, the deposited coating can be deposited substantially uniformly over the substrate and can be free of defects and/or pinholes. In some implementations, the dip-coating process can include sequential coating of the agricultural product in baths of coating precursors that can undergo self-assembly or covalent bonding on the agricultural product to form the coating. In some implementations, the coating can be deposited on agricultural products by passing the agricultural products under a stream of the coating solution/suspension/colloid (e.g., a waterfall of the coating solution/suspension/colloid). For example, the agricultural products can be disposed on a conveyor that passes through the stream of the coating solution/suspension/colloid. In some implementations, the coating can be misted, vapor- or dry vapor-deposited on the surface of the agricultural product. In some implementations, the coating solution/suspension/colloid can be mechanically applied to the surface of the product to be coated, for example by brushing it onto the surface. In some embodiments, the coating can be configured to be fixed on the surface of the agricultural product by UV crosslinking or by exposure to a reactive gas, for example oxygen.

In some implementations, the coating solutions/suspensions/colloids can be spray-coated on the agricultural products. Commercially available sprayers can be used for spraying the coating solutions/suspensions/colloids onto the agricultural product. In some implementations, the coating formulation can be electrically charged in the sprayer before spray-coating on to the agricultural product, such that the deposited coating electrostatically and/or covalently bonds to the exterior surface of the agricultural product.

As previously described, the coatings formed from coating agents described herein can be configured to prevent water loss or other moisture loss from the coated portion of the plant, delay ripening, and/or prevent oxygen diffusion into the coated portion of the plant, for example, to reduce oxidation of the coated portion of the plant. The coatings can also serve as a barrier to diffusion of carbon dioxide and/or ethylene into or out of the plant or agricultural product. The coatings can also protect the coated portion of the plant against biotic stressors, such as, for example, bacteria, fungi, viruses, and/or pests that can infest and decompose the coated portion of the plant. Since bacteria, fungi and pests all identify food sources via recognition of specific molecules on the surface of the agricultural product, coating the agricultural products with the coating agent can deposit molecularly contrasting molecules on the surface of the portion of the plant, which can render the agricultural products unrecognizable. Furthermore, the coating can also alter the physical and/or chemical environment of the surface of the agricultural product making the surface unfavorable for bacteria, fungi or pests to grow. The coating can also be formulated to protect the surface of the portion of the plant from abrasion, bruising, or otherwise mechanical damage, and/or protect the portion of the plant from photodegradation. The portion of the plant can include, for example, a leaf, a stem, a shoot, a flower, a fruit, a root, etc.

Any of the coatings described herein can be used to reduce the humidity generated by agricultural products (e.g., fresh produce) via mass loss (e.g. water loss) during transportation and storage by reducing the mass loss rate of the agricultural products (e.g., fresh produce). For example, as seen in Example 16, the mass loss rate from a group of lemons coated with a 94:6 mixture of compounds of Formula I (SA-1G and PA-1G) and compounds of Formula II or Formula III (SA-Na) at 50 g/L in water was 0.37% per day, as compared to 1.61% per day for the untreated control group. This corresponded to a lower humidity in cold storage after 48 hours (i.e. 61% humidity) for the coated group as compared to the untreated group (i.e. 72% humidity).

In some embodiments, the agricultural product is coated with a composition that reduces the mass loss rate by at least 10%, 15%, 20%, 25%, 30%, 35%, 40%, 45%, 50%, 55%, 60%, 65%, 70%, 75%, 80%, 85%, 90% or greater compared to untreated product measured. In some embodiments, treating an agricultural product using any of the coatings described herein can give a mass loss factor of at least 1.1, at least 1.2, at least 1.3, at least 1.4, at least 1.5, at least 1.6, at least 1.7, at least 1.8, at least 1.9, at least 2.0, at least 2.2, at least 2.4, at least 2.6, at least 2.8, at least 3.0. In some embodiments, treating an agricultural product using any of the coatings described herein can reduce the humidity generated during storage by at least 1%, 2%, 3%, 4%, 5%, 10%, 15%, 20%, 25%, 30%, 35%, 40%, 45%, 50%, 55%, 60%, 65%, 70%, 75%, 80%, 85%, 90% or greater compared to untreated product. In some embodiments, the reduction in mass loss rate of the agricultural product can reduce the energy required to maintain a relative humidity at a predetermined level (e.g., at 90% relative humidity or less, at 85% relative humidity or less, at 80% relative humidity or less, at 75% relative humidity or less, at 70% relative humidity or less, at 65% relative humidity or less, at 60% relative humidity or less, at 55% relative humidity or less, at 50% relative humidity or less, or at 45% relative humidity or less) during storage or transportation. In some embodiments, the energy required to maintain a relative humidity at the predetermined level (e.g., any of the predetermined levels listed above) during storage or transportation can be reduced by at least 1%, 2%, 3%, 4%, 5%, 10%, 15%, 20%, 25%, 30%, 35%, 40%, 45%, 50%, 55%, 60%, 65%, 70%, 75%, 80%, 85%, 90% or greater compared to untreated product.

Any of the coatings described herein can be used to reduce the heat generated by agricultural products (e.g., fresh produce) via respiration during transportation and storage by reducing the respiration rate of the agricultural products (e.g., fresh produce). As shown in Example 17, the energy usage to maintain a temperature (16° C.) of a group of avocados coated with a 94:6 mixture of compounds of Formula I (SA-1G and PA-1G) and compounds of Formula II or Formula III (SA-Na) at 50 g/L in water for 72 hours was 0.85 kWh, as compared to 1.19 kWh for the untreated control group. In some embodiments, the product is coated with a composition that reduces the respiration rate by at least 10%, 15%, 20%, 25%, 30%, 35%, 40%, 45%, 50%, 55%, 60%, 65%, 70%, 75%, 80%, 85%, 90% or greater compared to untreated product (measured as described above). In some embodiments, the reduction in heat generated by the agricultural product can reduce the energy required to maintain a temperature (e.g., a predetermined temperature) during storage or transportation. In some embodiments, the heat generated can be reduced by at least 5%, 10%, 15%, 20%, 25%, 30%, 35%, 40%, 45%, 50%, 55%, 60%, 65%, 70%, 75%, 80%, 85%, 90% or greater for coated products compared to untreated products. In some embodiments, the energy required to maintain the coated products at a predetermined temperature (e.g., at 25° C. or less, at 23° C. or less, at 20° C. or less, at 18° C. or less, at 15° C. or less, at 13° C. or less, at 10° C. or less, at 8° C. or less, at 5° C. or less, or at 3° C. or less) can be reduced by at least 1%, 2%, 3%, 4%, 5%, 10%, 15%, 20%, 25%, 30%, 35%, 40%, 45%, 50%, 55%, 60%, 65%, 70%, 75%, 80%, 85%, 90% or greater compared to untreated products.

Respiration rate approximations for various types of agricultural products (e.g., fresh produce) are shown below:

| Produce Type | Respiration Rate (ml CO₂/kg · hour) at 20° C. |
|---|---|
| Apples | 10-30 |
| Apricot | 15-25 |
| Asparagus | 138-250 |
| Avocado | 40-150 |
| Bananas | 20-70 |
| Broccoli | 140-160 |
| Cantaloupe | 23-33 |
| Cherry | 22-28 |
| Corn | 268-311 |
| Cucumber | 7-24 |
| Fig | 20-30 |
| Grape | 12-15 |
| Grapefruit | 7-12 |
| Honeydew | 20-27 |
| Kiwifruit | 15-20 |
| Lemon | 10-14 |
| Lime | 6-10 |
| Mandarin | 10-15 |
| Mango | 35-80 |
| Orange | 11-17 |
| Papaya | 15-35 (at 15° C.) |
| Peach | 32-55 |
| Pear | 15-35 |
| Peas | 123-180 |
| Pineapple | 15-20 |
| Strawberry | 50-100 |
| Tomato | 12-22 |
| Watermelon | 17-25 |

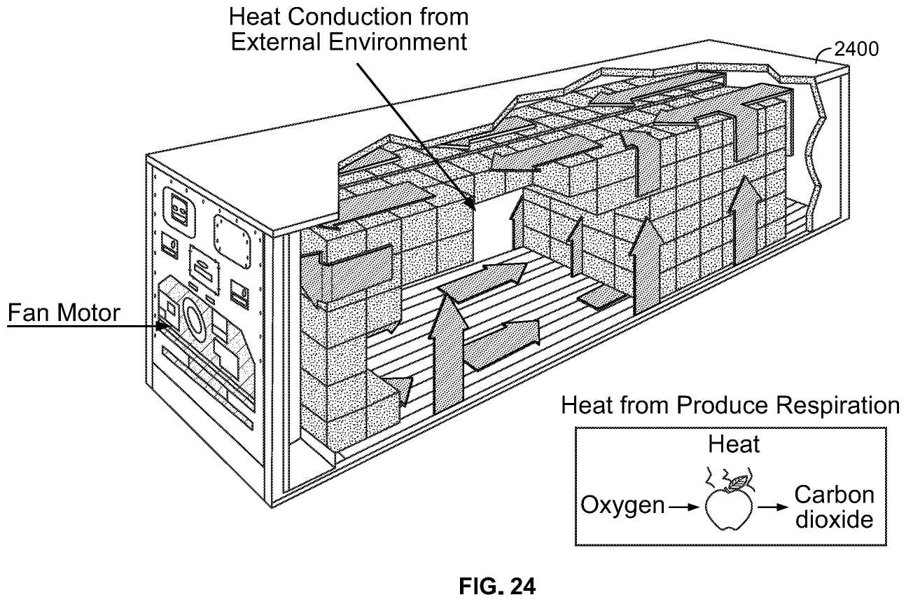

In some embodiments, the methods and compositions described herein are used to treat agricultural products (e.g., fresh produce) that are stored and/or transported in a refrigerated container or “reefer” 2400, illustrated schematically in FIG. 24. As shown in FIG. 24, heat from produce respiration is a contributor to the overall heat within a refrigerated container. In some embodiments, the methods and compositions described herein can reduce the respiration rate of the treated agricultural products (e.g., fresh produce) in order to reduce the heat generated due to respiration of the agricultural products (e.g., fresh produce) in a refrigerated container or “reefer”. In some embodiments, the methods and compositions described herein can reduce the mass loss rate of the treated agricultural products (e.g., fresh produce) in order to reduce the humidity generated due to mass loss (e.g. water loss) of the agricultural products (e.g., fresh produce) in a refrigerated container or “reefer”.

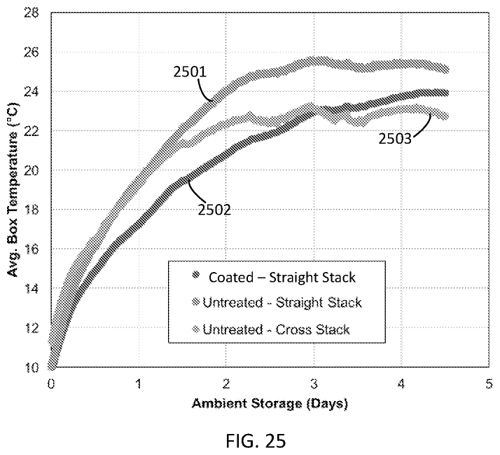

The methods and compositions described herein can also be used to minimize or reduce temperature or humidity gradients that arise from concentrating agricultural products (e.g., fresh produce) in stacks or pallets in order to prevent uneven ripening. The treated agricultural products (e.g., fresh produce) can be straight stacked during storage or can be stacked in an alternative fashion (e.g. cross stacked) to increase circulation around the agricultural products (e.g., fresh produce). Within the produce supply chain, boxes of agricultural products may be reoriented from a straight stack, which can be preferable during shipment, to a cross stack, which can be used during storage to increase air circulation and to prevent uneven ripening. As shown in FIG. 25 and Example 18, coating an agricultural product with a 94:6 mixture of compounds of Formula I (PA-1G and SA-1G) to compounds of Formula II or III (SA-Na) can reduce the rate at which the temperature rises in a stack of boxes of avocados after removal from 10° C. storage. As shown in FIG. 25, the rate of temperature rise in produce after removal from 10° C. cold storage was slowed in the treated produce during the first three days after removal. The untreated straight-stacked and cross-stacked produce generated more heat under ambient storage conditions over the first three days compared to the treated, straight-stacked produce, with the untreated, straight-stacked produce generating the most heat. Therefore, the temperature gradient across the pallet should be reduced as well, allowing more even and predictable ripening. In some embodiments, coating an agricultural product with a coating composition that reduces the heat generated (e.g. from respiration) within a stack of produce can reduce labor requirements throughout the produce supply chain by minimizing the need for reorientation of the stacks from a straight stack to an alternative stack (e.g. cross stack).

In some embodiments, treating an agricultural product with a coating that reduces the respiration rate can reduce the rate at which the temperature increases in a stack (e.g. upon removal from cold storage) by at least 0.5° C. per day, at least 1.0° C. per day, at least 1.5° C. per day, at least 2.0° C. per day, at least 2.5° C. per day, at least 3.0° C. per day, at least 3.5° C. per day, at least 4.0° C. per day, at least 4.5° C. per day, or at least 5° C. per day, as compared to an untreated stack. In some embodiments, treating an agricultural product with a coating that reduces the respiration rate can reduce the equilibrium temperature difference between the atmosphere and the average temperature of the stack by at least 0.5° C., at least 1.0° C., at least 1.5° C., at least 2.0° C., at least 2.5° C., at least 3.0° C., at least 3.5° C., at least 4.0° C., at least 4.5° C., or at least 5° C.

Any of the coatings described herein can be used to protect any agricultural product. In some embodiments, the coating can be coated on an edible agricultural product, for example, fruits, vegetables, edible seeds and nuts, herbs, spices, produce, meat, eggs, dairy products, seafood, grains, or any other consumable item. In such embodiments, the coating can include components that are non-toxic and safe for consumption by humans and/or animals. For example, the coating can include components that are U.S. Food and Drug Administration (FDA) approved direct or indirect food additives, FDA approved food contact substances, satisfy FDA regulatory requirements to be used as a food additive or food contact substance, and/or is an FDA Generally Recognized as Safe (GRAS) material. Examples of such materials can be found within the FDA Code of Federal Regulations Title 21, located at “http://www.accessdata.fda.gov/scripts/cdrh/cfdocs/cfcfr/cfrsearch.cfm”, the entire contents of which are hereby incorporated by reference herein. In some embodiments, the components of the coating can include a dietary supplement or ingredient of a dietary supplement. The components of the coating can also include an FDA approved food additive or color additive. In some embodiments, the coating can include components that are naturally derived, as described herein. In some embodiments, the coating can be flavorless or have a high flavor threshold of below 500 ppm, are odorless or have a high odor threshold, and/or are substantially transparent. In some embodiments, the coating can be configured to be washed off an edible agricultural product, for example, with water.

In some embodiments, the coatings described herein can be formed on an inedible agricultural product. Such inedible agricultural products can include, for example, inedible flowers, seeds, shoots, stems, leaves, whole plants, and the like. In such embodiments, the coating can include components that are non-toxic, but the threshold level for non-toxicity can be higher than that prescribed for edible products. In such embodiments, the coating can include an FDA approved food contact substance, an FDA approved food additive, or an FDA approved drug ingredient, for example, any ingredient included in the FDA's database of approved drugs, which can be found at “http://www.accessdata.fda.gov/scripts/cder/drugsatfda/index.cfm”, the entire contents of which are hereby incorporated herein by reference. In some embodiments, the coating can include materials that satisfy FDA requirements to be used in drugs or are listed within the FDA's National Drug Discovery Code Directory, “http://www.accessdata.fda.gov/scripts/cder/ndc/default.cfm”, the entire contents of which are hereby incorporated herein by reference. In some embodiments, the materials can include inactive drug ingredients of an approved drug product as listed within the FDA's database, “http://www.accessdata.fda.gov/scripts/cder/ndc/default.cfm”, the entire contents of which are hereby incorporated herein by reference.

Embodiments of the coatings described herein provide several advantages, including, for example: (1) the coatings can protect the agricultural products from biotic stressors, i.e. bacteria, viruses, fungi, or pests; (2) the coatings can prevent evaporation of water and/or diffusion of oxygen, carbon dioxide, and/or ethylene; (3) coating can help extend the shelf life of agricultural products, for example, post-harvest produce, without refrigeration; (4) the coatings can introduce mechanical stability to the surface of the agricultural products eliminating the need for expensive packaging designed to prevent the types of bruising which accelerate spoilage; (5) use of agricultural waste materials to obtain the coatings can help eliminate the breeding environments of bacteria, fungi, and pests; (6) the coatings can be used in place of pesticides to protect plants, thereby minimizing the harmful impact of pesticides to human health and the environment; (7) the coatings can be naturally derived and hence, safe for human consumption. Since in some cases the components of the coatings described herein can be obtained from agricultural waste, such coatings can be made at a relatively low cost. Therefore, the coatings can be particularly suited for small scale farmers, for example, by reducing the cost required to protect crops from pesticides and reducing post-harvest losses of agricultural products due to decomposition by biotic and/or environmental stressors.

Due to segmentation in the marketplace, the preparation/formation of coating agents or coating solutions/suspensions/colloids and the formation of coatings over substrates from the coating solutions/suspensions/colloids are often carried out by different parties or entities. For example, a manufacturer of compositions such as coating agents described herein (i.e., a first party) can form the compositions by one or more of the methods described herein. The manufacturer can then sell or otherwise provide the resulting composition to a second party, for example a farmer, shipper, distributor, or retailer of produce, and the second party can apply the composition to one or more agricultural products to form a protective coating over the products. Alternatively, the manufacturer can sell or otherwise provide the resulting composition to an intermediary party, for example a wholesaler, who then sells or otherwise provides the composition to a second party such as a farmer, shipper, distributor, or retailer of produce, and the second party can apply the composition to one or more agricultural products to form a protective coating over the products.

In some cases where multiple parties are involved, the first party may optionally provide instructions or recommendations about the composition (i.e., the coating agent), either written or oral, indicating one or more of the following: (i) that the composition is intended to be applied to a product for the purpose of coating or protecting the product, to extend the life of the product, to reduce spoilage of the product, or to modify or improve the aesthetic appearance of the product; (ii) conditions and/or methods that are suitable for applying the compositions to the surfaces of products; and/or (iii) potential benefits (e.g., extended shelf life, reduced rate of mass loss, reduced rate of molding and/or spoilage, etc.) that can result from the application of the composition to a product. While the instructions or recommendations may be supplied by the first party directly with the plant extract composition (e.g., on packaging in which the composition is sold or distributed), the instructions or recommendations may alternatively be supplied separately, for example on a website owned or controlled by the first party, or in advertising or marketing material provided by or on behalf of the first party.

In view of the above, it is recognized that in some cases, a party that manufactures compositions (i.e., coating agents) or coating solutions/suspensions/colloids according to one or more methods described herein (i.e., a first party) may not directly form a coating over a product from the composition, but can instead direct (e.g., can instruct or request) a second party to form a coating over a product from the composition. That is, even if the first party does not coat a product by the methods and compositions described herein, the first party may still cause the coating agent or solution to be applied to the product to form a protective coating over the product by providing instructions or recommendations as described above. Accordingly, as used herein, the act of applying a coating agent or solution/suspension/colloid to a product (e.g., a plant or agricultural product) also includes directing or instructing another party to apply the coating agent or solution to the product, thereby causing the coating agent or solution to be applied to the product.

### EXAMPLES

The following examples describe effects of various coating agents and solutions/suspensions/colloids on various substrates, as well as characterization of some of the various coating agents and solutions/suspensions/colloids. These examples are only for illustrative purposes and are not meant to limit the scope of the present disclosure. In each of the examples below, all reagents and solvents were purchased and used without further purification unless specified.

### Example 1: Effect of Coatings Formed of Long Chain Fatty Acid Esters on Mass Loss Rates of Finger Limes

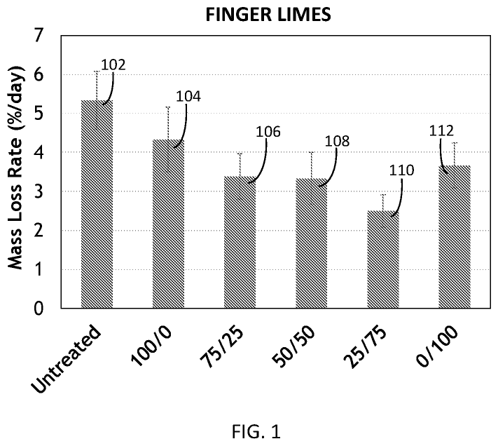

FIG. 1 is a graph showing average daily mass loss rates for finger limes coated with various mixtures of PA-2G and PA-1G measured over the course of several days. Each bar in the graph represents average daily mass loss rates for a group of 24 finger limes. The finger limes corresponding to bar 102 were untreated. The finger limes corresponding to bar 104 were coated with a coating agent that was substantially pure PA-1G. The finger limes corresponding to bar 106 were coated with a coating agent that was about 75% PA-1G and 25% PA-2G by mass. The finger limes corresponding to bar 108 were coated with a coating agent that was about 50% PA-1G and 50% PA-2G by mass. The finger limes corresponding to bar 110 were coated with a coating agent that was about 25% PA-1G and 75% PA-2G by mass. The finger limes corresponding to bar 112 were coated with a coating agent that was substantially pure PA-2G. The coating agents were each dissolved in ethanol at a concentration of 10 mg/mL to form solutions, and the solutions were applied to the surface of the corresponding finger limes to form the coatings.

In order to form the coatings, the finger limes were placed in bags, and the solution containing the composition was poured into the bag. The bag was then sealed and lightly agitated until the entire surface of each finger lime was wet. The finger limes were then removed from the bag and allowed to dry on drying racks. The finger limes were kept under ambient room conditions at a temperature in the range of about 23° C.-27° C. and humidity in the range of about 40%-55% while they dried and for the entire duration of the time they were tested.

As shown in FIG. 1, the untreated finger limes (102) exhibited an average mass loss rate of 5.3% per day. The mass loss rates of the finger limes coated with the substantially pure PA-1G formulation (104) and the substantially pure PA-2G formulation (112) exhibited average daily mass loss rates of 4.3% and 3.7%, respectively. The groups of finger limes corresponding to bars 106 (75:25 mass ratio of PA-1G to PA-2G) and 108 (50:50 mass ratio of PA-1G to PA-2G) both exhibited average daily mass loss rates of 3.4%. The finger limes corresponding to bar 110 (25:75 mass ratio of PA-1G to PA-2G) exhibited average daily mass loss rates of 2.5%.

### Example 2: Effect of Coatings Formed of Long Chain Fatty Acids and/or Esters Thereof on Mass Loss Rates of Avocados

Nine solutions using combinations of long chain fatty acid esters were prepared to examine the effects of various coating agent compositions on the mass loss rate of avocados treated with a solution composed of the coating agent dissolved in a solvent to form a coating over the avocados. Each solution was composed of the coating agents described below dissolved in ethanol at a concentration of 5 mg/mL.

The first solution contained MA-1G and PA-2G combined at a molar ratio of 1:3. The second solution contained MA-1G and PA-2G combined at a molar ratio of 1:1. The third solution contained MA-1G and PA-2G combined at a molar ratio of 3:1. The fourth solution contained PA-1G and PA-2G combined at a molar ratio of 3:1. The fifth solution contained PA-1G and PA-2G combined at a molar ratio of 1:1. The sixth solution contained PA-1G and PA-2G combined at a molar ratio of 1:3. The seventh solution contained SA-1G and PA-2G combined at a molar ratio of 1:3. The eighth solution contained SA-1G and PA-2G combined at a molar ratio of 1:1. The ninth solution contained SA-1G and PA-2G combined at a molar ratio of 3:1.

Avocados were harvested simultaneously and divided into nine groups of 30 avocados, each of the groups being qualitatively identical (i.e., all groups had avocados of approximately the same average size and quality). In order to form the coatings, the avocados were each individually dipped in one of the solutions, with each group of 30 avocados being treated with the same solution. The avocados were then placed on drying racks and allowed to dry under ambient room conditions at a temperature in the range of about 23° C.-27° C. and relative humidity in the range of about 40%-55%. The avocados were all held at these same temperature and humidity conditions for the entire duration of time they were tested.

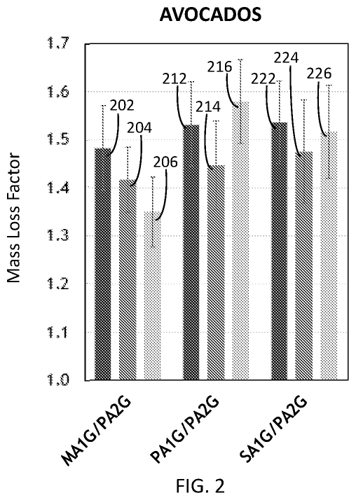

FIG. 2 is a graph showing the mass loss factor for avocados coated with various solutions described above. Bars 202, 204, and 206 correspond to MA-1G and PA-2G combined at a molar ratio of about 1:3, 1:1, and 3:1 (first, second, and third solutions), respectively. Bars 212, 214, and 216 correspond to PA-1G and PA-2G combined at a molar ratio of about 1:3, 1:1, and 3:1 (fourth, fifth, and sixth solutions), respectively. Bars 222, 224, and 226 correspond to SA-1G and PA-2G combined at a molar ratio of about 1:3, 1:1, and 3:1 (seventh, eighth, and ninth solutions), respectively.

As shown in FIG. 2, treatment in the first solution (202) resulted in a mass loss factor of 1.48, treatment in the second solution (204) resulted in a mass loss factor of 1.42, treatment in the third solution (206) resulted in a mass loss factor of 1.35, treatment in the fourth solution (212) resulted in a mass loss factor of 1.53, treatment in the fifth solution (214) resulted in a mass loss factor of 1.45, treatment in the sixth solution (216) resulted in a mass loss factor of 1.58, treatment in the seventh solution (222) resulted in a mass loss factor of 1.54, treatment in the eighth solution (224) resulted in a mass loss factor of 1.47, and treatment in the ninth solution (226) resulted in a mass loss factor of 1.52.

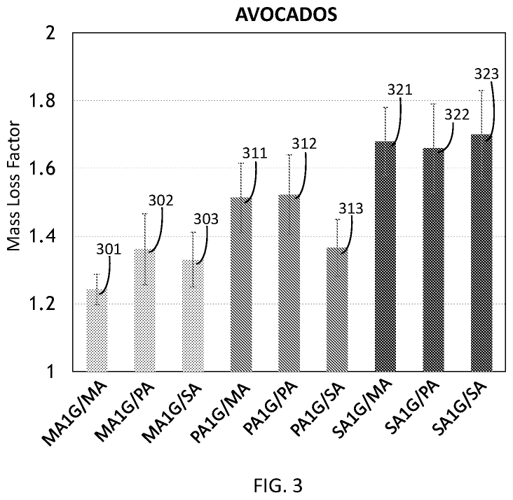

FIG. 3 is a graph showing the mass loss factor for avocados each coated with a mixture including a long chain fatty acid ester and a long chain fatty acid. All mixtures were a 1:1 mix by mole ratio of the compound of fatty acid ester and the fatty acid. Bars 301-303 correspond to coating agents composed of MA-1G and MA (301), MA-1G and PA (302), and MA-1G and SA (303). Bars 311-313 correspond to coating agents composed of PA-1G and MA (311), PA-1G and PA (312), and PA-1G and SA (313). Bars 321-323 correspond to coating agents composed of SA-1G and MA (321), SA-1G and PA (322), and SA-1G and SA (323). Each bar in the graph represents a group of 30 avocados. All coatings were formed by dipping the avocados in a solution comprising the associated mixture dissolved in ethanol at a concentration of 5 mg/mL, placing the avocados on drying racks, and allowing the avocados to dry under ambient room conditions at a temperature in the range of about 23° C.-27° C. and humidity in the range of about 40%-55%. The avocados were held at these same temperature and humidity conditions for the entire duration of the time they were tested.

As shown, the mass loss factor tended to increase as the carbon chain length of the fatty acid ester was increased. For example, all mixtures for which the carbon chain length of the ester was greater than 13 resulted in a mass loss factor greater than 1.2, all mixtures for which the carbon chain length of the ester was greater than 15 resulted in a mass loss factor greater than 1.35, and all mixtures for which the carbon chain length of the ester was greater than 17 resulted in a mass loss factor great than 1.6.

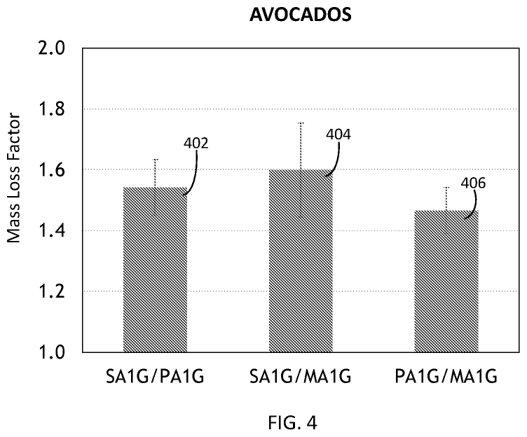

FIG. 4 is a graph showing the mass loss factor for avocados each coated with a coating agent including two different long chain fatty acid ester compounds mixed at a 1:1 mole ratio. Bar 402 corresponds to a mixture of SA-1G and PA-1G, bar 404 corresponds to a mixture of SA-1G and MA-1G, and bar 406 corresponds to a mixture of PA-1G and MA-1G. Each bar in the graph represents a group of 30 avocados. All coatings were formed by dipping the avocados in a solution composed of the associated mixture dissolved in ethanol at a concentration of 5 mg/mL, placing the avocados on drying racks, and allowing the avocados to dry under ambient room conditions at a temperature in the range of about 23° C.-27° C. and humidity in the range of about 40%-55%. The avocados were held at these same temperature and humidity conditions for the entire duration of the time they were tested. As shown, the PA-1G/MA-1G mixture (406) resulted in a mass loss factor of 1.47, the SA-1G/PA-1G mixture (402) resulted in a mass loss factor of 1.54, and the SA-1G/MA-1G mixture (1604) resulted in a mass loss factor of 1.60.

### Example 3: Effect of Coating Agent Concentration on Mass Loss Rates of Coated Blueberries

Two solutions were prepared by dissolving a coating agent formed of PA-2G and PA-1G mixed at a mass ratio of 75:25 in substantially pure ethanol. For the first solution, the coating agent was dissolved in the ethanol at a concentration of 10 mg/mL, and for the second solution, the coating agent was dissolved in the ethanol at a concentration of 20 mg/mL.

Blueberries were harvested simultaneously and divided into three groups of 60 blueberries each, each of the groups being qualitatively identical (i.e., all groups had blueberries of approximately the same average size and quality). The first group was a control group of untreated blueberries, the second group was treated with the 10 mg/mL solution, and the third group was treated with the 20 mg/mL solution.

To treat the blueberries, each blueberry was picked up with a set of tweezers and individually dipped in the solution for approximately 1 second, after which the blueberry was placed on a drying rack and allowed to dry. The blueberries were kept under ambient room conditions at a temperature in the range of 23° C.-27° C. and humidity in the range of 40%-55% while they dried and for the entire duration of the time they were tested. Mass loss was measured by carefully weighing the blueberries each day, where the reported percent mass loss was equal to the ratio of mass reduction to initial mass.

FIG. 6 shows plots of the percent mass loss over the course of 5 days in untreated (control) blueberries (602), blueberries treated using the first solution of 10 mg/mL (604), and blueberries treated using the second solution of 20 mg/mL (606). As shown, the percent mass loss for untreated blueberries was 19.2% after 5 days, whereas the percent mass loss for blueberries treated with the 10 mg/mL solution was 15% after 5 days, and the percent mass loss for blueberries treated with the 20 mg/mL solution was 10% after 5 days.

### Example 4: Effect of Coatings Formed of Esters and Salts of Long Chain Fatty Acids on Mass Loss Rates of Lemons

FIG. 7 is a graph showing the mass loss factor for lemons each coated with a coating agent including SA-1G and SA-Na mixed at a 4:1 mass ratio. Bar 702 corresponds to untreated lemons (control group), bar 704 corresponds to lemons treated with a suspension composed of the coating agent suspended in water at a concentration of 10 mg/mL, bar 706 corresponds to lemons treated with a suspension composed of the coating agent suspended in water at a concentration of 20 mg/mL, bar 708 corresponds to lemons treated with a suspension composed of the coating agent suspended in water at a concentration of 30 mg/mL, bar 710 corresponds to lemons treated with a suspension composed of the coating agent suspended in water at a concentration of 40 mg/mL, and bar 712 corresponds to lemons treated with a suspension composed of the coating agent suspended in water at a concentration of 50 mg/mL.

Each bar in the graph represents a group of 90 lemons. All coatings were formed by dipping the lemons in their associated suspension, placing the lemons on drying racks, and allowing the lemons to dry under ambient room conditions at a temperature in the range of about 23° C.-27° C. and humidity in the range of about 40%-55%. The lemons were held at these same temperature and humidity conditions for the entire duration of the time they were tested. As seen in FIG. 7, the mass loss factor for the lemons treated with the 10 mg/mL solution (704) was 1.83, the mass loss factor for the lemons treated with the 20 mg/mL solution (706) was 1.75, the mass loss factor for the lemons treated with the 30 mg/mL solution (708) was 1.90, the mass loss factor for the lemons treated with the 40 mg/mL solution (710) was 1.78, and the mass loss factor for the lemons treated with the 50 mg/mL solution (712) was 1.83.

### Example 5: Effect of Coatings Formed of Esters/Salts of Long Chain Fatty Acids and Esters of Medium Chain Esters on Mass Loss Rates of Lemons

FIG. 8 is a graph showing mass loss factors of lemons treated with various coating agents suspended in water. Bar 802 corresponds to untreated lemons. Bar 804 corresponds a coating agent formed of SA-1G and MA-Na mixed at a 95:5 mass ratio and added to the water at a concentration of 10 mg/mL. Bar 806 corresponds a coating agent formed of SA-1G and MA-Na mixed at a 95:5 mass ratio and added to the water at a concentration of 30 mg/mL. Bar 808 corresponds a coating agent formed of 10 mg/mL of SA-1G and MA-Na (mixed at a 95:5 mass ratio) and 5 mg/mL of UA-1G suspended in water. Bar 810 corresponds to a coating agent formed of 30 mg/mL of SA-1G and MA-Na (mixed at a 95:5 mass ratio) and 5 mg/mL of UA-1G suspended in water.

Each bar in the graph represents a group of 60 lemons. All coatings were formed by dipping the lemons in their associated solution, placing the lemons on drying racks, and allowing the lemons to dry under ambient room conditions at a temperature in the range of about 23° C.-27° C. and humidity in the range of about 40%-55%. The lemons were held at these same temperature and humidity conditions for the entire duration of the time they were tested. As seen in FIG. 8, the mass loss factor for the lemons corresponding to bar 804 was 1.50, the mass loss factor for the lemons corresponding to bar 806 was 1.68, the mass loss factor for the lemons corresponding to bar 808 was 1.87, and the mass loss factor for the lemons corresponding to bar 810 was 2.59.

### Example 6: Contact Angles of Solvents and Mixtures on the Surfaces of Lemons

FIG. 10 shows a graph of contact angles of various solvents or mixtures on the surfaces of non-waxed lemons. Contact angles were determined by placing drops containing 5 microliters of solvent/mixture on the surface of a lemon and determining the contact angle by digital image analysis. Each bar in the graph represents measurements of 15-20 drops. For bar 1002, the solvent was pure water (control sample). For bar 1004, the mixture included SA-1G and MA-Na combined at a mass ratio of 95:5 and dispersed in water at a concentration of 30 mg/mL. The mixtures corresponding to bars 1006, 1008, 1010, 1012, 1014, and 1016 were the same as that of bar 1004 but also included small concentrations of CA-1G. Bar 1006 included 0.1 mg/mL of CA-1G, bar 1008 included 0.5 mg/mL of CA-1G, bar 1010 included 1 mg/mL of CA-1G, bar 1012 included 2 mg/mL of CA-1G, bar 1014 included 4 mg/mL of CA-1G, and bar 1016 included 6 mg/mL of CA-1G.

As seen in FIG. 10, the drops corresponding to bar 1002 (pure water) exhibited an average contact angle of 88° on lemons. The drops corresponding to bar 1004 (SA-1G/MA-Na in water) exhibited an average contact angle of 84° on lemons. The drops corresponding to bar 1006 (addition of 0.1 mg/mL of CA-1G) exhibited an average contact angle of 70° on lemons. The drops corresponding to bar 1008 (addition of 0.5 mg/mL of CA-1G) exhibited an average contact angle of 68° on lemons. The drops corresponding to bar 1010 (addition of 1 mg/mL of CA-1G) exhibited an average contact angle of 65° on lemons. The drops corresponding to bar 1012 (addition of 2 mg/mL of CA-1G) exhibited an average contact angle of 58° on lemons. The drops corresponding to bar 1014 (addition of 4 mg/mL of CA-1G) exhibited an average contact angle of 56° on lemons. The drops corresponding to bar 1016 (addition of 6 mg/mL of CA-1G) exhibited an average contact angle of 47° on lemons.

### Example 7: Dependence on Carbon Chain Length of Surfactant on Contact Angles of Mixtures on the Surfaces of Lemons

FIG. 11 shows a graph of contact angles of various mixtures on the surfaces of non-waxed lemons. Contact angles were determined by placing drops containing 5 microliters of the mixture on the surface of a lemon and determining the contact angle by digital image analysis. Each bar in the graph represents measurements of 15-20 drops. For bar 1102, the solvent was pure water (control sample). For bar 1104, the mixture included SA-1G and MA-Na combined at a mass ratio of 95:5 and dispersed in water at a concentration of 30 mg/mL. The suspensions corresponding to bars 1106, 1108, and 1110 were the same as that of bar 1104 but also included 4 mg/mL of a medium chain fatty acid ester. For bar 1106 the medium chain fatty acid ester was LA-1G (carbon chain length of 12), for bar 1108 the medium chain fatty acid ester was UA-1G (carbon chain length of 11), and for bar 1110 the medium chain fatty acid ester was CA-1G (carbon chain length of 10).

As seen in FIG. 11, the drops corresponding to bar 1102 (pure water) exhibited an average contact angle of 88° on lemons. The drops corresponding to bar 1104 (SA-1G/MA-Na in water) exhibited an average contact angle of 84° on lemons. The drops corresponding to bar 1106 (addition of 4 mg/mL of LA-1G) exhibited an average contact angle of 67° on lemons. The drops corresponding to bar 1108 (addition of 4 mg/mL of UA-1G) exhibited an average contact angle of 56° on lemons. The drops corresponding to bar 1110 (addition of 1 mg/mL of CA-1G) exhibited an average contact angle of 50° on lemons.

### Example 8: Contact Angles of Solvents and Mixtures on the Surfaces of Lemons, Candelilla Wax, and Carnauba Wax

FIG. 12 shows a graph of contact angles of various solvents and mixtures on the surfaces of non-waxed lemons (1201-1203), candelilla wax (1211-1213), and carnauba wax (1221-1223). Contact angles were determined by placing drops containing 5 microliters of solution on the surface being tested and determining the contact angle by digital image analysis. Each bar in the graph represents measurements of 15-20 drops. For bars 1201, 1211, and 1221, the solvent was pure water (control sample). The second group of bars (1202, 1212, and 1222) correspond to 30 mg/mL of SA-1G and SA-Na combined at a mass ratio of 94:6, as well as 0.25 mg/mL of citric acid and 0.325 mg/mL of sodium bicarbonate dispersed in water. The third group of bars (1203, 1213, and 1223) correspond to a mixture which was the same as that of the second group of bars but also included 3 mg/mL of CA-1G.

As seen in FIG. 12, the drops corresponding to bar 1201 exhibited an average contact angle of 92° on lemons. The drops corresponding to bar 1202 exhibited an average contact angle of 105° on candelilla wax. The drops corresponding to bar 1203 exhibited an average contact angle of 96° on carnauba wax. The drops corresponding to bar 1211 exhibited an average contact angle of 80° on lemons. The drops corresponding to bar 1212 exhibited an average contact angle of 87° on candelilla wax. The drops corresponding to bar 1213 exhibited an average contact angle of 88° on carnauba wax. The drops corresponding to bar 1221 exhibited an average contact angle of 44° on lemons. The drops corresponding to bar 1222 exhibited an average contact angle of 31° on candelilla wax. The drops corresponding to bar 1223 exhibited an average contact angle of 32° on carnauba wax.

### Example 9: Effect of Adding Medium Chain Fatty Acid Esters to Coating Mixtures Used to Form Protective Coatings Over Avocados

FIG. 13 shows the mass loss factor for groups of avocados that were coated with a coating agent including SA-1G and MA-Na mixed with various concentrations of CA-1G or LA-1G. Coatings were formed by adding each coating agent in water at the specified concentration to form a mixture, applying the mixture to the surface of the avocados, and allowing the solvent to evaporate. Bar 1301 corresponds to untreated avocados (control group). Bar 1302 corresponds to a coating agent including SA-1G and MA-Na combined at a mass ratio of 94:6 and added to water at a concentration of 30 mg/mL. For bars 1303 and 1313, the mixture was the same as that for bar 1302, except that 1 mg/mL of CA-1G (bar 1303) or LA-1G (bar 1313) was also added. For bars 1304 and 1314, the mixture was the same as that for bar 1302, except that 2.5 mg/mL of CA-1G (bar 1304) or LA-1G (bar 1314) was also added. For bars 1305 and 1315, the mixture was the same as that for bar 1302, except that 4 mg/mL of CA-1G (bar 1305) or LA-1G (bar 1315) was also added. Each bar in the graph represents a group of 30 avocados. All coatings were formed by dipping the avocados in their associated mixture, placing the avocados on drying racks, and allowing the avocados to dry under ambient room conditions at a temperature in the range of about 23° C.-27° C. and humidity in the range of about 40%-55%. The avocados were held at these same temperature and humidity conditions for the entire duration of the time they were tested.

As seen in FIG. 13, the average mass loss factor for the avocados corresponding to bar 1302 (no medium chain fatty acid esters) was 1.78. For mixtures including small concentrations of CA-1G (bars 1303-1305), the average mass loss factors of the coated avocados were 2.35 for bar 1303 (CA-1G concentration of 1 mg/mL), 2.24 for bar 1304 (CA-1G concentration of 2.5 mg/mL), and 2.18 for bar 1305 (CA-1G concentration of 4 mg/mL). For mixtures including small concentrations of LA-1G (bars 1313-1315), the average mass loss factors of the coated avocados were 1.61 for bar 1313 (LA-1G concentration of 1 mg/mL), 2.15 for bar 1314 (LA-1G concentration of 2.5 mg/mL), and 2.15 for bar 1315 (LA-1G concentration of 4 mg/mL).

### Example 10: Effect of Adding CA-1G to Coating Mixtures Used to Form Protective Coatings Over Cherries

FIG. 14 shows the mass loss factor for groups of cherries (Bing variety) that were coated with a coating agent including SA-1G and MA-Na mixed with various concentrations of CA-1G. Coatings were formed by dissolving each coating agent in water at the specified concentration to form a solution, applying the solution to the surface of the cherries, and allowing the solvent to evaporate. Bar 1401 corresponds to untreated cherries (control group). Bar 1402 corresponds to a coating agent including SA-1G and MA-Na combined at a mass ratio of 94:6 and suspended in water at a concentration of 40 mg/mL. For bar 1403, the suspension was the same as that for bar 1402, except that 0.5 mg/mL of CA-1G was also added. For bar 1404, the suspension was the same as that for bar 1402, except that 1 mg/mL of CA-1G was also added. For bar 1405, the suspension was the same as that for bar 1402, except that 3 mg/mL of CA-1G was also added. Each bar in the graph represents a group of 90 cherries. All coatings were formed by dipping the cherries in their associated suspension, placing the cherries on drying racks, and allowing the cherries to dry under ambient room conditions at a temperature in the range of about 23° C.-27° C. and humidity in the range of about 40%-55%. The cherries were held at these same temperature and humidity conditions for the entire duration of the time they were tested.

As seen in FIG. 14, the average mass loss factor for the cherries corresponding to bar 1402 (no medium chain fatty acid esters) was 1.60. For suspensions including small concentrations of CA-1G (bars 1403-1405), the average mass loss factors of the coated cherries were 1.75 for bar 1403 (CA-1G concentration of 0.5 mg/mL), 1.96 for bar 1404 (CA-1G concentration of 1 mg/mL), and 2.00 for bar 1405 (CA-1G concentration of 3 mg/mL).

### Example 11: Effect of Adding UA-1G to Coating Mixtures Used to Form Protective Coatings Over Finger Limes

FIG. 15 shows the mass loss factor for groups of finger limes that were coated with a coating agent including SA-1G and SA-Na mixed with various concentrations of UA-1G. Coatings were formed by adding each coating agent to water at the specified concentration to form a suspension, applying the suspension to the surface of the finger limes, and allowing the solvent to evaporate. Bar 1501 corresponds to untreated finger limes (control group). Bar 1502 corresponds to a coating agent including SA-1G and SA-Na combined at a mass ratio of 94:6 and suspended in water at a concentration of 30 mg/mL. For bar 1503, the suspension was the same as that for bar 1502, except that 1 mg/mL of UA-1G was also added. For bar 1504, the suspension was the same as that for bar 1502, except that 3 mg/mL of UA-1G was also added. For bar 1505, the suspension was the same as that for bar 1502, except that 5 mg/mL of UA-1G was also added. Each bar in the graph represents a group of 48 finger limes. All coatings were formed by dipping the finger limes in their associated suspension, placing the finger limes on drying racks, and allowing the finger limes to dry under ambient room conditions at a temperature in the range of about 23° C.-27° C. and humidity in the range of about 40%-55%. The finger limes were held at these same temperature and humidity conditions for the entire duration of the time they were tested.

As seen in FIG. 15, the average mass loss factor for the finger limes corresponding to bar 1502 (no medium chain fatty acid esters) was 1.61. For suspensions including small concentrations of UA-1G (bars 1503-1505), the average mass loss factors of the coated finger limes were 2.33 for bar 1503 (UA-1G concentration of 1 mg/mL), 2.06 for bar 1504 (UA-1G concentration of 3 mg/mL), and 1.93 for bar 1505 (UA-1G concentration of 5 mg/mL).

### Example 12: Effect of Priming the Surface of Paraffin Wax on the Contact Angle of Solvents and Mixtures

FIG. 16 shows a graph of contact angles of various solvents and mixtures on the surface of paraffin wax. Contact angles were determined by placing drops containing 5 microliters of solvent/mixture on the surface of paraffin wax and determining the contact angle by digital image analysis. Each bar in the graph represents measurements of 15-20 drops. For bar 1601, the solvent was pure water. For bar 1602, the mixture included SA-1G and SA-Na combined at a mass ratio of 95:5 and dispersed in water at a concentration of 45 mg/mL. The mixture corresponding to bar 1603 was the same as that of bar 1602 but also included 3 mg/mL of CA-1G. For bar 1604, a mixture of CA-1G at a concentration of 3 mg/mL in water was first deposited on the surface of the paraffin wax and then allowed to dry in order to prime the surface. Afterward, the contact angle of water on the primed surface was determined. For bar 1605, a mixture of CA-1G at a concentration of 3 mg/mL in water was first deposited on the surface of the paraffin wax and then allowed to dry in order to prime the surface. Afterward, the contact angle of a mixture of SA-1G and SA-Na at a mass ratio of 95:5 dispersed in water at a concentration of 45 mg/mL on the primed surface was determined.

As seen in FIG. 16, the drops corresponding to bar 1601 (pure water) exhibited an average contact angle of 74° on paraffin wax. The drops corresponding to bar 1602 (a mixture of SA-1G and SA-Na) exhibited an average contact angle of 83° on paraffin wax. The drops corresponding to bar 1603 (a mixture of SA-1G, Sa-Na, and CA-1G) exhibited an average contact angle of 43° on paraffin wax. The drops corresponding to bar 1604 (pure water on primed paraffin wax surface) exhibited an average contact angle of 24°. The drops corresponding to bar 1605 (mixture of SA-1G and SA-Na in water on primed paraffin wax surface) exhibited an average contact angle of 30°.

### Example 13: Effect of Ester to Salt Ratio in Coatings Over Avocados on Mass Loss Factor

FIG. 18 shows the mass loss factor for groups of avocados that were coated with a coating agent including either SA-Na or MA-Na combined at different ratios with a mixture that was approximately a 50/50 mix of SA-1G and PA-1G. Coatings were formed by adding each coating agent to water at a concentration of 30 mg/mL to form a suspension, applying the suspension to the surface of the avocados, and allowing the solvent to evaporate. Bar 1801 corresponds to untreated avocados (control group). Bar 1802 corresponds to a coating agent including the SA-1G/PA-1G mixture and SA-Na combined at a mass ratio of 94:6. Bar 1803 corresponds to a coating agent including the SA-1G/PA-1G mixture and SA-Na combined at a mass ratio of 70:30. Bar 1804 corresponds to a coating agent including the SA-1G/PA-1G mixture and MA-Na combined at a mass ratio of 94:6. Bar 1805 corresponds to a coating agent including the SA-1G/PA-1G mixture and MA-Na combined at a mass ratio of 70:30. Each bar in the graph represents a group of 180 avocados. All coatings were formed by brushing the suspension onto the avocados on a brush bed, placing the avocados on drying racks, and allowing the avocados to dry under ambient room conditions at a temperature in the range of about 23° C.-27° C. and humidity in the range of about 40%-55%. The avocados were held at these same temperature and humidity conditions for the entire duration of the time they were tested.

As seen in FIG. 18, the average mass loss factor for the avocados corresponding to bar 1802 was 1.88, the average mass loss factor for the avocados corresponding to bar 1803 was 1.59, the average mass loss factor for the avocados corresponding to bar 1804 was 2.47, and the average mass loss factor for the avocados corresponding to bar 1805 was 1.91.

### Example 14: Effect of Emulsifier on Mass Loss Rate of Avocados

FIG. 19 shows the mass loss rate of a group of avocados that were coated with a coating agent including either a compound of Formula II or Formula III (SA-Na), a fatty alcohol derivative (sodium lauryl sulfate), or a phospholipid (lecithin) combined with a mixture that was approximately a 50/50 mix of SA-1G and PA-1G. Coatings were formed by adding to water 28.2 g/L of the SA-1G, along with the SA-Na (at a 94 to 6 ratio of SA-1G/PA-1G mixture to SA-Na), sodium lauryl sulfate (at a 94 to 6 ratio of SA-1G/PA-1G mixture to SLS), or lecithin (at a 70 to 30 ratio of SA-1G/PA-1G mixture to lecithin) to form a suspension, applying the suspension to the surface of the avocados, and allowing the solvent to evaporate. Bar 1901 corresponds to untreated avocados (control group). Bar 1902 corresponds to a coating agent including the SA-1G/PA-1G mixture and SA-Na. Bar 1903 corresponds to a coating agent including the SA-1G/PA-1G mixture and SLS. Bar 1904 corresponds to a coating agent including the SA-1G/PA-1G mixture and soy lecithin. All coatings were formed by brushing the suspension onto the avocados on a brush bed, placing the avocados on drying racks, and allowing the avocados to dry under ambient room conditions at a temperature in the range of about 23° C.-27° C. and humidity in the range of about 40%-55%. The avocados were held at these same temperature and humidity conditions for the entire duration of the time they were tested.

As seen in FIG. 19, the average mass loss rate for the avocados corresponding to bar 1901 was 1.44% per day, the average mass loss rate for the avocados corresponding to bar 1902 was 0.88% per day, the average mass loss rate for the avocados corresponding to bar 1903 was 0.69% per day, and the average mass loss rate for the avocados corresponding to bar 1904 was 1.08% per day.

### Example 15: Effect of Concentration and Emulsifier in Coatings Over Avocados on Respiration and Mass Loss

FIG. 20 shows the mass loss factor of a group of avocados that were coated with a coating agent including either SA-Na or sodium lauryl sulfate (SLS), with a mixture that was approximately a 50/50 mix of SA-1G and PA-1G. All of the coatings were formed using a 94 to 6 ratio of the SA-1G/PA-1G mixture to either SA-Na or SLS. Coatings were formed by adding each coating agent to water at a concentration of 20 g/L, 30 g/L, or 40 g/L to form a suspension, applying the suspension to the surface of the avocados, and allowing the solvent to evaporate. Bar 2001 corresponds to a coating agent including the SA-1G/PA-1G mixture and SA-Na at 20 g/L. Bar 2002 corresponds to a coating agent including the SA-1G/PA-1G mixture and SLS at 20 g/L. Bar 2003 corresponds to a coating agent including the SA-1G/PA-1G mixture and SA-Na at 30 g/L. Bar 2004 corresponds to a coating agent including the SA-1G/PA-1G mixture and SLS at 30 g/L. Bar 2005 corresponds to a coating agent including the SA-1G/PA-1G mixture and SA-Na at 40 g/L. Bar 2006 corresponds to a coating agent including the SA-1G/PA-1G mixture and SLS at 40 g/L. All coatings were formed by brushing the suspension onto the avocados on a brush bed, placing the avocados on drying racks, and allowing the avocados to dry under ambient room conditions at a temperature in the range of about 23° C.-27° C. and humidity in the range of about 40%-55%. The avocados were held at these same temperature and humidity conditions for the entire duration of the time they were tested.

As seen in FIG. 20, the mass loss factor for the avocados corresponding to bar 2001 was 1.57, the mass loss factor for the avocados corresponding to bar 2002 was 1.63, the mass loss factor for the avocados corresponding to bar 2003 was 1.64, the mass loss factor for the avocados corresponding to bar 2004 was 1.76, the mass loss factor for the avocados corresponding to bar 2005 was 1.81, and the mass loss factor for the avocados corresponding to bar 2006 was 1.88.

FIG. 21 shows the respiration factor for the same group of avocados as above. Bar 2101 corresponds to a coating agent including the SA-1G/PA-1G mixture and SA-Na at 20 g/L. Bar 2102 corresponds to a coating agent including the SA-1G/PA-1G mixture and SLS at 20 g/L. Bar 2103 corresponds to a coating agent including the SA-1G/PA-1G mixture and SA-Na at 30 g/L. Bar 2104 corresponds to a coating agent including the SA-1G/PA-1G mixture and SLS at 30 g/L. Bar 2105 corresponds to a coating agent including the SA-1G/PA-1G mixture and SA-Na at 40 g/L. Bar 2106 corresponds to a coating agent including the SA-1G/PA-1G mixture and SLS at 40 g/L.

As seen in FIG. 21, the respiration factor for the avocados corresponding to bar 2101 was 1.21, the respiration factor for the avocados corresponding to bar 2102 was 1.20, the respiration factor for the avocados corresponding to bar 2103 was 1.22, the respiration factor for the avocados corresponding to bar 2104 was 1.34, the respiration factor for the avocados corresponding to bar 2105 was 1.32, and the respiration factor for the avocados corresponding to bar 2102 was 1.41.

FIGS. 22 and 23 show droplets of coating mixtures (i.e., coating agents in a solvent) on a surface. Contact angles were determined by placing drops containing 5 microliters of solution on the surface being tested and determining the contact angle by digital image analysis. FIG. 22 corresponds to a representative image of a droplet of a coating mixture that included a 94 to 6 ratio of a 50/50 mixture of SA-1G and PA-1G to SA-Na in water at 45 g/L. The observed contact angle from coating mixtures such as that in FIG. 22 is 95±5°. FIG. 23 corresponds to representative image of a coating mixture including a 94 to 6 ratio of a 50/50 mixture of SA-1G and PA-1G to SLS in water at 45 g/L. The observed contact angle from coating mixtures such as that in FIG. 23 is 84 4°.

### Example 16: Effect of Coating on Humidity During Cold Storage of Lemons

| Treatment Group | Mass Loss Rate (% per | |
|---|---|---|
| (Lemons) | day) | Humidity (after 48 hours) |
| Untreated | 1.61 | 72% |
| 50 g/L | 0.37 | 61% |

The table above shows a comparison between mass loss rates and cold storage humidity for untreated lemons and lemons treated with a 94:6 mixture of fatty acid esters (an approximately 50/50 mix of SA-1G and PA-1G) and fatty acid salts (SA-Na) at 50 g/L in water. Each treatment group included 7 boxes of lemons with 60 lemons per box. Each treatment group was placed in a chest freezer equipped with a fan and a humidity sensor. As seen in the table above the untreated group had a mass loss rate of 1.61% per day, as compared to 0.37% per day for the lemons treated with the 50 g/L mixture. The higher mass loss rate of the untreated group corresponded to a higher humidity inside the chest freezer, with the freezer containing the untreated lemons having a humidity of 72%, as compared to 61% humidity in the freezer with the lemons treated with the 50 g/L mixture.

### Example 17: Effect of Coating on Energy Usage During Cold Storage of Avocados

| Treatment Group | Energy Usage after 72 hours (at 16° C.) |
|---|---|
| Untreated | 1.19 kWh |
| 50 g/L | 0.85 kWh |

The table above shows a comparison between energy usage of untreated avocados and avocados treated with a 94:6 mixture of fatty acid esters (an approximately 50/50 mix of SA-1G and PA-1G) and fatty acid salts (SA-Na) at 50 g/L in water. Each treatment group included 7 boxes of avocados with 60 avocados per box. Each treatment group was placed in a chest freezer equipped with a fan and an energy usage meter. As seen in the table above, the freezer containing the untreated group consumed 1.19 kWh of energy after 72 hours, as compared to 0.85 kWh for the freezer containing the avocados treated with the 50 g/L mixture.

### Example 18: Temperature as a Function of Stacking and Coating

FIG. 25 is a graph showing the average temperature (° C.) of three sample groups over the course of approximately 5 days. Each sample group included 10 boxes of 60 Hass avocados that were either straight stacked (i.e. 5 boxes high, 2 stacks wide, each box stacked parallel to the box below) or cross stacked (i.e. 5 boxes high, 2 stacks wide, each box stacked perpendicular to the box below). One of the straight stack groups (corresponding to 2502) was coated with a coating agent formed of SA-1G and SA-Na mixed at a mass ratio of 94:6 dispersed in water at a concentration of 30 mg/mL. The other groups were untreated avocados that were either straight stacked (corresponding to 2501) or cross stacked (corresponding to 2503). In each group, the data represents the average temperature from 4 temperature loggers distributed throughout the stack after removal from 10° C. cold storage as a function of time.

As shown in FIG. 25, the rate of temperature rise in produce after removal from 10° C. cold storage during the first three days was slowed in the treated produce as compared to the untreated produce. The untreated straight-stacked and cross-stacked produce generated more heat under ambient storage conditions over the first three days compared to the treated, straight-stacked produce, with the untreated, straight-stacked produce generating the most heat. Therefore, the temperature gradient across the pallet should be reduced as well, allowing more even and predictable ripening.

While various compositions and methods have been described above, it should be understood that they have been presented by way of example only, and not limitation. Where methods and steps described above indicate certain events occurring in certain order, ordering of steps may be modified, and such modification are in accordance with the variations of the invention. Additionally, certain of the steps may be performed concurrently in a parallel process when possible, as well as performed sequentially as described above. The various implementations have been particularly shown and described, but it will be understood that various changes in form and details may be made. Accordingly, other implementations are within the scope of the following claims.

1. A composition, comprising:
(i) from 50% to 99% by mass of a first group of compounds, wherein each compound of the first group is a compound of Formula I; and
(ii) from 1% to 50% by mass of a second group of compounds, wherein each compound of the second group is a salt of Formula II, wherein Formulas I and II are: 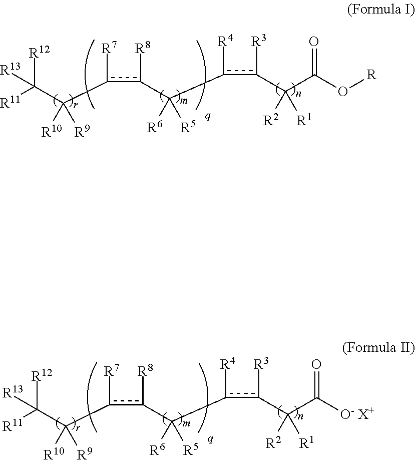
wherein for each of the formulas:
R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
R³ and R⁴ can combine with the carbon atoms to which they are attached to form a C₃-C₆ cycloalkyl, a C₄-C₆ cycloalkenyl, or 3- to 6-membered ring heterocycle; and/or
R⁷ and R⁸ can combine with the carbon atoms to which they are attached to form a C₃-C₆ cycloalkyl, a C₄-C₆ cycloalkenyl, or 3- to 6-membered ring;
R¹⁴ and R¹⁵ are each independently, at each occurrence, —H, aryl, heteroaryl, —C₁-C₆ alkyl, —C₂-C₆ alkenyl, or —C₂-C₆ alkynyl;
the symbol [symbol] represents an optionally single or cis or trans double bond;
n is 0, 1, 2, 3, 4, 5, 6, 7, or 8;
m is 0, 1, 2, or 3;
q is 0, 1, 2, 3, 4, or 5;
r is 0, 1, 2, 3, 4, 5, 6, 7, or 8;
R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen, hydroxyl, nitro, —CN, —NH₂, —SH, —SR¹⁵, —OR¹⁴, —NR¹⁴R¹⁵, —C₁-C₆ alkyl, —C₂-C₆ alkenyl, or —C₂-C₆ alkynyl; and
X is a cationic moiety.

2. A composition, comprising:
(i) from 50% to 99% by mass of a first group of compounds, wherein each compound of the first group is a compound of Formula I; and
(ii) from 1% to 50% by mass of a second group of compounds, wherein each compound of the second group is a compound of Formula III, wherein Formula I and Formula III are: 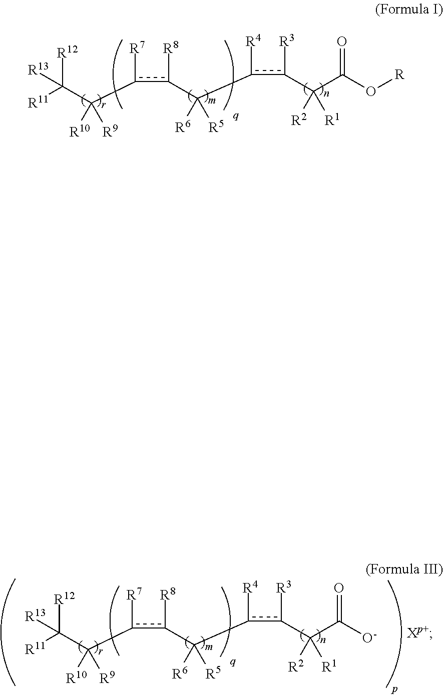
wherein for each of the formulas:
R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
R³ and R⁴ can combine with the carbon atoms to which they are attached to form a C₃-C₆ cycloalkyl, a C₄-C₆ cycloalkenyl, or 3- to 6-membered ring heterocycle; and/or
R⁷ and R⁸ can combine with the carbon atoms to which they are attached to form a C₃-C₆ cycloalkyl, a C₄-C₆ cycloalkenyl, or 3- to 6-membered ring;
R¹⁴ and R¹⁵ are each independently, at each occurrence, —H, aryl, heteroaryl, —C₁-C₆ alkyl, —C₂-C₆ alkenyl, or —C₂-C₆ alkynyl;
the symbol [symbol] represents an optionally single or cis or trans double bond;
n is 0, 1, 2, 3, 4, 5, 6, 7, or 8;
m is 0, 1, 2, or 3;
q is 0, 1, 2, 3, 4, or 5;
r is 0, 1, 2, 3, 4, 5, 6, 7, or 8;
R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen, hydroxyl, nitro, —CN, —NH₂, —SH, —SR¹⁵, —OR¹⁴, —NR¹⁴R¹⁵, —C₁-C₆ alkyl, —C₂-C₆ alkenyl, or —C₂-C₆ alkynyl; and
X^{p+} is a cationic counter ion having a charge state p, and p is 1, 2, or 3.

3. The composition of any of claims 1-2, wherein each compound of the first group of compounds has a carbon chain length of at least 14.

4. The composition of claim 3, wherein each compound of the second group of compounds has a carbon chain length of at least 14.

5. The composition of claim 4, wherein the composition comprises from 70% to 99% by mass of the first group of compounds and from 1% to 30% by mass of the second group of compounds.

6. The composition of any of claims 1-2, wherein R is -glyceryl.

7. The composition of claim 6, wherein the second group of compounds comprises SA-Na, PA-Na, MA-Na, SA-K, PA-K, or MA-K.

8. The composition of any of claims 1-2, wherein a mass ratio of the first group of compounds to the second group of compounds is in a range of 2 to 99.

9. The composition of any of claims 1-2, wherein the composition comprises less than 10% by mass of diglycerides.

10. The composition of any of claims 1-2, wherein the composition comprises less than 10% by mass of triglycerides.

11. The composition of any of claims 1-2, wherein the composition comprises less than 10% by mass of acetylated monoglycerides.

12. The composition of any of claims 1-2, wherein the first group of compounds comprises one or more compound selected from the group consisting of:

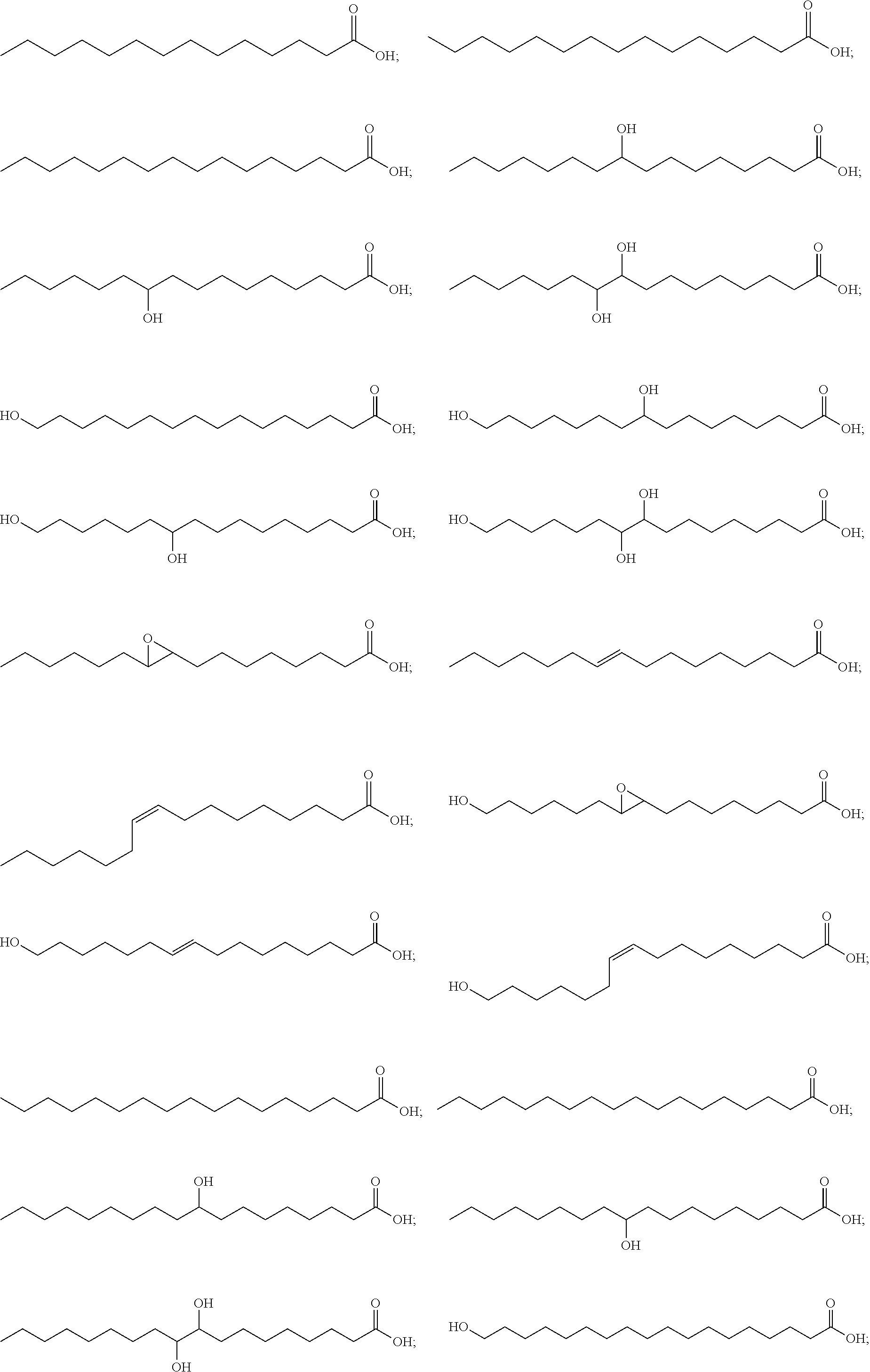

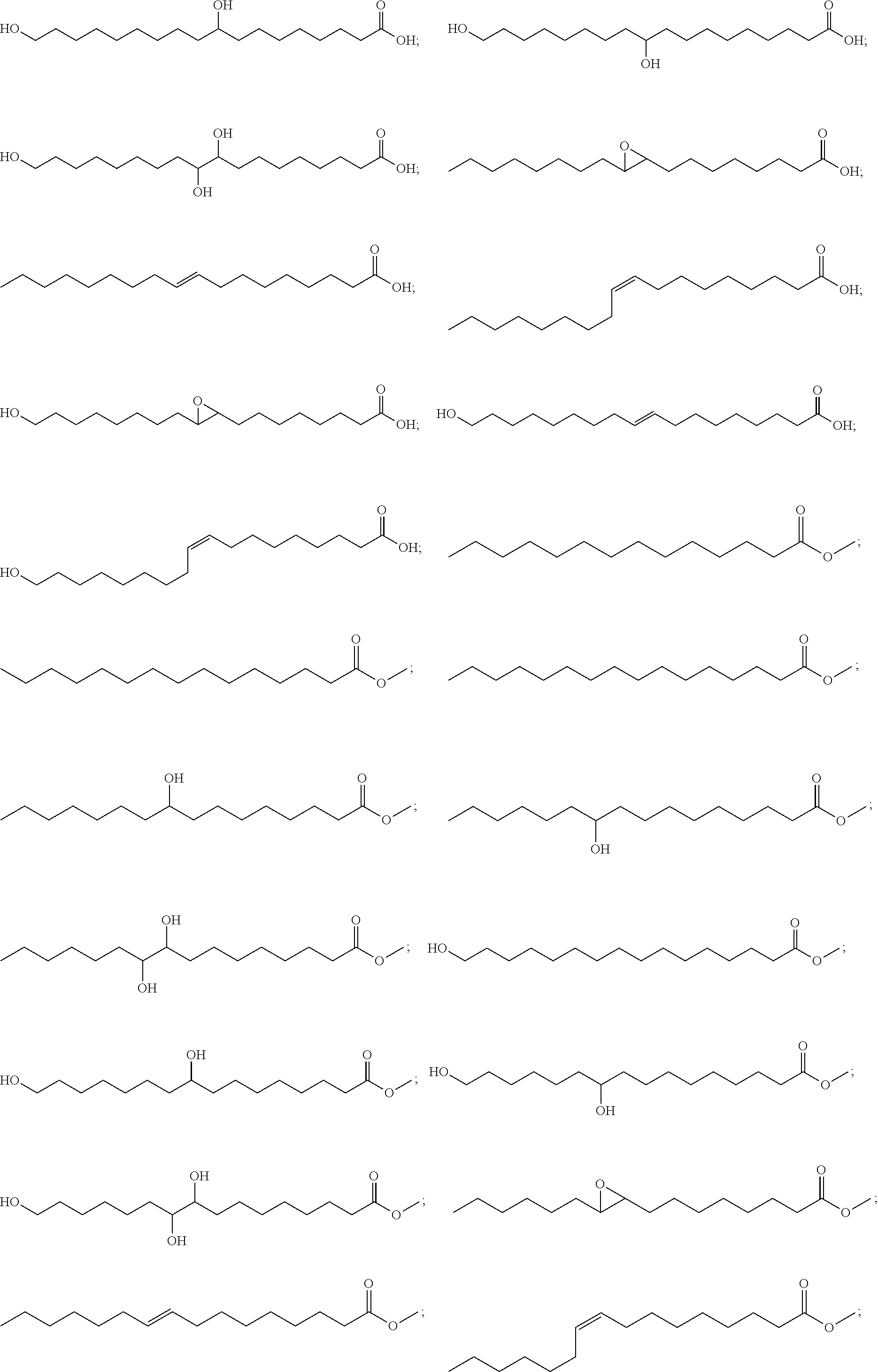

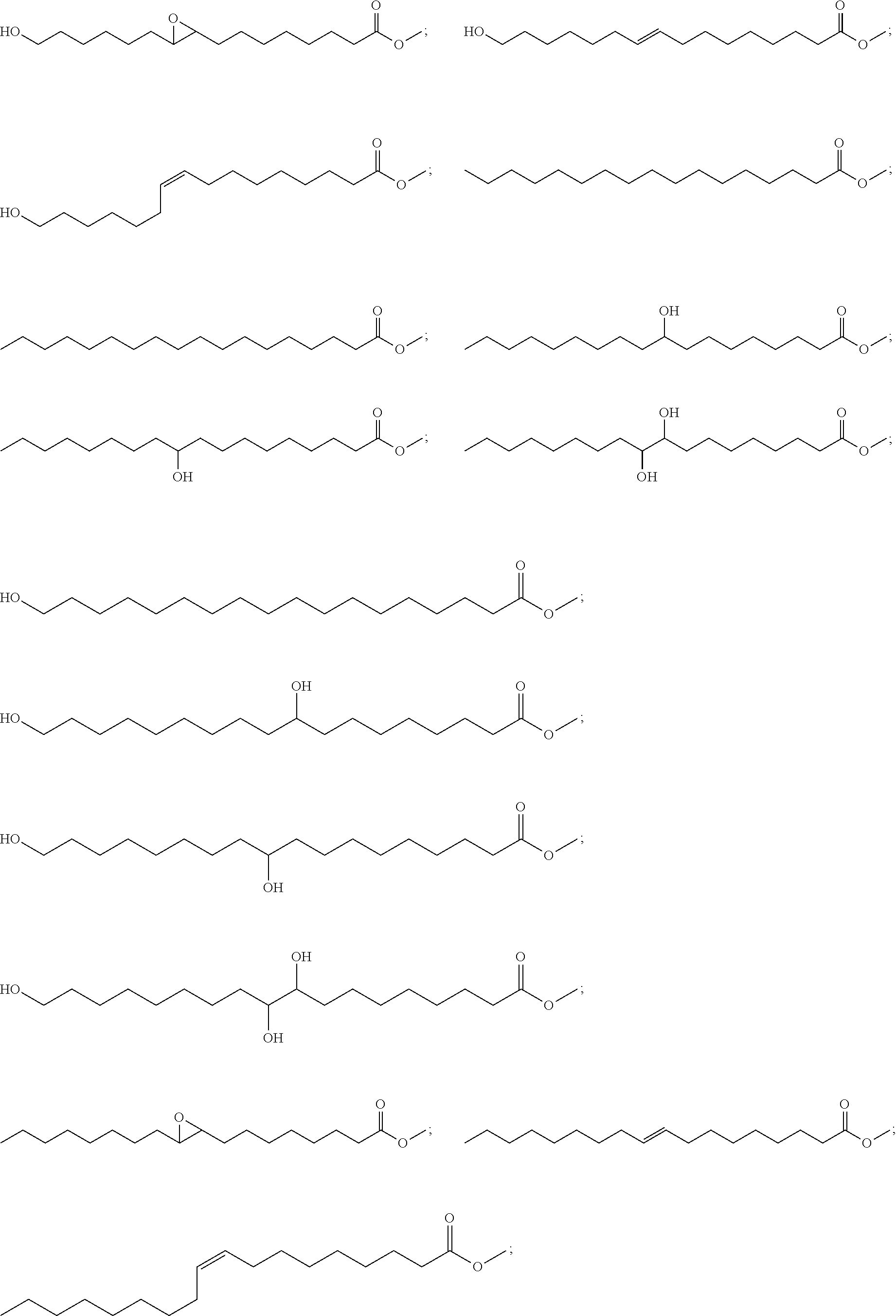

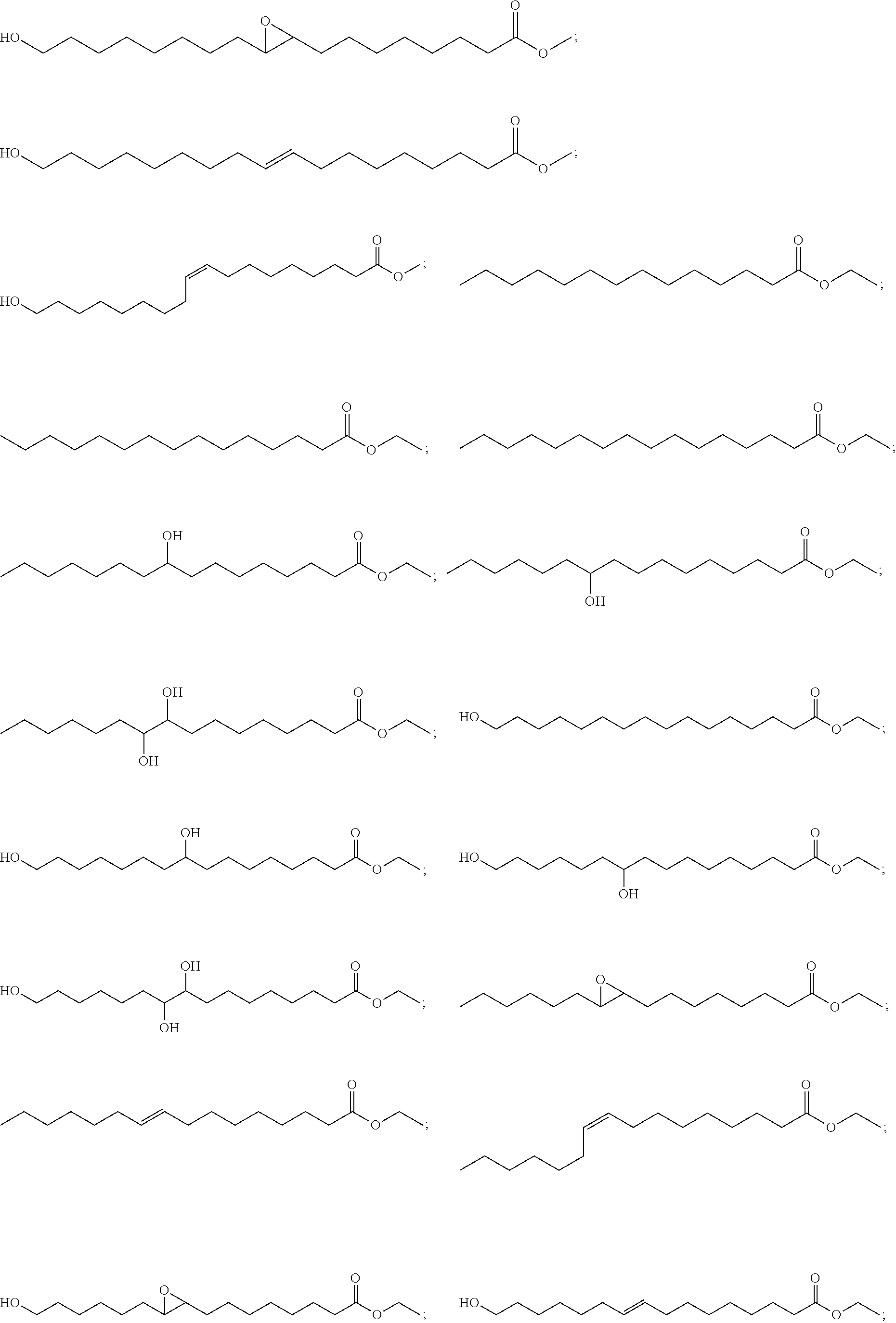

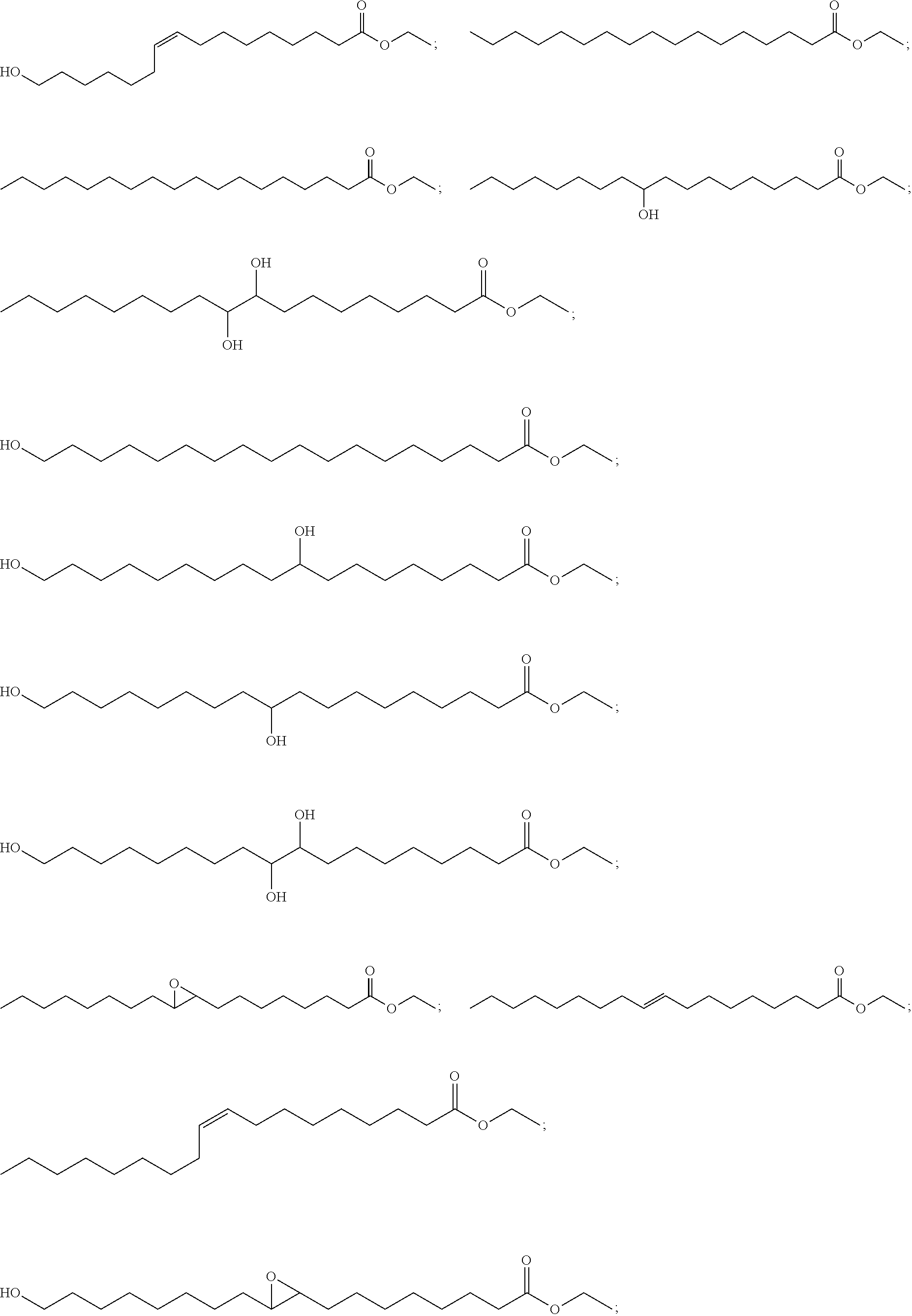

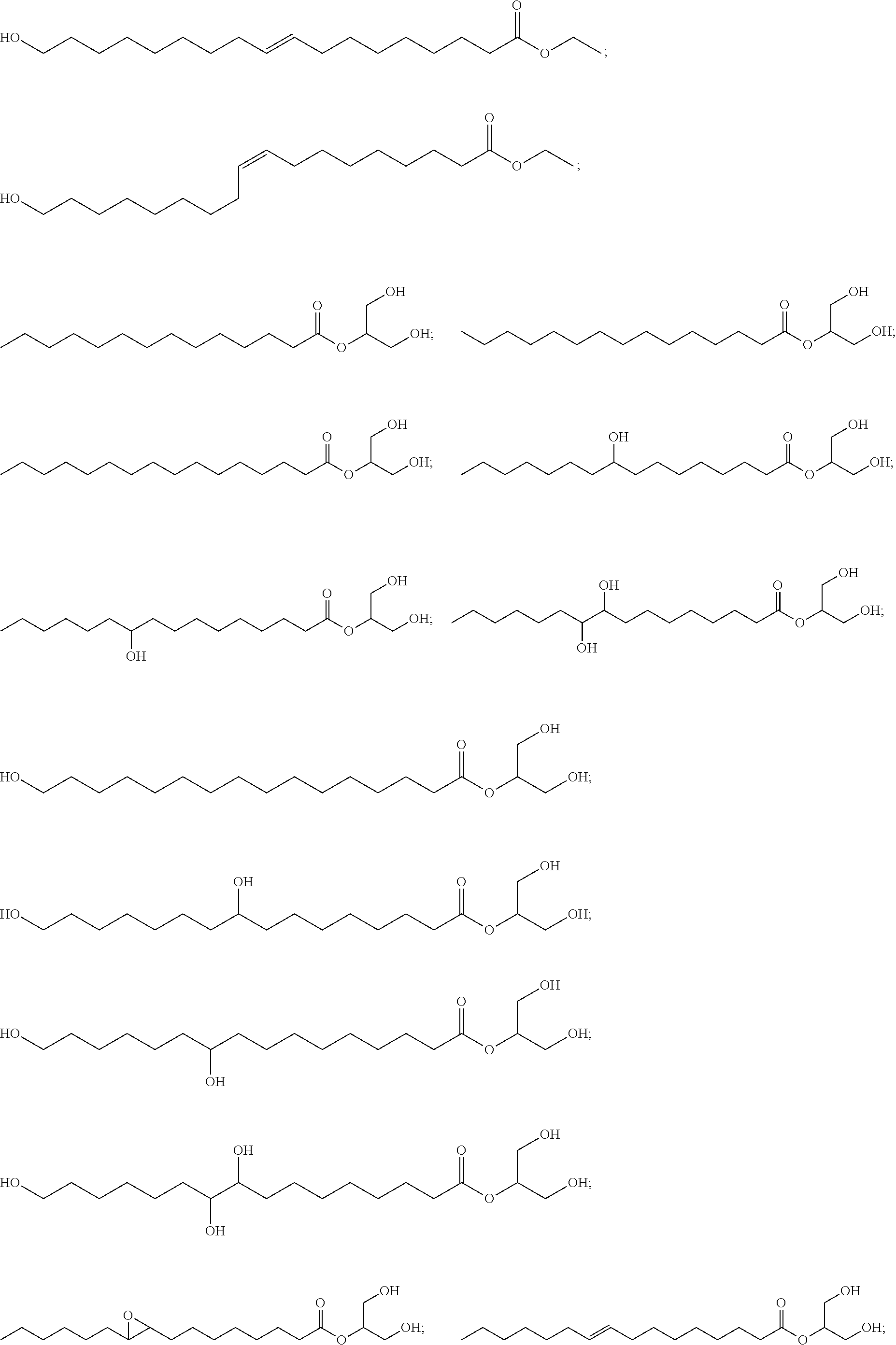

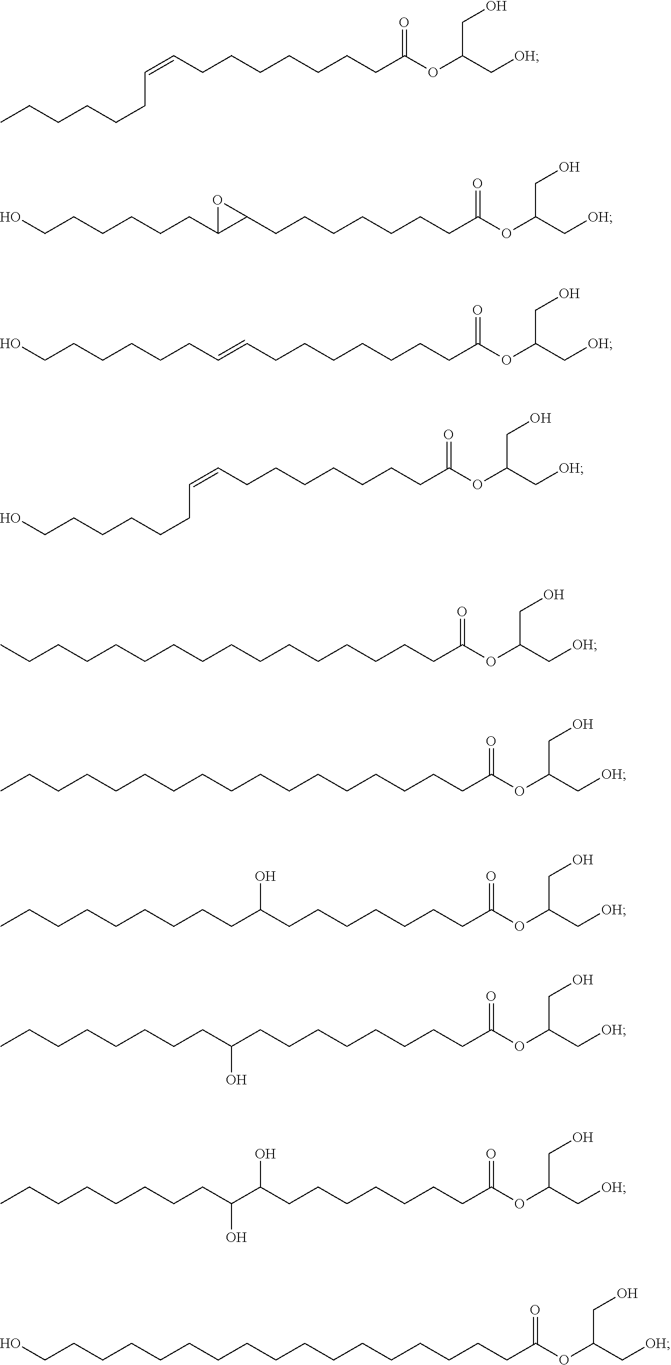

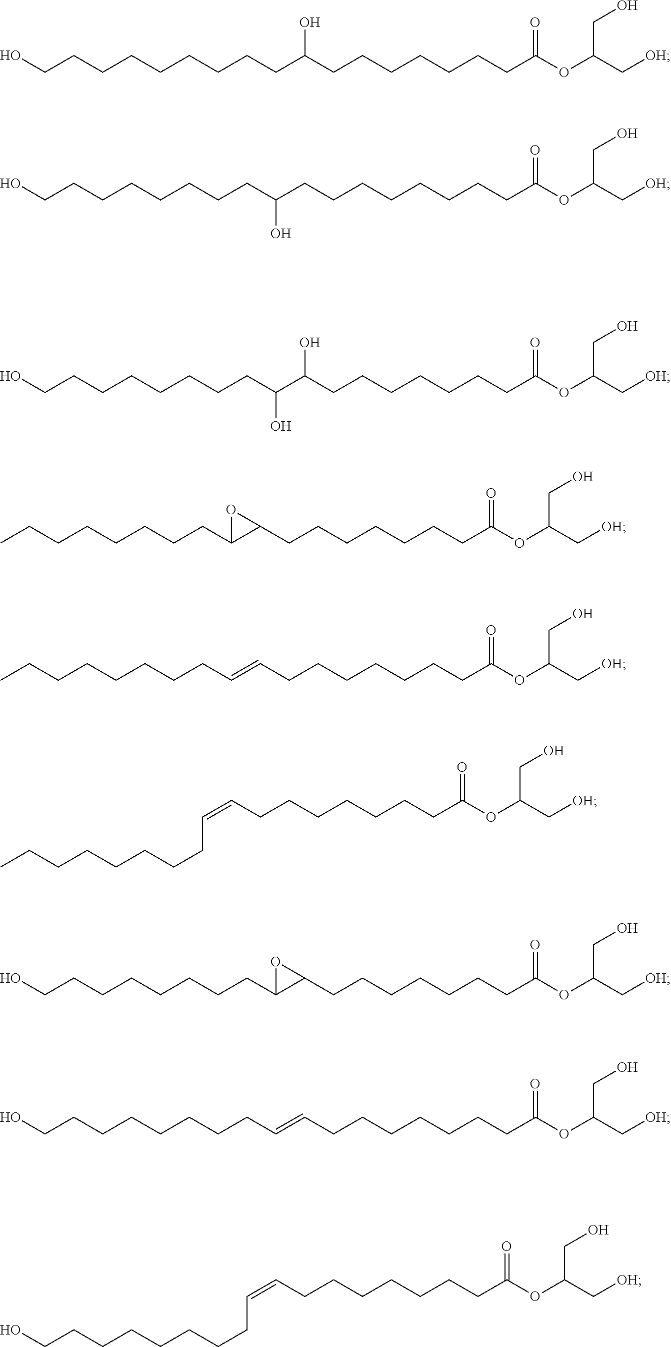

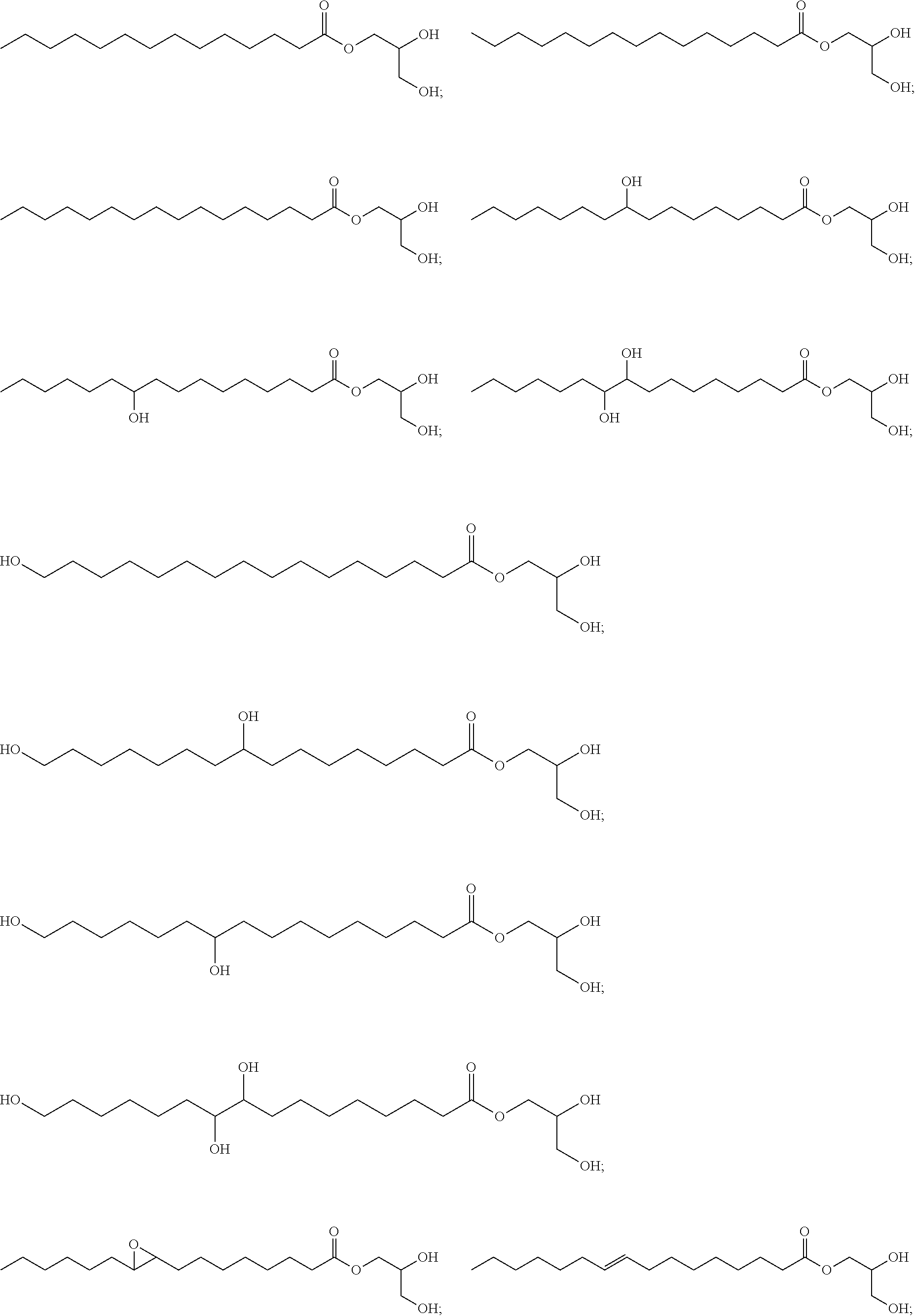

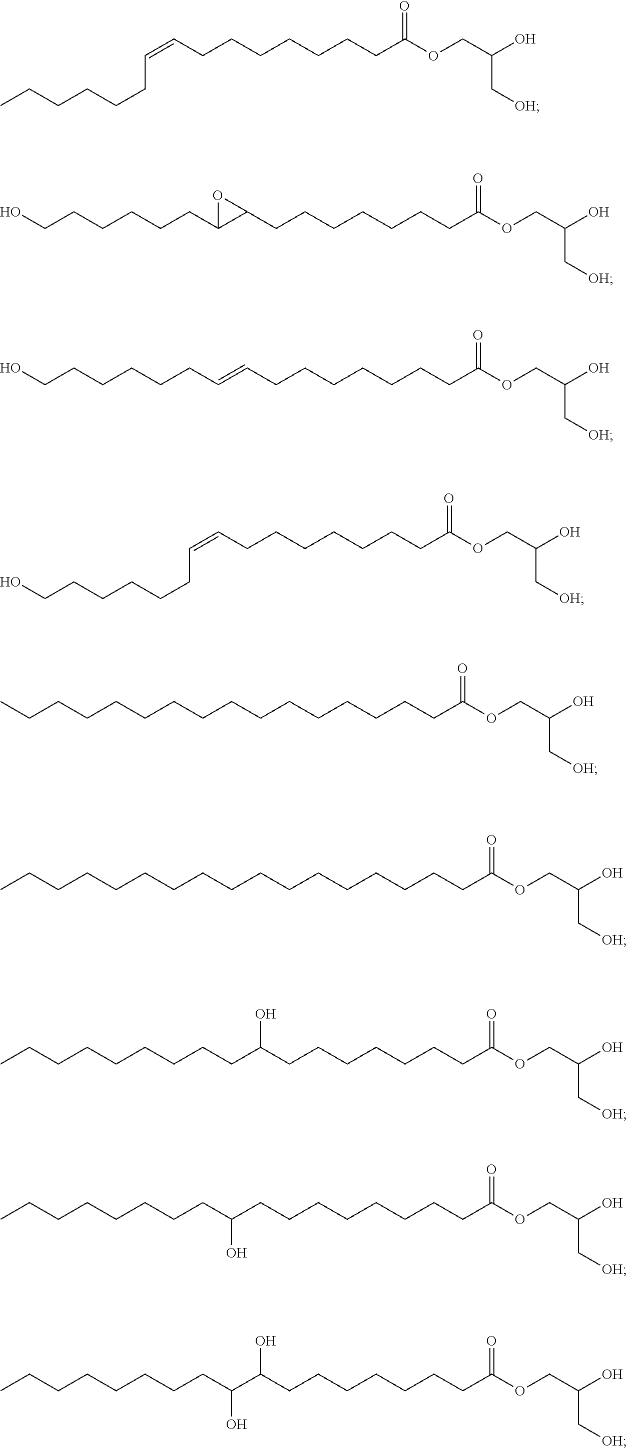

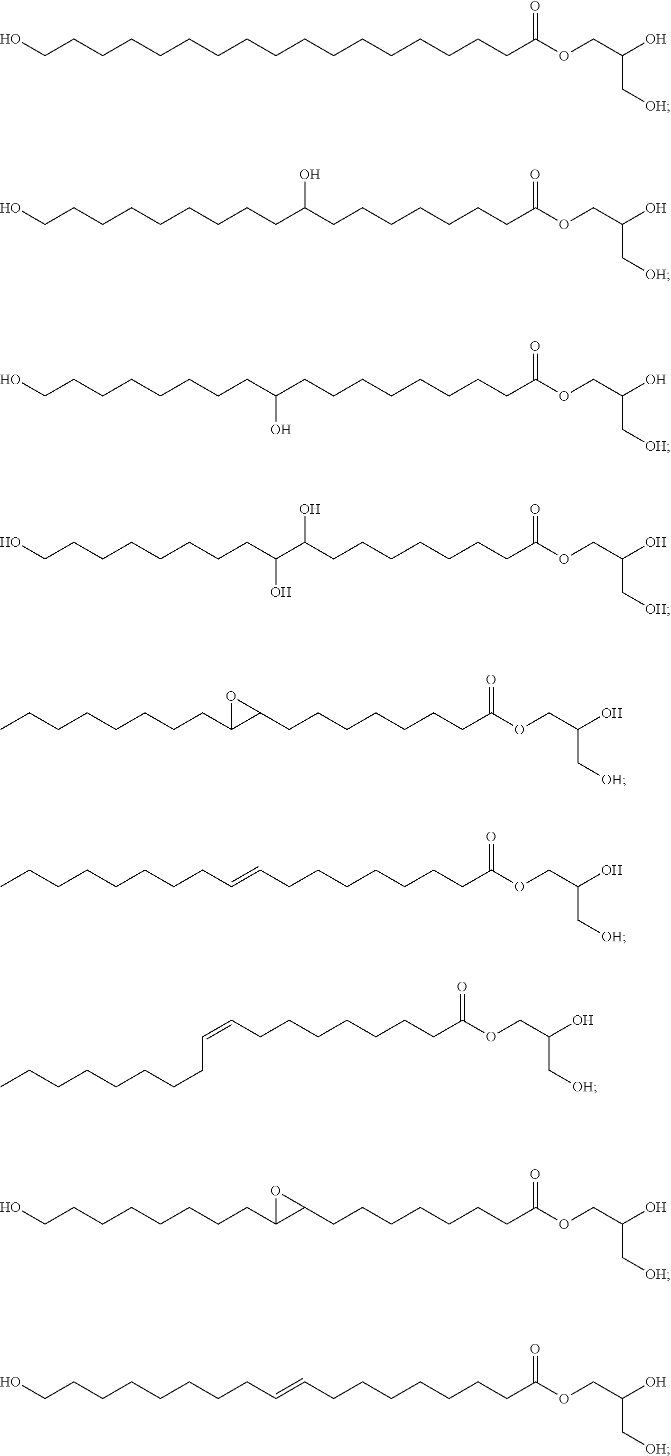

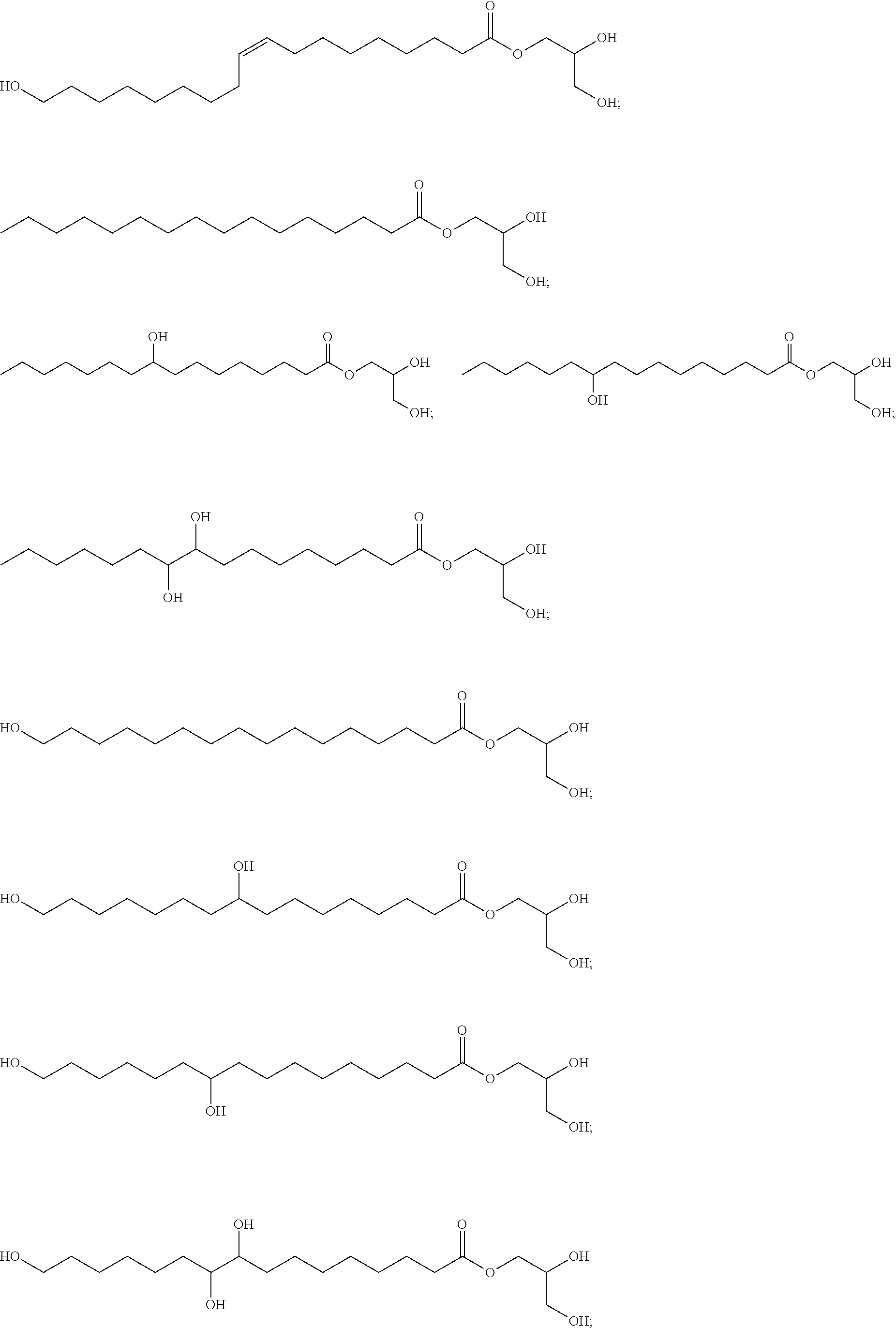

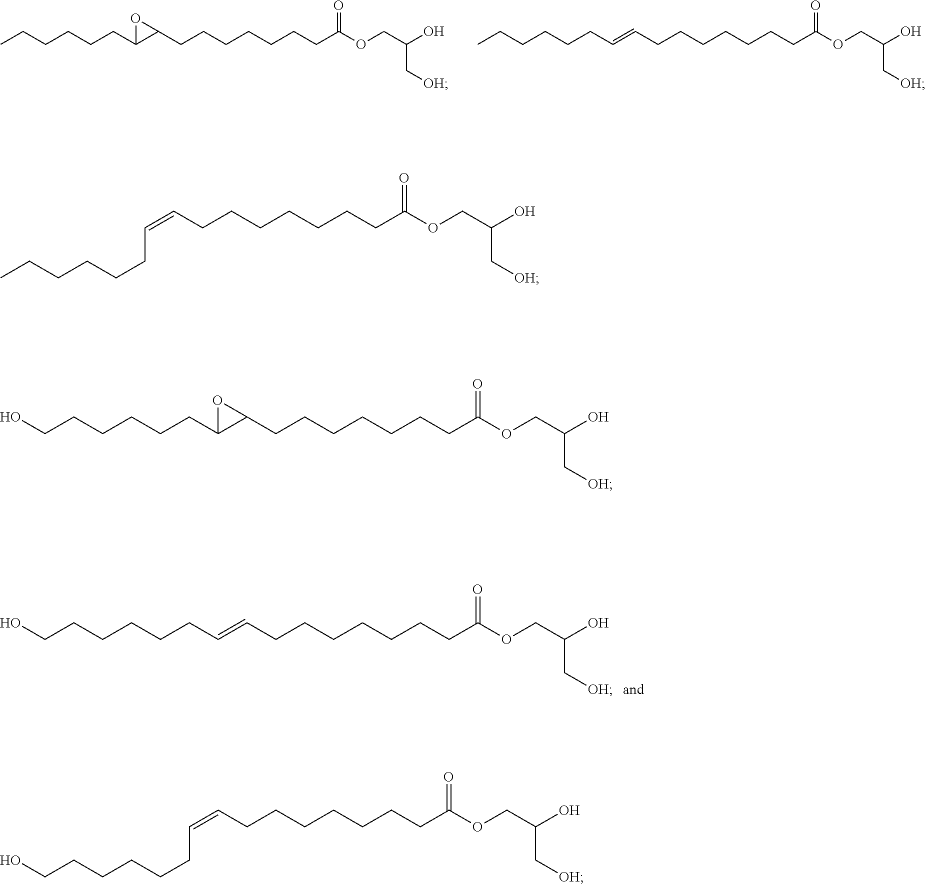

13. The composition of claim 2, wherein the second group of compounds comprises SA-Na, PA-Na, MA-Na, SA-K, PA-K, or MA-K, (SA)₂-Mg, (PA)₂-Mg, (MA)₂-Mg, (SA)₂-Ca, (PA)₂-Ca, or (MA)₂-Ca.

14. A mixture comprising a composition in a solvent, the composition comprising:
(i) from 50% to 99% by mass of a first group of compounds, wherein each compound of the first group is a compound of Formula I;
(ii) from 1% to 50% by mass of a second group of compounds, wherein each compound of the second group is a salt of Formula II, wherein Formulas I and II are: 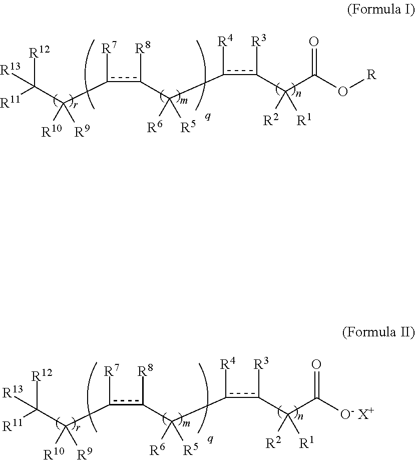
wherein for each of the formulas:
R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
R³ and R⁴ can combine with the carbon atoms to which they are attached to form a C₃-C₆ cycloalkyl, a C₄-C₆ cycloalkenyl, or 3- to 6-membered ring heterocycle; and/or
R⁷ and R⁸ can combine with the carbon atoms to which they are attached to form a C₃-C₆ cycloalkyl, a C₄-C₆ cycloalkenyl, or 3- to 6-membered ring;
R¹⁴ and R¹⁵ are each independently, at each occurrence, —H, aryl, heteroaryl, —C₁-C₆ alkyl, —C₂-C₆ alkenyl, or —C₂-C₆ alkynyl;
the symbol [symbol] represents an optionally single or cis or trans double bond;
n is 0, 1, 2, 3, 4, 5, 6, 7, or 8;
m is 0, 1, 2, or 3;
q is 0, 1, 2, 3, 4, or 5;
r is 0, 1, 2, 3, 4, 5, 6, 7, or 8;
R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen, hydroxyl, nitro, —CN, —NH₂, —SH, —SR¹⁵, —OR¹⁴, —NR¹⁴R¹⁵, —C₁-C₆ alkyl, —C₂-C₆ alkenyl, or —C₂-C₆ alkynyl; and
X is a cationic moiety.

15. A mixture comprising a composition in a solvent, the composition comprising:
(i) from 50% to 99% by mass of a first group of compounds, wherein each compound of the first group is a compound of Formula I;
(ii) from 1% to 50% by mass of a second group of compounds, wherein each compound of the second group is a compound of Formula III, wherein Formula I and Formula III are: 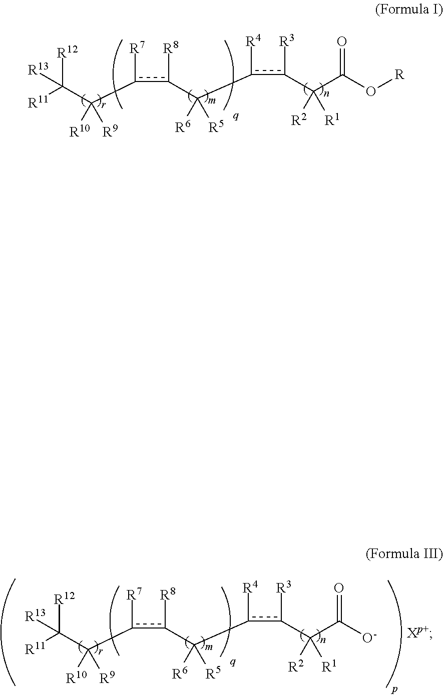
wherein for each of the formulas:
R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
R³ and R⁴ can combine with the carbon atoms to which they are attached to form a C₃-C₆ cycloalkyl, a C₄-C₆ cycloalkenyl, or 3- to 6-membered ring heterocycle; and/or
R⁷ and R⁸ can combine with the carbon atoms to which they are attached to form a C₃-C₆ cycloalkyl, a C₄-C₆ cycloalkenyl, or 3- to 6-membered ring;
R¹⁴ and R¹⁵ are each independently, at each occurrence, —H, aryl, heteroaryl, —C₁-C₆ alkyl, —C₂-C₆ alkenyl, or —C₂-C₆ alkynyl;
the symbol [symbol] represents an optionally single or cis or trans double bond;
n is 0, 1, 2, 3, 4, 5, 6, 7, or 8;
m is 0, 1, 2, or 3;
q is 0, 1, 2, 3, 4, or 5;
r is 0, 1, 2, 3, 4, 5, 6, 7, or 8;
R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen, hydroxyl, nitro, —CN, —NH₂, —SH, —SR¹⁵, —OR¹⁴, —NR¹⁴R¹⁵, —C₁-C₆ alkyl, —C₂-C₆ alkenyl, or —C₂-C₆ alkynyl; and
X^{p+} is a cationic counter ion having a charge state p, and p is 1, 2, or 3.

16. The mixture of any of claims 14-15, wherein the solvent is water.

17. The mixture of any of claims 14-15, wherein the solvent is at least 50% water by volume.

18. The mixture of any of claims 14-15, wherein the first group of compounds comprises one or more compound selected from the group consisting of:

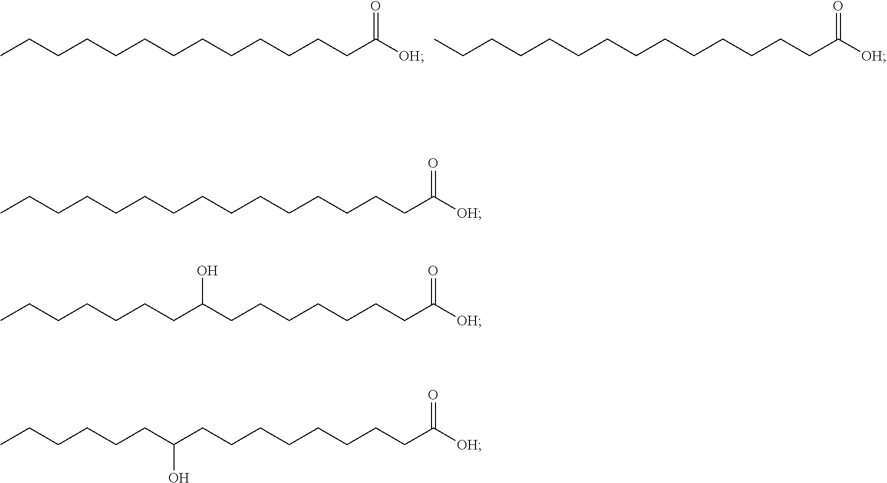

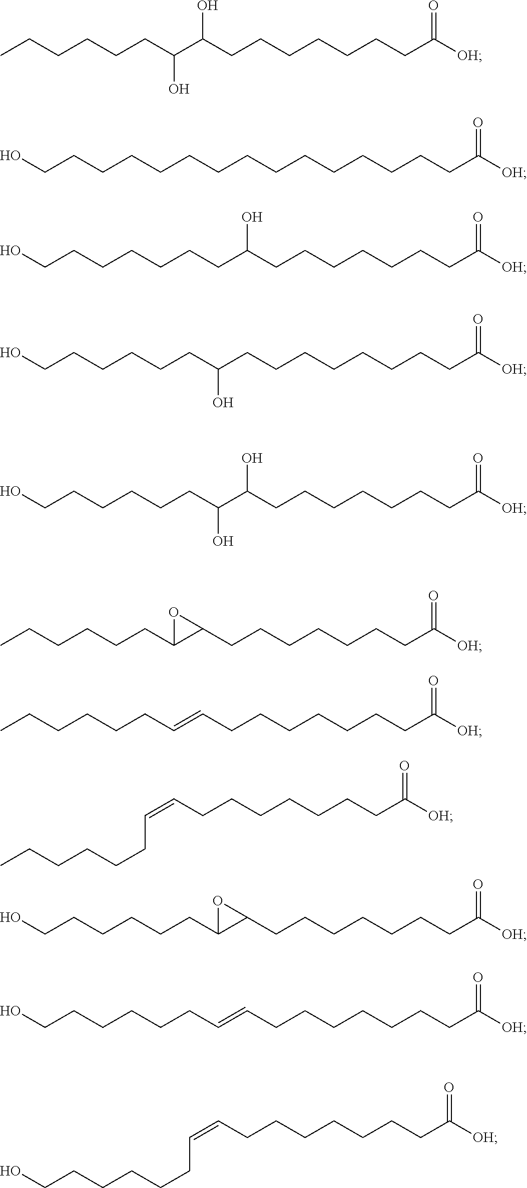

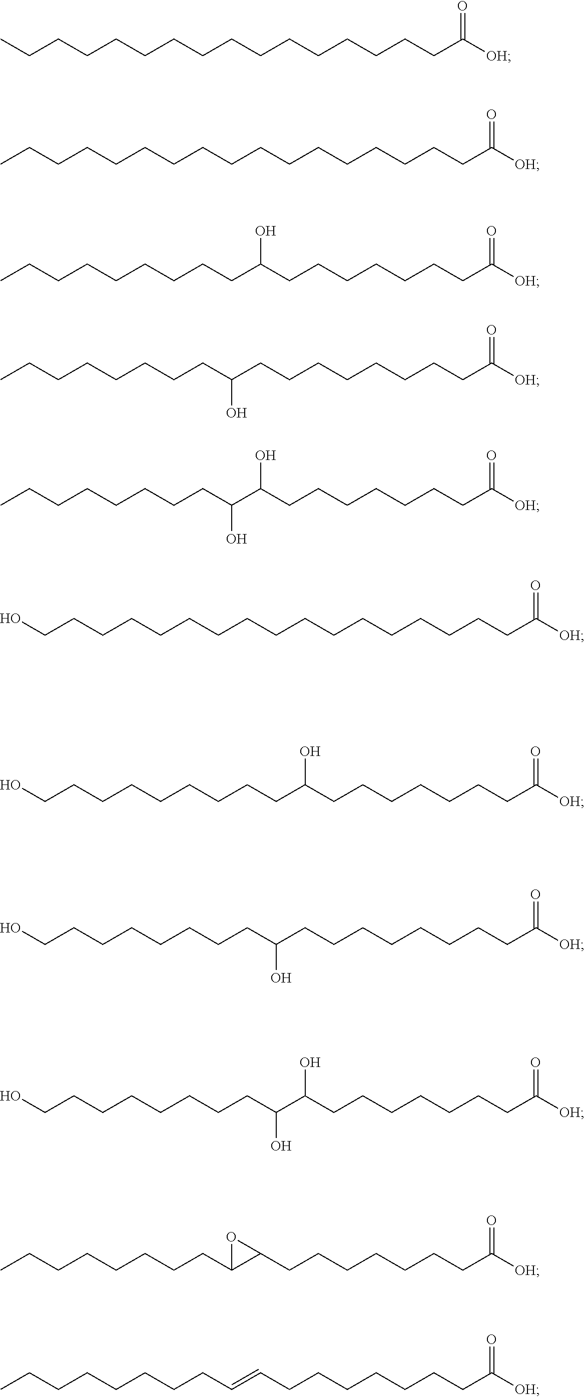

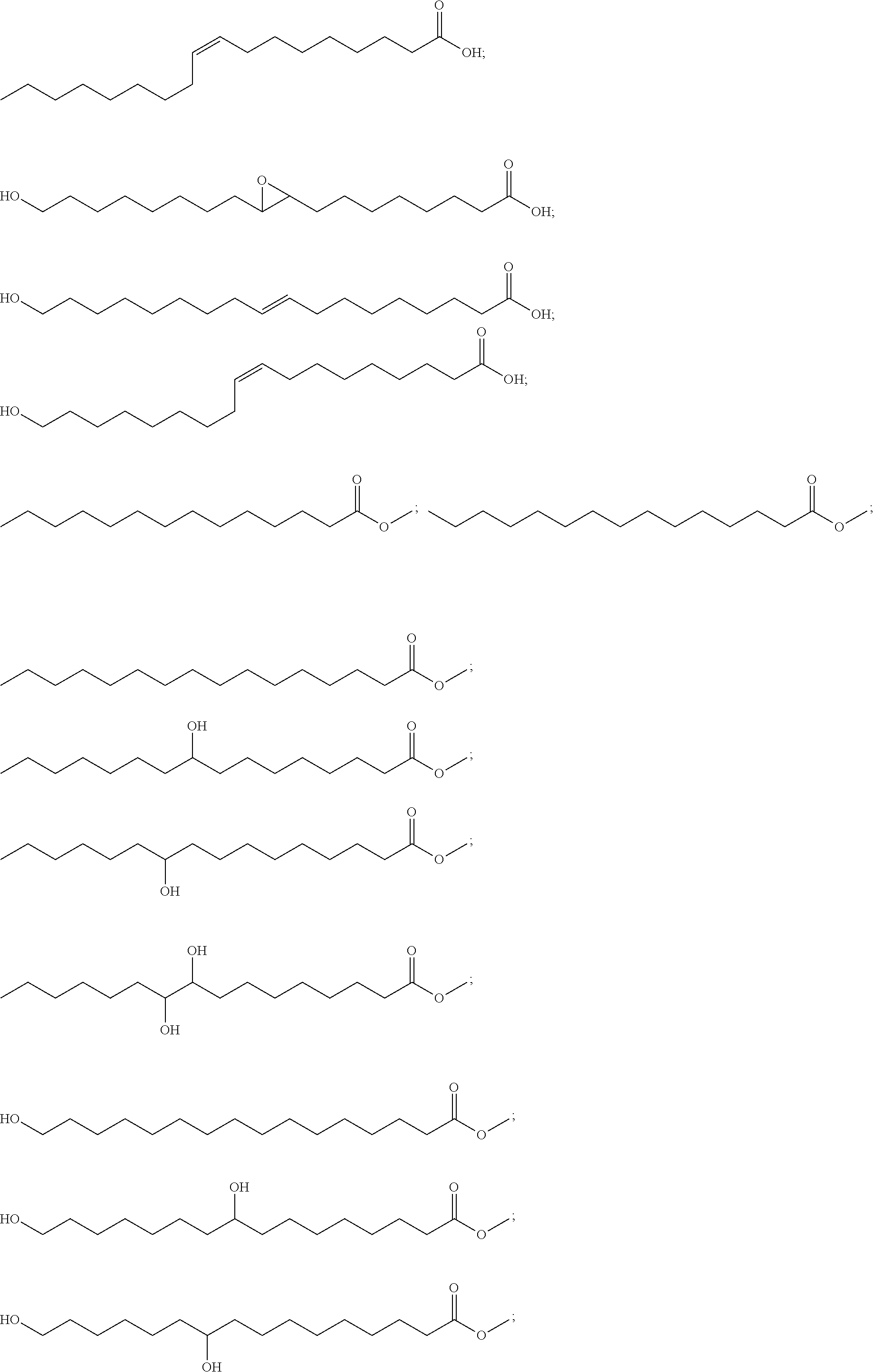

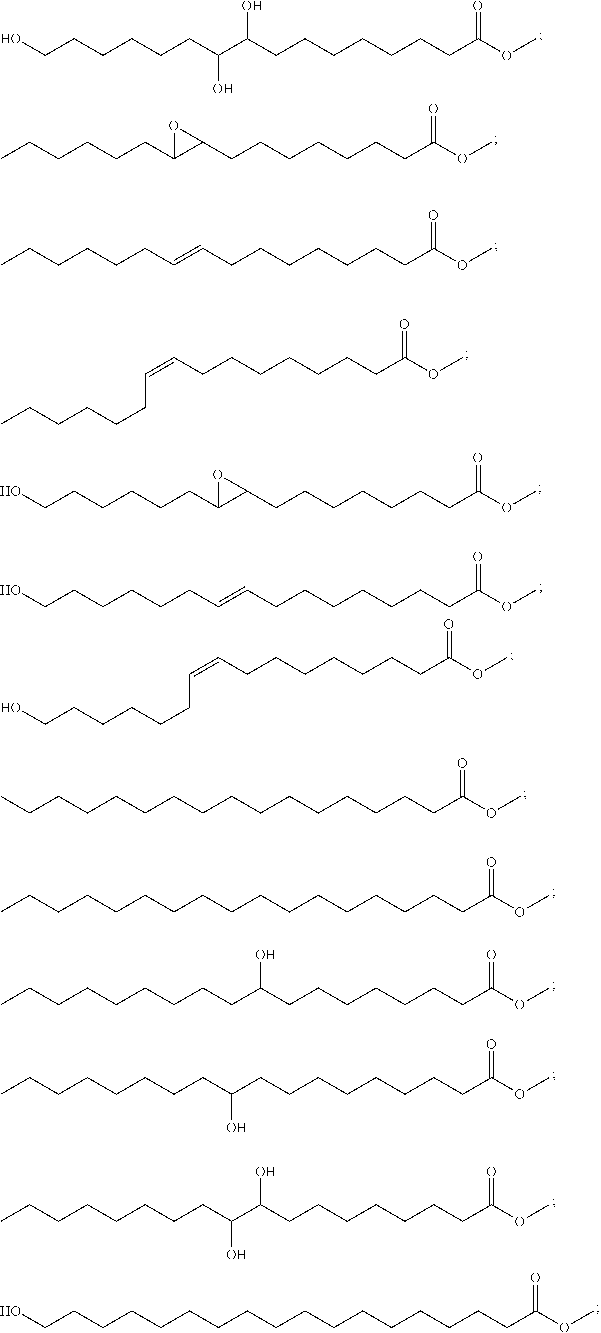

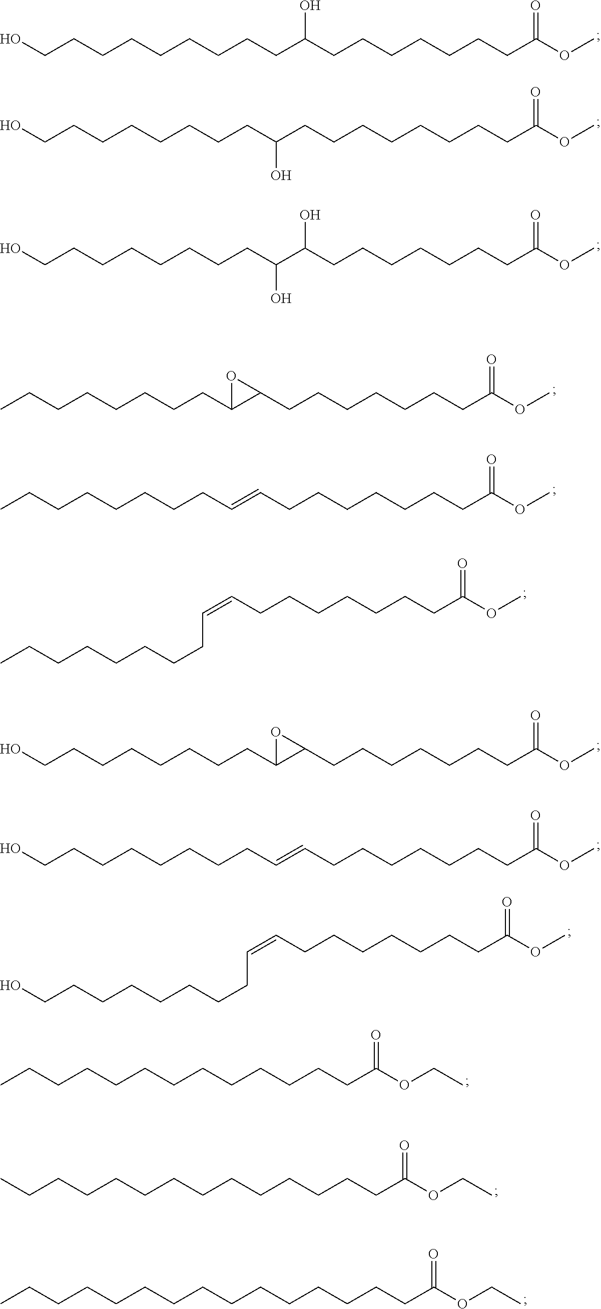

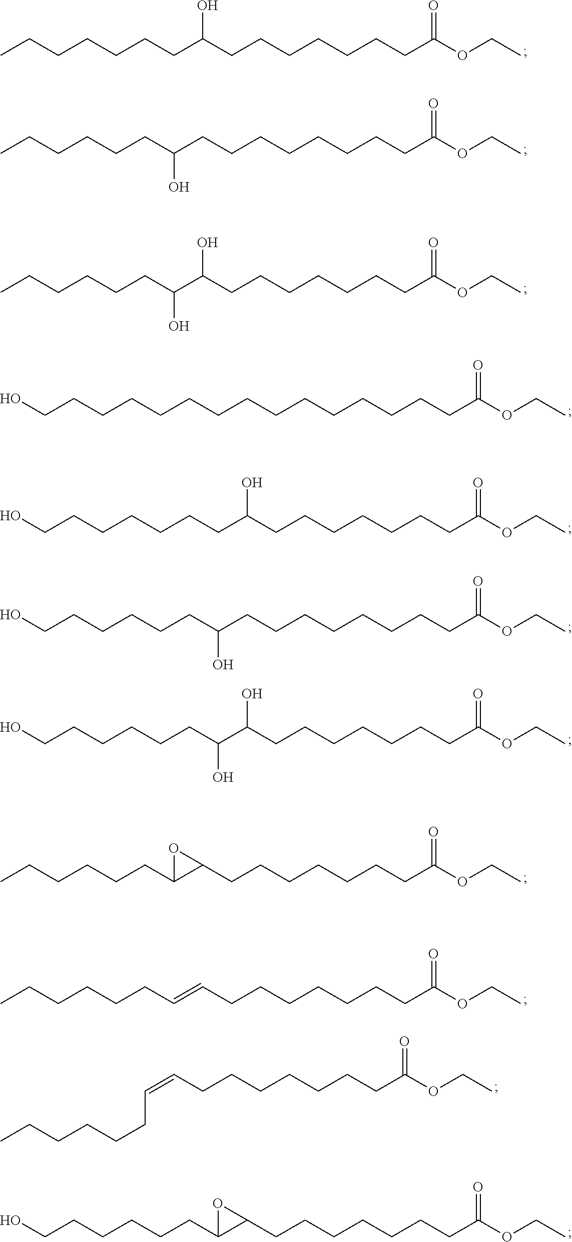

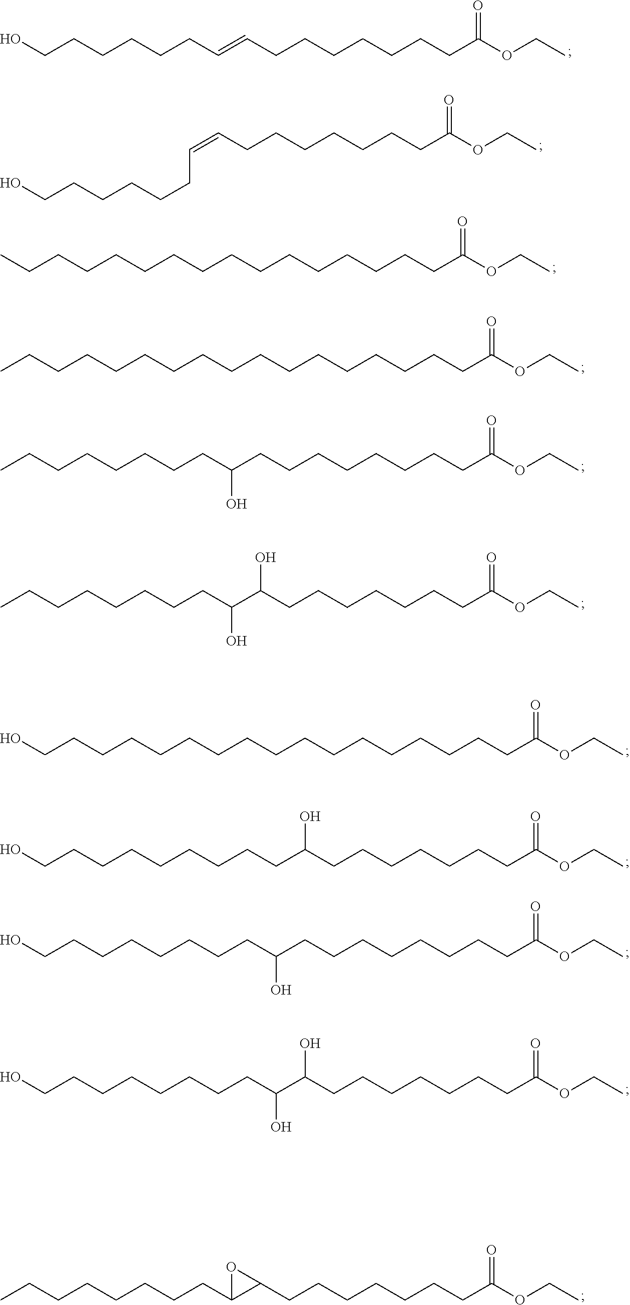

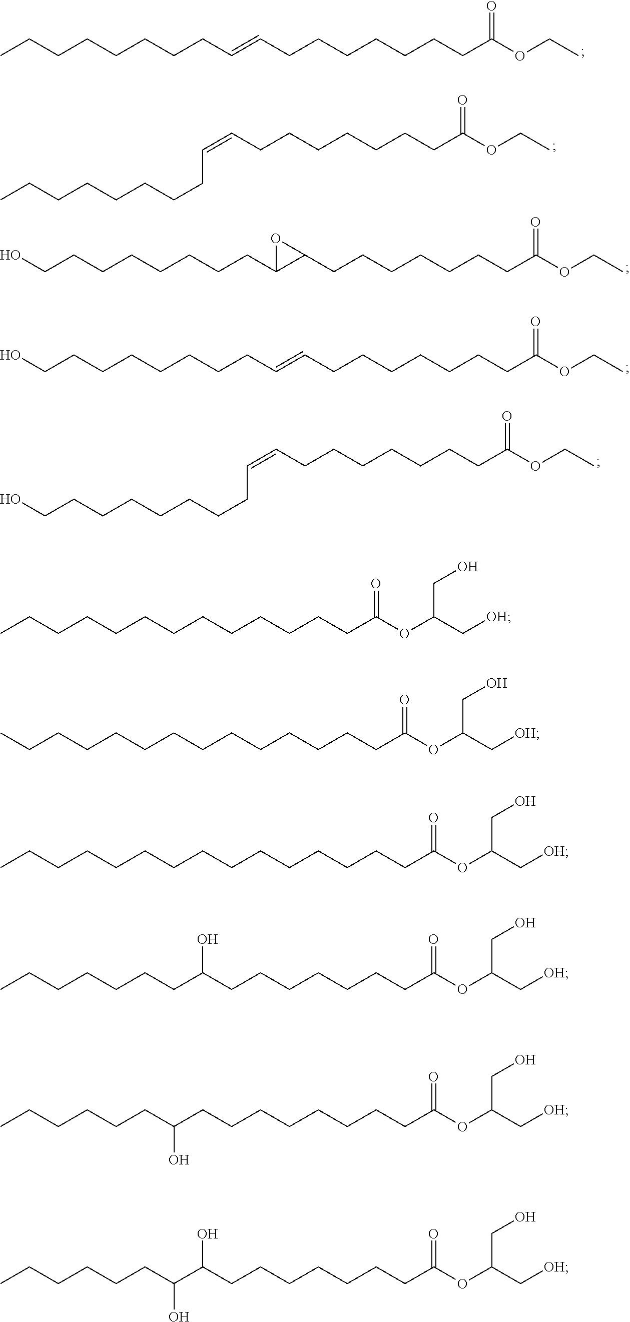

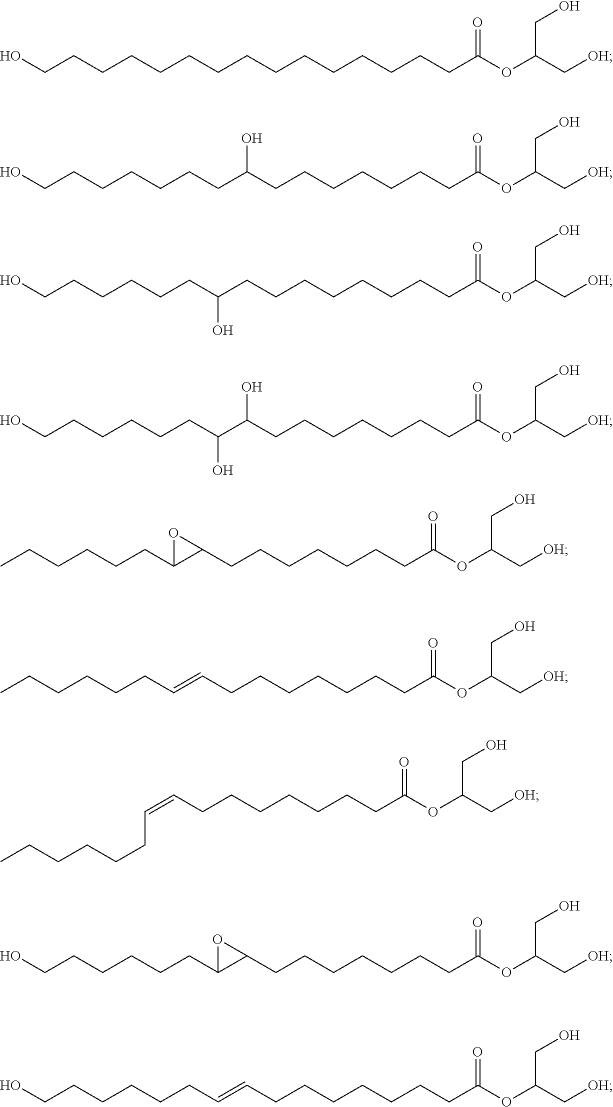

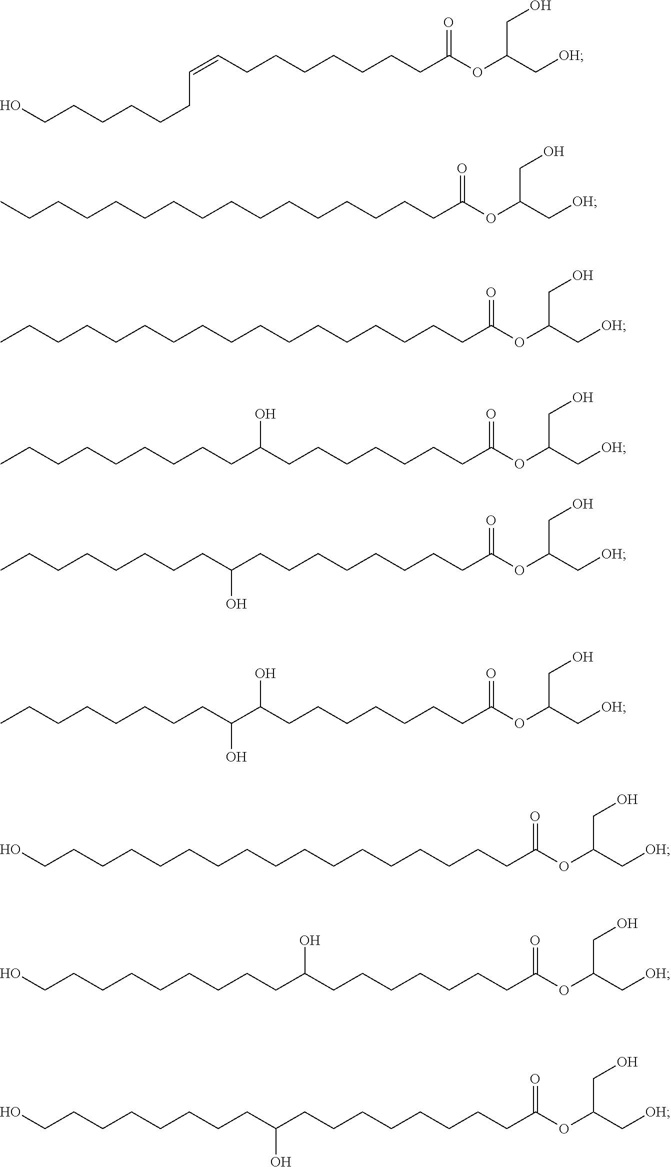

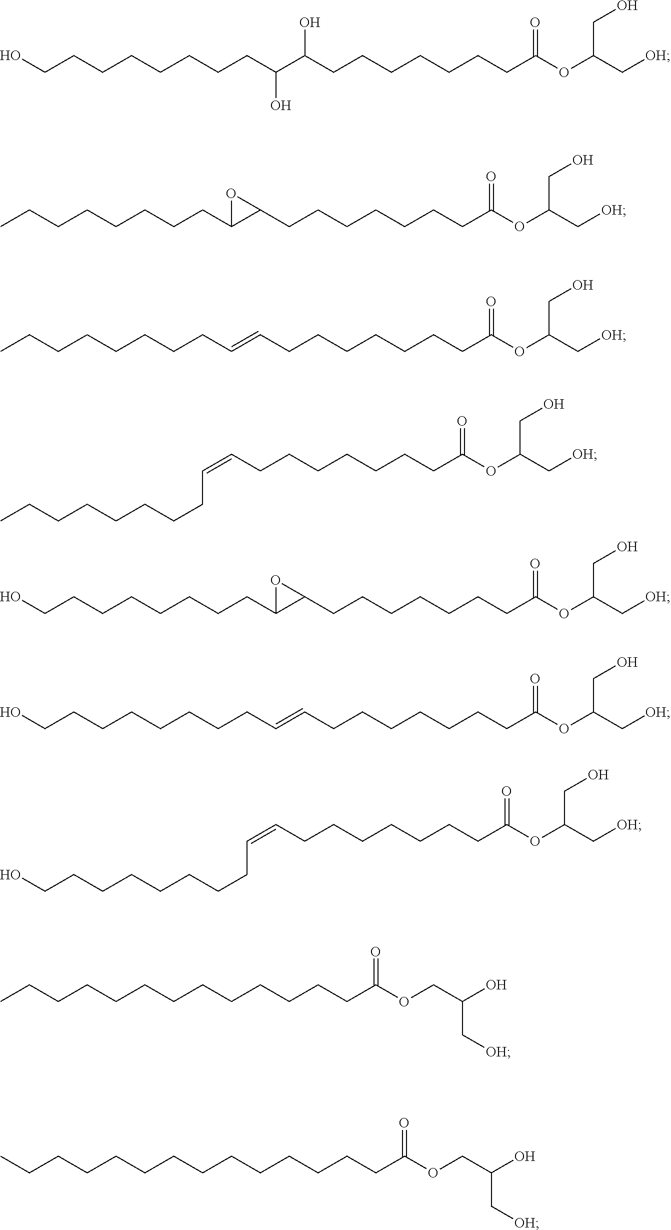

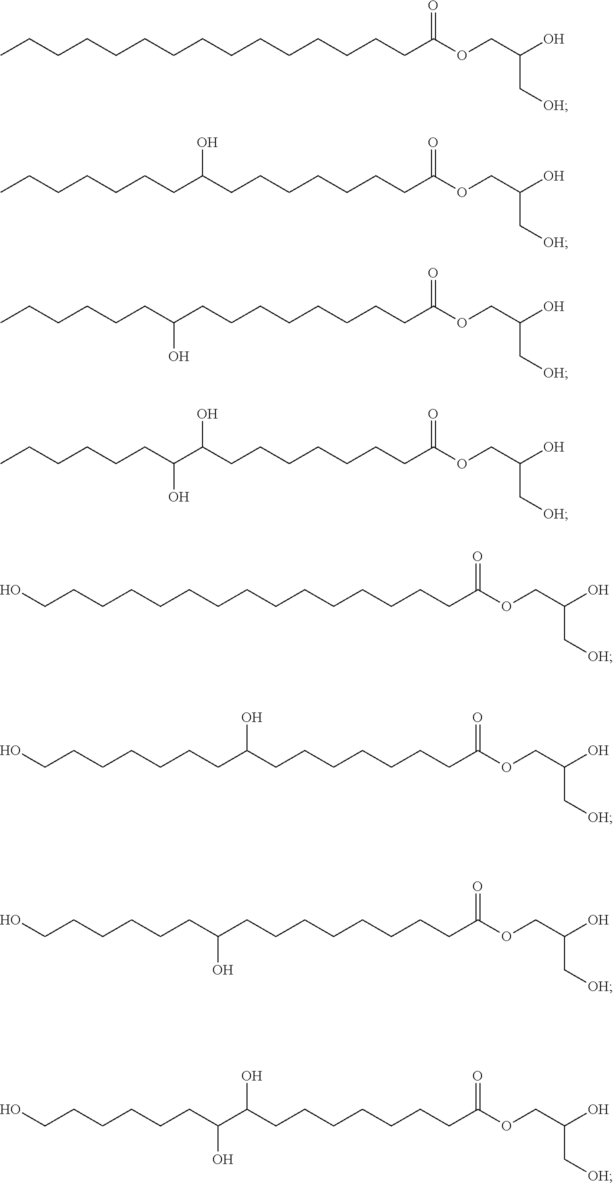

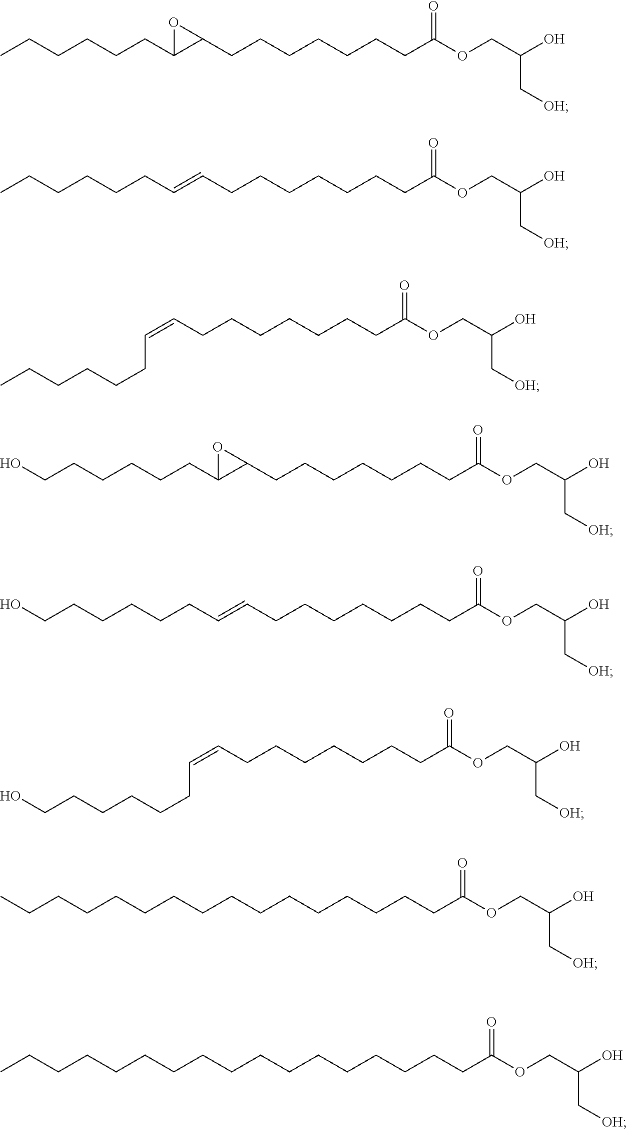

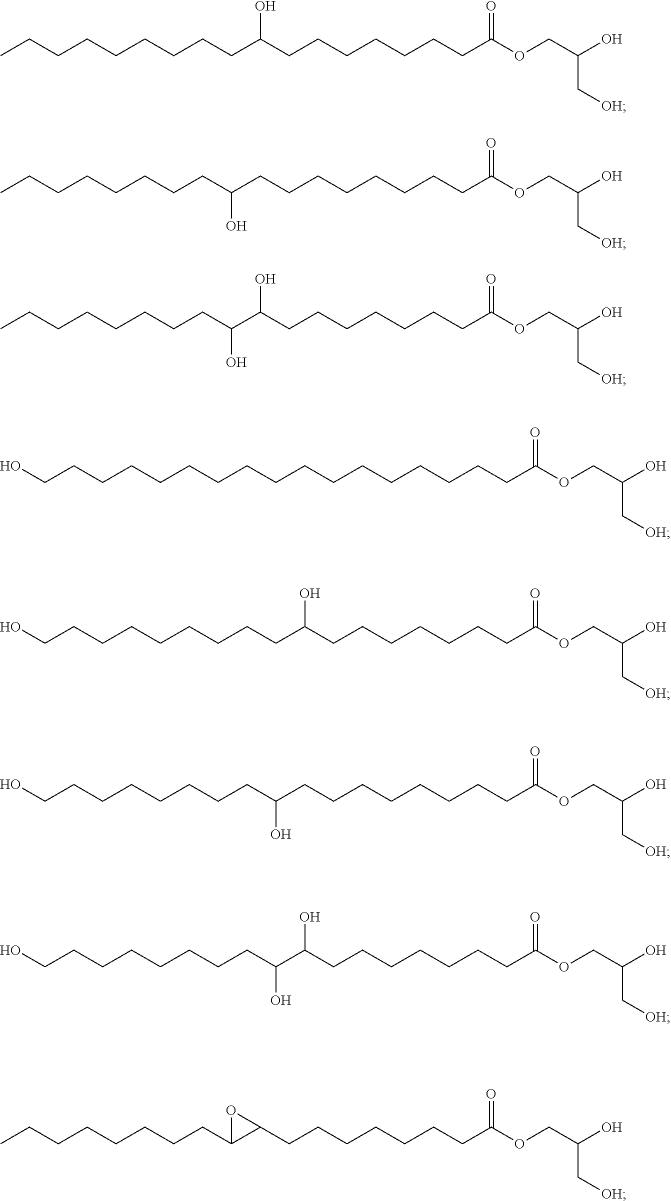

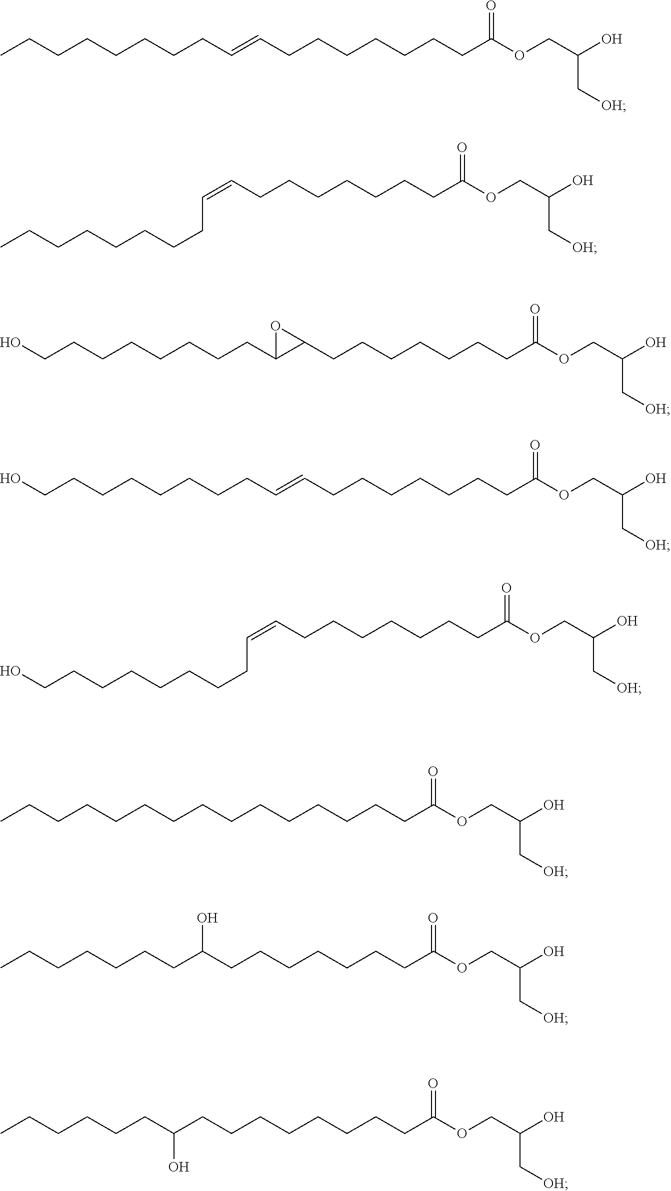

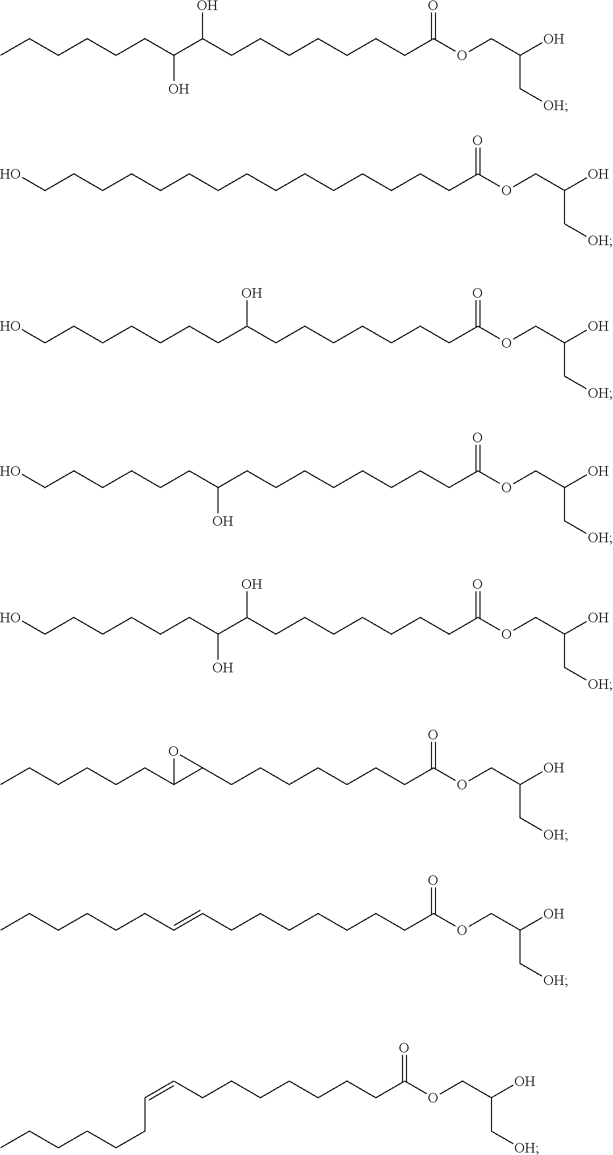

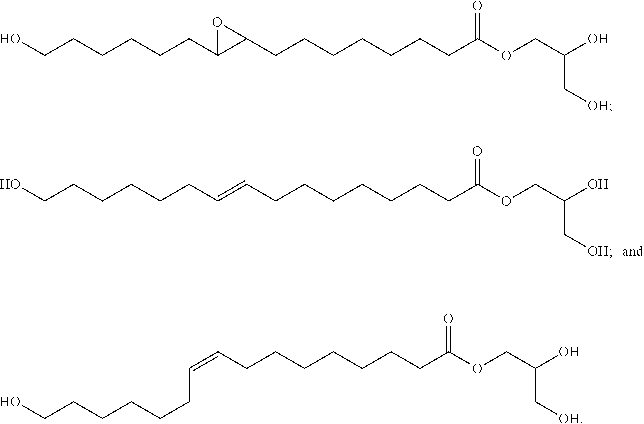 [SMILES: O=C(CCCCCCCC1OC1CCCCCCO)OCC(O)CO ; O=C(CCCCCCC/C=C/CCCCCCO)OCC(O)CO ; O=C(CCCCCCC/C=C\CCCCCCO)OCC(O)CO]

19. The mixture of any of claims 14-15, wherein the second group of compounds comprises SA-Na, PA-Na, MA-Na, SA-K, PA-K, or MA-K.

20. The mixture of any of claims 14-15, wherein a concentration of the composition in the mixture is in a range of 0.5 to 200 mg/mL.

21. The mixture of any of claims 14-15, wherein each compound of the first group of compounds has a carbon chain length of at least 14.

22. The mixture of claim 21, wherein each compound of the second group of compounds has a carbon chain length of at least 14.

23. The mixture of claim 22, wherein the composition comprises from 70% to 99% by mass of the first group of compounds and from 1% to 30% by mass of the second group of compounds.

24. The mixture of any of claims 14-15, wherein R is -glyceryl.

25. The mixture of claim 15, wherein the second group of compounds comprises SA-Na, PA-Na, MA-Na, SA-K, PA-K, MA-K, (SA)₂-Mg, (PA)₂-Mg, (MA)₂-Mg, (SA)₂-Ca, (PA)₂-Ca, or (MA)₂-Ca.

26. The mixture of any of claims 14-15, wherein the composition comprises less than 10% by mass of diglycerides.

27. The mixture of any of claims 14-15, wherein the composition comprises less than 10% by mass of triglycerides.

28. The mixture of any of claims 14-15, wherein the composition comprises less than 10% by mass of acetylated monoglycerides.

29. A composition, comprising:
from 50% to 99.9% by mass of one or more first compounds selected from the group consisting of fatty acids, fatty acid esters, fatty acid salts, and combinations thereof, wherein each of the one or more first compounds has a carbon chain length of at least 14; and
from 0.1% to 35% by mass of one or more second compounds selected from the group consisting of fatty acids, fatty acid esters, fatty acid salts, and combinations thereof, wherein each of the one or more second compounds has a carbon chain length in a range of 7 to 13.

30. The composition of claim 29, wherein each of the one or more second compounds has a carbon chain length of 8, 10, 11, or 12.

31. The composition of claim 29, wherein each of the one or more first compounds and each of the one or more second compounds is a compound of Formula I or Formula III, where Formula I and Formula III are: 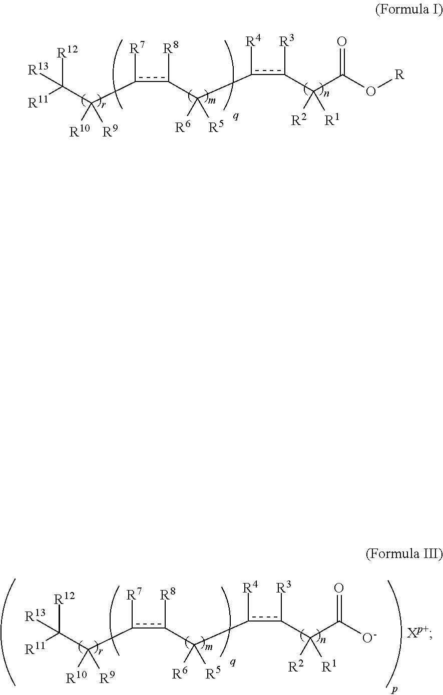
wherein for each of the formulas:
R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
R³ and R⁴ can combine with the carbon atoms to which they are attached to form a C₃-C₆ cycloalkyl, a C₄-C₆ cycloalkenyl, or 3- to 6-membered ring heterocycle; and/or
R⁷ and R⁸ can combine with the carbon atoms to which they are attached to form a C₃-C₆ cycloalkyl, a C₄-C₆ cycloalkenyl, or 3- to 6-membered ring;
R¹⁴ and R¹⁵ are each independently, at each occurrence, —H, aryl, heteroaryl, —C₁-C₆ alkyl, —C₂-C₆ alkenyl, or —C₂-C₆ alkynyl;
the symbol [symbol] represents an optionally single or cis or trans double bond;
n is 0, 1, 2, 3, 4, 5, 6, 7, or 8;
m is 0, 1, 2, or 3;
q is 0, 1, 2, 3, 4, or 5;
r is 0, 1, 2, 3, 4, 5, 6, 7, or 8;
R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen, hydroxyl, nitro, —CN, —NH₂, —SH, —SR¹⁵, —OR¹⁴, —NR¹⁴R¹⁵, —C₁-C₆ alkyl, —C₂-C₆ alkenyl, or —C₂-C₆ alkynyl; and
X^{p+} is a cationic counter ion having a charge state p, and p is 1, 2, or 3.

32. The composition of claim 31, wherein the cationic counter ion is an inorganic ion.

33. The composition of claim 31, wherein the cationic counter ion is an organic ion.

34. A composition, comprising:
from 50% to 99.9% by mass of one or more first compounds selected from the group consisting of fatty acids, fatty acid esters, fatty acid salts, and combinations thereof, wherein each of the one or more first compounds has a carbon chain length of at least 14; and
from 0.1% to 35% by mass of one or more second compounds selected from the group consisting of phospholipids, lysophospholipids, glycoglycerolipids, glycolipids, ascorbyl esters of a fatty acid, esters of lactic acid, esters of tartaric acid, esters of malic acid, esters of fumaric acid, esters of succinic acid, esters of citric acid, esters of pantothenic acid, fatty alcohol derivatives, and combinations thereof.

35. The composition of any of claims 29-34, wherein each of the one or more second compounds is a wetting agent.

36. The composition of any of claims 29-34, wherein the one or more first compounds comprises one or more monoacylglycerides or fatty acid salts.

37. The composition of any of claims 29-34, wherein the one or more first compounds is a combination of one or more monoacylglycerides and one or more fatty acid salts.

38. The composition of claim 37, wherein a mass ratio of the monoacylglycerides to the fatty acid salts is in a range of about 2 to 100.

39. A composition, comprising:
from about 50% to about 99.8% by mass of one or more first compounds selected from the group consisting of fatty acids, fatty acid esters, and combinations thereof, wherein each compound of the first group has a carbon chain length of at least 14;
from about 0.1% to about 35% by mass of one or more wetting agents;
from about 0.1% to about 25% by mass of one or more fatty acid salts, wherein each fatty acid salt has a carbon chain length of at least 14.

40. The composition of claim 39, wherein each of the one or more first compounds is a compound of Formula I: 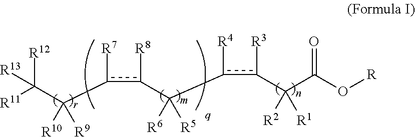
wherein:
R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen, hydroxyl, nitro, —CN, —NH₂, —SH, —SR¹⁵, —OR¹⁴, —NR¹⁴R¹⁵, —C₁-C₆ alkyl, —C₂-C₆ alkenyl, or —C₂-C₆ alkynyl;
R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
R³ and R⁴ can combine with the carbon atoms to which they are attached to form a C₃-C₆ cycloalkyl, a C₄-C₆ cycloalkenyl, or 3- to 6-membered ring heterocycle; and/or
R⁷ and R⁸ can combine with the carbon atoms to which they are attached to form a C₃-C₆ cycloalkyl, a C₄-C₆ cycloalkenyl, or 3- to 6-membered ring;
R¹⁴ and R¹⁵ are each independently, at each occurrence, —H, aryl, heteroaryl, —C₁-C₆ alkyl, —C₂-C₆ alkenyl, or —C₂-C₆ alkynyl;
the symbol [symbol] represents an optionally single or cis or trans double bond;
n is 0, 1, 2, 3, 4, 5, 6, 7, or 8;
m is 0, 1, 2, or 3;
q is 0, 1, 2, 3, 4, or 5; and
r is 0, 1, 2, 3, 4, 5, 6, 7, or 8.

41. The composition of any of claims 39-40, wherein each of the one or more fatty acid salts is a compound of Formula III, wherein Formula III is: 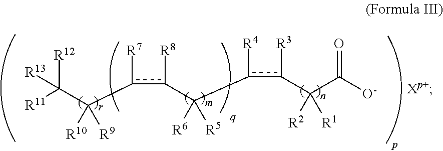
wherein:
R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
R³ and R⁴ can combine with the carbon atoms to which they are attached to form a C₃-C₆ cycloalkyl, a C₄-C₆ cycloalkenyl, or 3- to 6-membered ring heterocycle; and/or
R⁷ and R⁸ can combine with the carbon atoms to which they are attached to form a C₃-C₆ cycloalkyl, a C₄-C₆ cycloalkenyl, or 3- to 6-membered ring;
R¹⁴ and R¹⁵ are each independently, at each occurrence, —H, aryl, heteroaryl, —C₁-C₆ alkyl, —C₂-C₆ alkenyl, or —C₂-C₆ alkynyl;
the symbol [symbol] represents an optionally single or cis or trans double bond;
n is 0, 1, 2, 3, 4, 5, 6, 7, or 8;
m is 0, 1, 2, or 3;
q is 0, 1, 2, 3, 4, or 5;
r is 0, 1, 2, 3, 4, 5, 6, 7, or 8; and
X^{p+} is a cationic counter ion having a charge state p, and p is 1, 2, or 3.

42. The composition of any of claims 39-40, wherein each of the one or more first compounds comprises a fatty acid ester.

43. The composition of claim 42, wherein each of the one or more first compounds comprises a monoacylglyceride.

44. The composition of any of claims 39-40, wherein a mass ratio of the one or more first compounds to the fatty acid salts is from 2 to 100.

45. The composition of any of claims 39-40, wherein each of the one or more wetting agents is selected from the group consisting of fatty acids, fatty acid esters, and fatty acid salts, and each of the one or more wetting agents has a carbon chain length in a range of 7 to 13.

46. The composition of claim 45, wherein each of the one or more wetting agents is a monoacylglyceride.

47. The composition of any of claims 39-40, wherein each of the one or more wetting agents is selected from the group consisting of phospholipids, lysophospholipids, glycoglycerolipids, glycolipids, ascorbyl esters of a fatty acid, esters of lactic acid, esters of tartaric acid, esters of malic acid, esters of fumaric acid, esters of succinic acid, esters of citric acid, esters of pantothenic acid, and fatty alcohol derivatives.

48. A composition, comprising:
from about 50% to about 99.8% by mass of a first group of compounds, wherein each compound of the first group is a compound of Formula I having a carbon chain length of at least 14;
from about 0.1% to about 35% by mass of a second group of compounds, wherein each compound of the second group is a compound of Formula I having a carbon chain length in a range of 7 to 13; and
from about 0.1% to about 25% by mass of a third group of compounds, wherein each compound of the third group is a salt of Formula III, wherein Formula I and Formula III are: 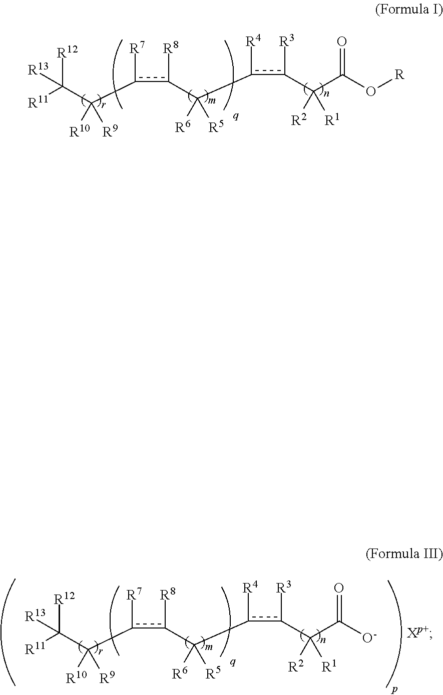
wherein for each of the formulas:
R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
R³ and R⁴ can combine with the carbon atoms to which they are attached to form a C₃-C₆ cycloalkyl, a C₄-C₆ cycloalkenyl, or 3- to 6-membered ring heterocycle; and/or
R⁷ and R⁸ can combine with the carbon atoms to which they are attached to form a C₃-C₆ cycloalkyl, a C₄-C₆ cycloalkenyl, or 3- to 6-membered ring;
R¹⁴ and R¹⁵ are each independently, at each occurrence, —H, aryl, heteroaryl, —C₁-C₆ alkyl, —C₂-C₆ alkenyl, or —C₂-C₆ alkynyl;
the symbol [symbol] represents an optionally single or cis or trans double bond;
n is 0, 1, 2, 3, 4, 5, 6, 7, or 8;
m is 0, 1, 2, or 3;
q is 0, 1, 2, 3, 4, or 5;
r is 0, 1, 2, 3, 4, 5, 6, 7, or 8;
R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen, hydroxyl, nitro, —CN, —NH₂, —SH, —SR¹⁵, —OR¹⁴, —NR¹⁴R¹⁵, —C₁-C₆ alkyl, —C₂-C₆ alkenyl, or —C₂-C₆ alkynyl; and
X^{p+} is a cationic counter ion having a charge state p, and p is 1, 2, or 3.

49. The composition of claim 48, wherein each compound of the first group comprises a fatty acid or a fatty acid ester.

50. The composition of claim 48, wherein each compound of the first group comprises a monoacylglyceride.

51. The composition of any of claims 48-50, wherein a mass ratio of the first group of compounds to the third group of compounds is in a range of 2 to 100.

52. The composition of any of claims 48-50, wherein the cationic moiety comprises sodium, potassium, calcium, or magnesium.

53. A mixture comprising the composition of any of claims 29-52 in a solvent.

54. The mixture of claim 53, wherein the solvent is at least 70% water by volume.

55. The mixture of any of claims 53-54, wherein the solvent further comprises ethanol.

56. The mixture of any of claims 53-54, wherein the mixture further comprises an antimicrobial agent.

57. The mixture of claim 56, wherein the antimicrobial agent comprises citric acid.

58. The mixture of any of claims 53-54, wherein the solvent is a hydrophilic solvent.

59. The mixture of any of claims 53-58, wherein the mixture further comprises sodium bicarbonate.

60. The mixture of any of claims 53-54, wherein a concentration of the wetting agents in the mixture is at least about 0.1 mg/mL.

61. The mixture of any of claims 53-54, wherein a concentration of the composition in the mixture in a range of 0.5 to 200 mg/mL.

62. The mixture of claim 61, wherein the solvent is water.

63. A method of forming a mixture, comprising:
providing a solvent, wherein the solvent is characterized as exhibiting a contact angle of at least about 70° when disposed on the surface of carnauba wax; and
adding a composition to the solvent to form the mixture; wherein
the composition comprises one or more fatty acids or salts or esters thereof, and
the mixture is characterized as exhibiting a contact angle less than about 65° when disposed on the surface of carnauba wax.

64. The method of claim 63, wherein at least one of the fatty acids or salts or esters thereof of the composition has a carbon chain length of 13 or less.

65. The method of any of claims 63-64, wherein at least one of the fatty acids or salts or esters thereof of the composition has a carbon chain length of 14 or greater.

66. The method of any of claims 63-64, wherein the solvent is at least 70% water by volume.

67. The method of any of claims 63-64, wherein the one or more fatty acids or salts or esters thereof is a compound of Formula I or Formula III, wherein Formula I and Formula III are: 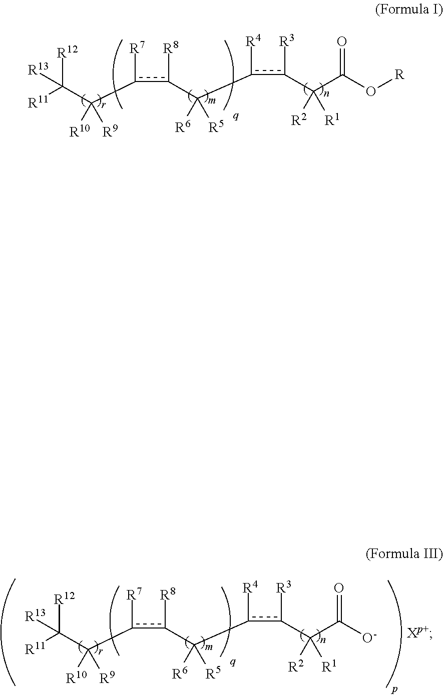
wherein for each of the formulas:
R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
R³ and R⁴ can combine with the carbon atoms to which they are attached to form a C₃-C₆ cycloalkyl, a C₄-C₆ cycloalkenyl, or 3- to 6-membered ring heterocycle; and/or
R⁷ and R⁸ can combine with the carbon atoms to which they are attached to form a C₃-C₆ cycloalkyl, a C₄-C₆ cycloalkenyl, or 3- to 6-membered ring;
R¹⁴ and R¹⁵ are each independently, at each occurrence, —H, aryl, heteroaryl, —C₁-C₆ alkyl, —C₂-C₆ alkenyl, or —C₂-C₆ alkynyl;
the symbol [symbol] represents an optionally single or cis or trans double bond;
n is 0, 1, 2, 3, 4, 5, 6, 7, or 8;
m is 0, 1, 2, or 3;
q is 0, 1, 2, 3, 4, or 5;
r is 0, 1, 2, 3, 4, 5, 6, 7, or 8;
R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen, hydroxyl, nitro, —CN, —NH₂, —SH, —SR¹⁵, —OR¹⁴, —NR¹⁴R¹⁵, —C₁-C₆ alkyl, —C₂-C₆ alkenyl, or —C₂-C₆ alkynyl; and
X^{p+} is a cationic counter ion having a charge state p, and p is 1, 2, or 3.

68. A composition, comprising:
from about 50% to about 99% by mass of one or more fatty acid esters having carbon chain length of at least 14; and
from about 1% to about 50% by mass of one or more fatty acid salts having a carbon chain length of at least 14.

69. The composition of claim 68, wherein the one or more fatty acid esters comprises one or more monoacylglycerides.

70. The composition of any of claims 68-69, wherein a mass ratio of the one or more fatty acid esters to the one or more fatty acid salts is in a range of about 2 to 99.

71. The composition of any of claims 68-70, wherein the composition comprises less than 10% by mass of diglycerides.

72. The composition of any of claims 68-71, wherein the composition comprises less than 10% by mass of triglycerides.

73. The composition of any of claims 68-72, wherein the composition comprises less than 10% by mass of acetylated monoglycerides.

74. A mixture comprising the composition of any of claims 68-73 in a solvent.

75. A method of treating agricultural products, the method comprising coating the agricultural products with a composition comprising:
(i) from about 50% to about 99.9% by mass of one or more first compounds selected from the group consisting of fatty acids, fatty acid esters, fatty acid salts, and combinations thereof, wherein each of the one or more first compounds has a carbon chain length of at least 14; and
(ii) from about 0.1% to about 35% by mass of one or more second compounds selected from the group consisting of fatty acids, fatty acid esters, fatty acid salts, and combinations thereof, wherein each of the one or more second compounds has a carbon chain length in a range of 7 to 13.

76. The method of claim 75, wherein each of the one or more second compounds has a carbon chain length of 8, 10, 11, or 12.

77. A method of treating agricultural products, the method comprising coating the agricultural products with a composition comprising:
(i) from about 50% to about 99.8% by mass of one or more first compounds selected from the group consisting of fatty acids, fatty acid esters, and combinations thereof, wherein each compound of the first group has a carbon chain length of at least 14;
(ii) from about 0.1% to about 35% by mass of one or more wetting agents;
(iii) from about 0.1% to about 25% by mass of one or more fatty acid salts, wherein each fatty acid salt has a carbon chain length of at least 14.

78. The method of claim 77, wherein each of the one or more wetting agents is selected from the group consisting of fatty acids, fatty acid esters, and fatty acid salts, and each of the one or more wetting agents has a carbon chain length in a range of 7 to 13.

79. The method of claim 78, wherein each of the one or more wetting agents is a monoacylglyceride.

80. The method of claim 77, wherein each of the one or more wetting agents is selected from the group consisting of phospholipids, lysophospholipids, glycoglycerolipids, glycolipids, ascorbyl esters of a fatty acid, esters of lactic acid, esters of tartaric acid, esters of malic acid, esters of fumaric acid, esters of succinic acid, esters of citric acid, esters of pantothenic acid, and fatty alcohol derivatives.

81. The method of any of claims 75-80, wherein each of the one or more first compounds is a compound of Formula I: 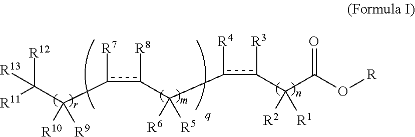
wherein:
R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen (e.g., C₁, Br, or I), hydroxyl, nitro, —CN, —NH₂, —SH, —SR¹⁵, —OR¹⁴, —NR¹⁴R¹⁵, —C₁-C₆ alkyl, —C₂-C₆ alkenyl, or —C₂-C₆ alkynyl;
R¹, R², R⁵, R⁶, R⁹, R¹⁰, R¹¹, R¹² and R¹³ are each independently, at each occurrence, —H,
—(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
R³, R⁴, R⁷, and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl wherein each alkyl, alkynyl, cycloalkyl, aryl, or heteroaryl is optionally substituted with one or more —OR¹⁴, —NR¹⁴R¹⁵, —SR¹⁴, or halogen; or
R³ and R⁴ can combine with the carbon atoms to which they are attached to form a C₃-C₆ cycloalkyl, a C₄-C₆ cycloalkenyl, or 3- to 6-membered ring heterocycle; and/or
R⁷ and R⁸ can combine with the carbon atoms to which they are attached to form a C₃-C₆ cycloalkyl, a C₄-C₆ cycloalkenyl, or 3- to 6-membered ring heterocycle;
R¹⁴ and R¹⁵ are each independently, at each occurrence, —H, aryl, heteroaryl, —C₁-C₆ alkyl, —C₂-C₆ alkenyl, or —C₂-C₆ alkynyl;
the symbol [symbol] represents a single bond or a cis or trans double bond;
n is 0, 1, 2, 3, 4, 5, 6, 7 or 8;
m is 0, 1, 2 or 3;
q is 0, 1, 2, 3, 4 or 5; and
r is 0, 1, 2, 3, 4, 5, 6, 7 or 8.

82. The method of any of claims 75-80, wherein the one or more first compounds comprises one or more monoacylglycerides or fatty acid salts.

83. The method of any of claims 75-80, wherein the one or more first compounds is a combination of one or more monoacylglycerides and one or more fatty acid salts.

84. The method of claim 83, wherein a mass ratio of the monoacylglycerides to the fatty acid salts is in a range of about 2 to 100.

85. A method of treating agricultural products, the method comprising coating the agricultural products with a composition comprising:
(i) from about 50% to about 99% by mass of one or more fatty acid esters having a carbon chain length of at least 14; and
(ii) from about 1% to about 50% by mass of one or more fatty acid salts having a carbon chain length of at least 14.

86. The method of any of claims 75-80 and 85, wherein the composition comprises an antimicrobial agent.

87. The method of any of claims 75-80 and 85, wherein the composition further comprises one or more additives.

88. The method of claim 87, wherein the one or more additives is a pH adjusting agent.

89. The method of claim 88, wherein the pH adjusting agent is sodium bicarbonate.

90. The method of any of claims 75-80 and 85, wherein the composition is dissolved or dispersed in a solvent, and the resulting solution, suspension, or colloid is coated onto the agricultural products.

91. The method of claim 90, wherein the solvent is a hydrophilic solvent.

92. The method of claim 90, wherein the solvent is at least 70% water by volume.

93. The method of claim 92, wherein the solvent further comprises ethanol.

94. The method of any of claims 75-80 and 85, wherein the agricultural products are coated with the composition by spraying.

95. The method of any of claims 75-80 and 85, wherein the agricultural products are coated with the composition by dipping.

96. The method of any of claims 75-80 and 85, wherein the agricultural products are coated with the composition by brushing.

97. The method of any of claims 75-80 and 85, wherein the coating reduces the heat generated by respiration of the agricultural products.

98. The method of any of claims 75-80 and 85, wherein the agricultural products comprise fresh fruits, fresh vegetables, or combinations thereof.

99. The method of any of claims 75-80 and 85, wherein the agricultural products comprise flowers or cut flowers.

100. A method for reducing the heat generated by respiration of agricultural products, the method comprising coating the agricultural products with a composition, wherein the coating reduces the average rate of respiration of the agricultural products by at least about 10%.

101. The method of claim 100, wherein the coating reduces the average rate of respiration of the agricultural products by at least 15%, 20%, 25%, 30%, 35%, 40%, 45%, 50%, 55%, 60%, 65%, 70%, 75%, 80%, 85%, or 90%.

102. The method of claim 100, wherein the composition comprises:
(i) from about 50% to about 99.9% by mass of one or more first compounds selected from the group consisting of fatty acids, fatty acid esters, fatty acid salts, and combinations thereof, wherein each of the one or more first compounds has a carbon chain length of at least 14; and
(ii) from about 0.1% to about 35% by mass of one or more second compounds selected from the group consisting of fatty acids, fatty acid esters, fatty acid salts, and combinations thereof, wherein each of the one or more second compounds has a carbon chain length in a range of 7 to 13.

103. The method of claim 102, wherein each of the one or more second compounds has a carbon chain length of 8, 10, 11, or 12.

104. The method of claim 100, wherein the composition comprises:
(i) from about 50% to about 99.8% by mass of one or more first compounds selected from the group consisting of fatty acids, fatty acid esters, and combinations thereof, wherein each compound of the first group has a carbon chain length of at least 14;
(ii) from about 0.1% to about 35% by mass of one or more wetting agents;
(iii) from about 0.1% to about 25% by mass of one or more fatty acid salts, wherein each fatty acid salt has a carbon chain length of at least 14.

105. The method of claim 104, wherein each of the one or more wetting agents is selected from the group consisting of fatty acids, fatty acid esters, and fatty acid salts, and each of the one or more wetting agents has a carbon chain length in a range of 7 to 13.

106. The method of claim 105, wherein each of the one or more wetting agents is a monoacylglyceride.

107. The method of claim 104, wherein each of the one or more wetting agents is selected from the group consisting of phospholipids, lysophospholipids, glycoglycerolipids, glycolipids, ascorbyl esters of a fatty acid, esters of lactic acid, esters of tartaric acid, esters of malic acid, esters of fumaric acid, esters of succinic acid, esters of citric acid, esters of pantothenic acid, and fatty alcohol derivatives.

108. The method of any of claims 102-107, wherein each of the one or more first compounds is a compound of Formula I: 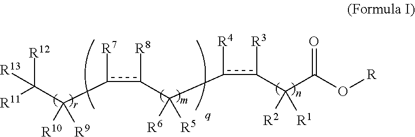
wherein:
R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen (e.g., C₁, Br, or I), hydroxyl, nitro, —CN, —NH₂, —SH, —SR¹⁵, —OR¹⁴, —NR¹⁴R¹⁵, —C₁-C₆ alkyl, —C₂-C₆ alkenyl, or —C₂-C₆ alkynyl;
R¹, R², R⁵, R⁶, R⁹, R¹⁰, R¹¹, R¹² and R¹³ are each independently, at each occurrence, —H,
—(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
R³, R⁴, R⁷, and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl wherein each alkyl, alkynyl, cycloalkyl, aryl, or heteroaryl is optionally substituted with one or more —OR¹⁴, —NR¹⁴R¹⁵, —SR¹⁴, or halogen; or
R³ and R⁴ can combine with the carbon atoms to which they are attached to form a C₃-C₆ cycloalkyl, a C₄-C₆ cycloalkenyl, or 3- to 6-membered ring heterocycle; and/or
R⁷ and R⁸ can combine with the carbon atoms to which they are attached to form a C₃-C₆ cycloalkyl, a C₄-C₆ cycloalkenyl, or 3- to 6-membered ring heterocycle;
R¹⁴ and R¹⁵ are each independently, at each occurrence, —H, aryl, heteroaryl, —C₁-C₆ alkyl, —C₂-C₆ alkenyl, or —C₂-C₆ alkynyl;
the symbol [symbol] represents a single bond or a cis or trans double bond;
n is 0, 1, 2, 3, 4, 5, 6, 7 or 8;
m is 0, 1, 2 or 3;
q is 0, 1, 2, 3, 4 or 5; and
r is 0, 1, 2, 3, 4, 5, 6, 7 or 8.

109. The method of any of claims 102-107, wherein the one or more first compounds comprises one or more monoacylglycerides or fatty acid salts.

110. The method of any of claims 102-107, wherein the one or more first compounds is a combination of one or more monoacylglycerides and one or more fatty acid salts.

111. The method of claim 110, wherein a mass ratio of the monoacylglycerides to the fatty acid salts is in a range of about 2 to 100.

112. The method of claim 100, wherein the composition comprises:
(i) from about 50% to about 99% by mass of one or more fatty acid esters having carbon chain length of at least 14; and
(ii) from about 1% to about 50% by mass of one or more fatty acid salts having a carbon chain length of at least 14.

113. The method of any of claims 102-107 and 112, wherein the composition comprises an antimicrobial agent.

114. The method of any of claims 102-107 and 112, wherein the composition further comprises one or more additives.

115. The method of claim 114, wherein the one or more additives is a pH adjusting agent.

116. The method of claim 115, wherein the pH adjusting agent is sodium bicarbonate.

117. The method of any of claims 102-107 and 112, wherein the composition is dissolved or dispersed in a solvent, and the resulting solution, suspension, or colloid is coated onto the agricultural products.

118. The method of claim 117, wherein the solvent is a hydrophilic solvent.

119. The method of claim 117, wherein the solvent is at least 70% water by volume.

120. The method of claim 119, wherein the solvent further comprises ethanol.

121. The method of any of claims 102-107 and 112, wherein the agricultural products are coated with the composition by spraying.

122. The method of any of claims 102-107 and 112, wherein the agricultural products are coated with the composition by dipping.

123. The method of any of claims 102-107 and 112, wherein the agricultural products are coated with the composition by brushing.

124. The method of claim 123, wherein the brushing is performed using a brush bed.

125. The method of any of claims 102-107 and 112, wherein the agricultural products comprise fresh fruits, fresh vegetables, or combinations thereof.

126. The method of any of claims 102-107 and 112, wherein the agricultural products comprise flowers or cut flowers.
